(19) United States
(12) Patent Application Publication
(10) Pub. No.: US 2016/0164135 A1
(43) Pub. Date: Jun. 9, 2016

(54) NANOCOMPOSITE PARTICLES OF CONVERSION CHEMISTRY AND MIXED ELECTRONIC IONIC CONDUCTOR MATERIALS

(71) Applicant: QuantumScape Corporation, San Jose, CA (US)

(72) Inventors: Rainer J. Fasching, Mill Valley, CA (US); Will Hudson, Belmont, CA (US); Ghyrn E. Loveness, Mountain View, CA (US); Eric Tulsky, Berleley, CA (US); Adrian Winoto, San Francisco, CA (US); Aram Yang, Berkeley, CA (US); Arnold Allenic, San Jose, CA (US)

(73) Assignee: QuantumScape Corporation, San Jose, CA (US)

(21) Appl. No.: 14/827,105

(22) Filed: Aug. 14, 2015

Related U.S. Application Data
(60) Provisional application No. 62/088,461, filed on Dec. 5, 2014.

(51) Int. Cl. H01M 10/0562; H01M 4/58; H01M 4/04; H01M 4/62; H01M 10/0525

(52) U.S. Cl. CPC H01M 10/0562; H01M 4/625; H01M 10/0525; H01M 4/0485; H01M 4/582; H01M 2220/30; H01M 2220/20; H01M 2300/0068; H01M 2300/0071

(57) ABSTRACT

Positive electrode films for a Li-secondary battery are provided. The films include composite particles including a mixed electronic ionic conductor (MEIC), a metal fluoride (MF), and optionally an electrically conductive additive comprising carbon. The films include a catholyte and a binder that are both in contact with the composite particle surfaces but not contained therein. The composite particles are characterized by a porosity of less than about 15% v/v at 25° C. Methods of forming positive electrode films for a Li-secondary battery are also provided. Methods of forming positive electrode films including annealed composite particles for a Li-secondary battery are also provided. The methods include preparing a composite including a mixed electronic ionic conductor (MEIC) including a member selected from metal oxides, metal sulfides, metal halides, metal oxyhalides, and combinations thereof, a nanodimensioned metal fluoride (MF), optionally a binder, and optionally an electrically conductive additive comprising carbon.

### CROSS-REFERENCE TO RELATED APPLICATIONS

This application claims the benefit under 35 U.S.C. §119(e) of U.S. Provisional Patent Application 62/088,461 filed on Dec. 5, 2014, which is incorporated herein by reference in its entirety for all purposes.

### BACKGROUND

The increased performance requirements for consumer electronics (e.g., mobile telephones and computers) and transportation vehicles (e.g., electric and hybrid automobiles) as well as the adverse environmental effects related to fossil fuel consumption has resulted in a need for improved rechargeable (i.e., secondary) batteries for storing and delivering electrical energy and power. Conventional secondary batteries, however, are generally associated with high manufacturing costs, low energy densities, and poor power performance and are therefore inadequate to meet many of the current and future needs for these devices.

Lithium ion batteries have some of the highest energy densities currently available commercially. However, these types of batteries are performance limited, in part, due to the positive electrode materials and the battery architectures and electrode configurations into which these materials are fabricated. While advances in positive electrode materials have been made (See, for example U.S. Patent Application Publication No. 2014/0170493, entitled NANOSTRUCTURED MATERIALS FOR ELECTROCHEMICAL CONVERSION REACTIONS, filed as U.S. patent application Ser. No. 13/922,214 on Jun. 29, 2013, to Holme et al.), developments are still needed with regard to battery architectures and electrode configurations for these and other positive electrode materials.

Recent work investigated the use of nanodimensioned metal fluorides as a positive electrode material (See F. Badway et al., Journal of The Electrochemical Society, 2003, 150(9), A1209-A1218) and combinations of nanodimensioned metal fluorides with mixed electronic ionic conductors (See U.S. Pat. No. 8,518,604, entitled METAL FLUORIDE AND PHOSPHATE NANOCOMPOSITES AS ELECTRODE MATERIALS, filed as U.S. patent application Ser. No. 12/025,662 on Feb. 4, 2008, to Amatucci et al.; see also Gmitter, et al., Journal of Materials Chemistry, 2010, 20, 4149-4161). However, electrodes which incorporate these composites are characterized by voids, high porosity, and a significant amount of vacant space which limits the electronic and ionic conductivity in the corresponding electrochemical devices which incorporate such electrodes and composites. The positive electrodes in many of these devices also have low volumetric energy densities (i.e. energy per unit volume) and low gravimetric energy densities (i.e. energy per unit mass), which requires larger volume and heavier batteries, still with limited electronic and ionic properties, for a given rechargeable battery application.

What is needed are Li-secondary battery positive electrode films, and positive electrode active materials and composites therefor, having reduced porosity, improved conductivity, improved power delivery, improved cyclability, improved rates of charge and discharge, and, or, reduced cycle hysteresis as well as novel methods of making and using such positive electrode materials and electrochemical thin films including the same. The disclosure in this application sets forth a variety of solutions to these and other unmet challenges in the field to which the instant disclosure pertains.

### SUMMARY

In some embodiments set forth herein, aspects are related to a Li-secondary battery positive electrode film including composite particles. The composite particles include a mixed electronic ionic conductor (MEIC) or either or both of a member selected from the group consisting of an electronic conductor and ionic conductor, also a metal fluoride (MF), and optionally an electrically conductive additive including carbon. The film may further include a catholyte and a binder, wherein the catholyte and binder contact the composite particle's surfaces but are not contained therein. The composite particles in the film are characterized by a porosity of less than about 15% v/v at 25° C. In some embodiments, the porosity of the composites is less than 10% v/v or less than 5% v/v. In some embodiments, the film having the nanocomposites herein is characterized by a porosity of less than about 20% v/v at 25° C. or less than about 15% v/v at 25° C. In some embodiments, the metal fluoride is replaced by a metal and LiF. In some embodiments, the metal fluoride is LiF and further includes a transition metal, such as, but not limited to, Fe, Co, Ni, Cu, Zn, or combinations thereof. In some embodiments, the metal fluoride is nanodimensioned. In some embodiments, the metal is nanodimensioned. In some embodiments, the metal fluoride is doped with a dopant selected from an alkali metal, a transition metal, a combination thereof, an oxide thereof, or a fluoride thereof. In some embodiments, the composite particle has a characteristic particle size dimension of about 0.25 μm to 10 μm (e.g., largest dimension of composite particle or the diameter for a spherically shaped composite particle) and particle features, therein, which have a characteristic dimension of about 0.1 nm to about 250 nm (e.g., distance between MEIC and metal fluoride, or composite particle protrusions, digitation, or particle surface roughness). In some embodiments, the nanocomposites are micron sized particles with nanodimensioned metal fluorides therein in which the MEIC and carbon provide Li⁺ ion and electron conduction pathways, respectively, to and from the metal fluorides in the nanocomposite. By providing these conduction pathways, the nanocomposites herein allow the metal fluorides to be charged and discharged at higher rates than those achievable with metal fluorides which are not in a nanocomposite as set forth herein.

In other embodiments set forth herein, aspects are related to a Li-secondary battery positive electrode film including composite particles. The composite particles include a mixed electronic ionic conductor (MEIC), a metal fluoride (MF), and optionally an electrically conductive additive including carbon. In some embodiments, the composite particles include a metal fluoride (MF) and electrically conductive carbon. The film further includes a catholyte and a binder, wherein the catholyte and binder contact the composite particles surfaces but are not contained therein. In some examples, the weight ratio of MEIC to MF in the composite particles is about 1:99 to 25:75 w/w. In some embodiments, the weight ratio of MEIC to MF in the composite particles is about 5:90 to 20:80. In some embodiments, the particle size of the composite particle is 0.5 μm to 10 μm at its maximum characteristic length. In some embodiments, the composite particle is 0.5 μm to 10 μm and the film thickness is from 1 μm to 120 μm or from 30 μm to 90 μm.

In other embodiments set forth herein, aspects are related to a Li-secondary battery positive electrode film including composite particles. The composite particles include a mixed electronic ionic conductor (MEIC), a metal fluoride (MF), and optionally an electrically conductive additive including carbon. The film further includes a catholyte and a binder, wherein the catholyte and binder contact the composite particles surfaces but are not contained therein. The composite is characterized by a median diameter (d₅₀) of about 0.1 μm to 15 μm or a diameter (d₉₀) of 1 μm to 40 μm. In some other embodiments, the MF in the composite is characterized by a median diameter (d₅₀) of about 1 nm to 20 nm, about 1 nm to 10 nm, or about 1 nm to 5 nm.

In other embodiments set forth herein, aspects are related to a Li-secondary battery positive electrode film including composite particles. The composite particles include a mixed electronic ionic conductor (MEIC), a conversion chemistry material, and optionally an electrically conductive additive including carbon. The film further includes a catholyte and a binder, wherein the catholyte and binder contact the composite particles surfaces but are not contained therein. The composite particles are characterized by a porosity of less than about 15% v/v at 25° C. In some embodiments, the composites are characterized by a porosity less than about 15% v/v, or less than 12% v/v, or less than 10% v/v, or less than 8% v/v, or less than 6% v/v, or less than 4% v/v, or less than 2% v/v. In some embodiments, the films which include the composites are characterized by a porosity less than about 15% v/v, or less than 12% v/v, or less than 10% v/v, or less than 8% v/v, or less than 6% v/v, or less than 4% v/v, or less than 2% v/v. In these examples, porosity of the composite particles is measured by helium (He) pycnometry. This measurement entails first determining a theoretical density for the nanocomposite. This measurement entails empirically measuring the density of the nanocomposite using He pycnometry. The measurement entails determining the differential between the theoretical density and the empirical density. This measurement entails equating the density differential to a porosity in the empirically measured sample such that the porosity value determined for the nanocomposite accounts for the differential density determined between the empirical density and the theoretical density.

In other embodiments set forth herein, aspects are related to a Li-secondary battery positive electrode film including composite particles. The composite particles include a mixed electronic ionic conductor (MEIC), a metal fluoride (MF), and optionally an electrically conductive additive including carbon. The film further includes a binder that contacts the composite particles surfaces but is not contained therein. The film is characterized by a porosity of less than about 15% v/v. In some embodiments, the MEIC present is carbon.

In other embodiments set forth herein, aspects are related to a method of forming a Li-secondary battery positive electrode film. The method includes providing a combination of a mixed electronic ionic conductor (MEIC), a metal fluoride (MF), optionally a catholyte, and a binder. An electrically conductive additive including carbon is optionally included in the combination. The combination is heated to a temperature of about 80 to 600° C., and pressure is applied to the combination while it is heated. In some embodiments, the applied pressure is 1 to 20,000 pounds per square inch (PSI).

In some embodiments set forth herein, the films including the nanodimensioned composites are observed to have improved electrochemical performance properties (e.g., low impedance, high conductivity, fast cycle rates, and high energy density) due, in part, to the low porosity in the nanocomposite. Because of the distribution of the MEIC in the composites, the conduction of electrons and ions (e.g., Li ions) in, out, and through the composites is observed to be higher than it would have been in the absence of the composite configurations set forth herein. The nanocomposites set forth herein are also well suited for all solid state batteries, which lack a liquid electrolyte which could react with the nanocomposite surface and produce a solid-electrolyte interphase, which typically results in high impedance properties.

In some embodiments set forth herein, aspects are related to a method of forming a Li-secondary battery positive electrode film including annealed composite particles. The method includes preparing a composite including a mixed electronic ionic conductor (MEIC) selected from metal oxides, metal sulfides, metal halides, metal oxyhalides, and combinations thereof, a nanodimensioned metal fluoride (MF), optionally a binder, and optionally an electrically conductive additive comprising carbon. The composite is milled to form a milled composite having a characteristic dimension of about 300 nm to 100 μm. The milled composite is heated to a temperature of about 150° C. to 600° C. for about 2 to 10 hours to form an annealed composite, and the annealed composite is optionally cooled to room temperature. A slurry is prepared by mixing the annealed composite with a catholyte and optionally a binder, the slurry being cast as a film. The film is heated to a temperature of about 80° C. to 400° C., and pressure is applied to the film. In some embodiments, the method includes individually milling the MEIC, MF, optional binder, and/or optional electrically conductive additive prior to combining the MEIC, MF, optional binder, and optional electrically conductive additive in a solvent. In some embodiments, the volume percent of the MEIC in the composite is about 30% (v/v) or less, and in some embodiments the volume percent of the MEIC in the composite is about 15% (v/v) or less. In some embodiments, the MEIC comprises a metal oxide selected from MoO₃₋ₓ where 0≦x≦1, MoOF₄, FeMoO₂, FeMoO₄, MoS₂, MoS, VO_{y} where 1≦y≦2.5, LiV₃O₈, LiV₃O₆, VOF₃, fluorinated vanadium oxide, fluorinated molybdenum oxide, or MoOF. In some embodiments, heating the milled composite reduces the grain boundaries between the constituent components in the milled composite and, in some embodiments, heating the milled composite reduces the porosity of the milled composite. In some embodiments, heating the milled composite produces an additional chemical component different than the MEIC, MF, optional binder, and optional electrically conductive additive, wherein the additional chemical component is selected from FeF₂, FeMoO₄, FeOF, or MoOₓF_{y}, where 1≦x≦2, and 1≦y≦4. In some examples, the annealed nanocomposites have a lower water content as compared to a nanocomposite that was not annealed. The annealing process can drive water out of the nanocomposite if there is water in the nanocomposite (e.g., absorbed moisture from atmosphere). In some examples, the annealed nanocomposites are more crystalline than a nanocomposite that has not been annealed. The annealing process can increase the crystallinity of the materials comprising the nanocomposite. The nanocomposites presented herein show increased rate performance as compared to conversion chemistry positive electrodes that are not manufactured as the nanocomposites set forth herein. In addition, the nanocomposites set forth herein allow for positive electrodes comprising conversion chemistry active materials to access the intercalation capacity at appreciate discharge and charge rates.

In other embodiments set forth herein, aspects are related to a Li-secondary battery positive electrode film including annealed composite particles. The film further includes a catholyte and a binder, and the annealed composite particles include a mixed electronic ionic conductor (MEIC) selected from metal oxides, metal sulfides, metal halides, metal oxyhalides, and combinations thereof, a metal fluoride (MF), and optionally an electrically conductive additive comprising carbon. The catholyte and binder contact the annealed composite particle outer surfaces but are not contained therein. In some embodiments, the annealed composite particles further include a metal oxyfluoride or a metal oxide fluoride, with the metal being iron, copper, nickel, cobalt, or combinations thereof. In some embodiments, the annealed composite particles are characterized by CuKα XRD peaks at one or more of 2θ=26°±1°, 27°±1°, 28°±1°, 29°±1°, 32°±1°, 34°±1°, 35°±1°, 49°±1°, 52.5°±1°, and 55°±1°. In some embodiments, the volume percent of the MEIC in the composite is about 30% (v/v) or less, and in some embodiments the volume percent of the MEIC in the composite is about 15% (v/v) or less. In some embodiments, the annealed composite particles have a characteristic dimension of about 300 nm to 10 μm.

In some embodiments set forth herein, the films including the annealed composite particles are observed to have further improved electrochemical performance properties such as reduced hysteresis and enhanced cyclability (e.g., longer cycle life before any appreciable degradation such as voltage fade). By annealing the milled composite particles before mixing the particles with the catholyte and optional binder, grain growth and recrystallization of the composite particles can occur, contact between grains can be improved (e.g., the “thickness” of grain boundaries can be reduced), new interphases can be formed, porosity can be reduced, and/or the density of the resulting the film can be increased, thereby providing the observed improvements in performance.

### BRIEF DESCRIPTION OF THE DRAWINGS

FIG. 1 shows a scanning electron microscope (SEM) image of a positive electrode film including Flash Evaporated nanodimensioned FeF₃, a LSTPS catholyte, and VGCF carbon (not labeled) and a binder (not labeled).

FIG. 2 shows an SEM image of a positive electrode film including low porosity nanocomposite particles, LSTPS catholyte, and vapor grown carbon fiber (VGCF). The nanocomposite particles shown in FIG. 2 include a composite of MoS₂, FeF₃, and vapor grown carbon fiber. A binder is present but unlabeled and not contained within the nanocomposite.

FIGS. 3-5 show SEM images of a positive electrode film including low porosity nanocomposite particles, LSTPS catholyte, and VGCF. The nanocomposite particles shown in FIGS. 3-5 include a composite of V₂O₅, FeF₃, and VGCF.

FIG. 6 shows an energy-dispersive X-ray spectroscopy (EDX) analysis of the region of interest (ROI) shown in the SEM image of FIG. 5. Referring to the middle representation, darker areas correspond to sulfur and phosphorous, while lighter areas correspond to iron and fluorine.

Now referring to the right representation, darker areas correspond to sulfur and phosphorous, while lighter areas correspond to vanadium.

FIG. 7 shows a SEM of a positive electrode film including spray-coated crystalline FeF₃, LSTPS catholyte, VGCF, and a binder. Weight ratio of FeF₃:LSTPS:binder:VGCF=82.5:12.5:3:2. The material in FIG. 7 is not formulated as a low porosity composite but rather a mixture of FeF₃, LSTPS catholyte, VGCF, and a binder.

FIG. 8 shows size measurements of a sample of low porosity composites each including of FeF₃ and MoS₂. As seen in FIG. 8, the measured particles had a d₁₀ of 0.4 μm, a median particle diameter (d₅₀) of 2.88 μm, and a d₉₀ of 17.6 μm.

FIG. 9 show porosity measurements for positive electrode films including Atomic Layer Deposition (ALD)-coated FeF₃, MoS₂/FeF₃ nanocomposite particles, and spray-coated crystalline FeF₃, using various calender temperatures. The films in each sample included a LSTPS catholyte, VGCF, and a binder, with the MoS₂/FeF₃ nanocomposite particles also including VGCF. As seen in FIGS. 9A-9B, the films including the lower porosity composites demonstrated reduced impedance as compared to films including composites with higher porosity.

FIG. 10 shows measurements of voltage (V) as a function of specific capacity (mAh/g) for a positive electrode film including low porosity nanocomposite particles of FeF₃, V₂O₅, VGCF, and with a binder but not including a catholyte in the film.

FIG. 11 shows an SEM image of a low porosity composite of CuF₂:FeF₃N₂O₅ prepared according to Example 6.

FIG. 12 shows an energy-dispersive X-ray spectroscopy (EDX) analysis of a region of interest (ROI) shown in the SEM image of FIG. 11. As seen in FIG. 12, Fe (lighter color) is present in the nanocomposite particles.

FIG. 13 shows an energy-dispersive X-ray spectroscopy (EDX) analysis of a region of interest (ROI) shown in the SEM image of FIG. 11. As seen in FIG. 13, V (lighter color) is present in the nanocomposite particles.

FIG. 14 shows a low porosity composite of CuF₂:FeF₃/MoS₂ prepared according to Example 7.

FIG. 15 shows a low porosity composite of CuF₂:FeF₃/MoS₂ prepared according to Example 7.

FIG. 16 shows Voltage v. Run active mass-specific capacity (mAh/g) plots for all-solid-state platform cathode films with and without a nanocomposites therein. The film without the nanocomposites included milled cathode active powder materials but without the nanocomposite dopant therein.

FIG. 17 shows a performance comparison for a solid state cell v. a liquid state cell for cathode films including a nanocomposite of FeF₃, V₂O₅, and VGCF.

FIG. 18 shows a plot of Voltage v. cycle active mass-specific capacity (mAh/g) for all solid-state platform cathode films having nanocomposites therein with different types of FeF₃ with V₂O₅ and VGCF. Sample 1 is flash evaporated Cu-doped FeF₃ at about 4 atomic % Cu doping; sample 2 is flash evaporated FeF₃ without a dopant therein; sample 3 is crystalline FeF₃.

FIG. 19 shows a comparison plot of Voltage v. Run state of charge [%] in which a 5 μm diameter cathode particle film in a solid state battery configuration is compared with a 5 μm diameter cathode particle film in a liquid electrolyte battery configuration. Solid state formulation shows beneficial capacity and voltage over liquid formulation.

FIG. 20 compares Voltage v. Run active mass-specific capacity (mAh/g) plots for positive electrode films including annealed and non-annealed composite particles. For all samples, a C/10 rate was used with the composite particles comprising 24% (w/w) MoO₃ and 75% (w/w)) Cu-doped FeF₃. The annealed samples were heated to 350° C. for 4 hours according to Example 9.

FIG. 21 compares Voltage v. Run active mass-specific capacity (mAh/g) plots for positive electrode films including composite particles annealed at different temperatures. Both samples were cycled twice at a rate of C/10 followed by once at a C/3 rate, with the composite particles comprising 24% (w/w) MoO₃ and 75% (w/w) Cu-doped FeF₃. One sample was annealed at 250° C. for 4 hours and the other sample was annealed at 350° C. for 4 hours.

FIG. 22 compares x-ray diffraction (XRD) data for positive electrode films including non-annealed composite particles, annealed composite particles including “Purple” MoO₃ MEIC that was milled with ethanol prior to annealing, and annealed composite particles including “Sky Blue” MoO₃ MEIC was milled with isopropanol prior to annealing.

### DETAILED DESCRIPTION

### I. GENERAL

Set forth herein are Li-secondary battery positive electrode films including composite particles that each include a metal fluoride (MF) and optionally also a mixed electronic ionic conductor (MEIC), and, optionally, an electrically conductive additive comprising carbon. The film can further comprise a catholyte and a binder, where the catholyte and binder contact the composite particle's surfaces but are not contained therein. In some embodiments, the composite particles include a MEIC and a conversion chemistry material which includes a MF or other type of conversion chemistry material. In some particular embodiments, the positive electrode film does not include a catholyte. In some other embodiments, the positive electrode film does not include a catholyte which, in some examples, is a sulfur-including catholyte but rather includes a catholyte that lacks sulfur, e.g., a lithium stuffed garnet or a lithium borate. Set forth herein are also methods of making Li-secondary battery positive electrode films having nanodimensioned composites therein. In some examples, a gel is used for the catholyte. Example gels are found in U.S. Pat. No. 5,296,318, entitled RECHARGEABLE LITHIUM INTERCALATION BATTERY WITH HYBRID POLYMERIC ELECTROLYTE, to Gozdz, et al.

The positive electrode film in accordance with embodiments set forth herein can have composites that have a very low porosity, e.g., less than about 15% v/v at 25° C. or about 0.5 to about 20% v/v. The positive electrode film in accordance with embodiments can have nanodimensioned composites that have a very low porosity, e.g., less than about 15% v/v at 20° C. The positive electrode film in accordance with embodiments can have composites therein that have a very low porosity, e.g., less than about 15% v/v at 30° C. The low porosity composites can result from the novel combinations of components, component characteristics such as particle size, methods of forming, pressure and temperature application in combination with materials selection, and/or other aspects describe herein. By reducing the presence of porous voids, volumetric energy density and, or, power output is increased, thereby allowing for smaller volume batteries to be used in a given application or for each battery that has the nanodimensioned composites set forth herein to have improved power, rate and energy density characteristics, as compared to a battery not having the nanodimensioned composites set forth herein.

In some embodiments, set forth herein are nanodimensioned composites that are characterized by a median physical dimension that is equal to the thickness of the film in which the nanodimensioned composite is included. In some embodiments, the median physical dimension is about the thickness of the film, or the median physical dimension is about half the thickness of the film, or the median physical dimension is about one quarter of the thickness of the film, or the median physical dimension is about one eighth the thickness of the film. For example, in some embodiments, the nanodimensioned composites have a median physical dimension of about 5 μm, these composites are in a film that is about 60 μm thick, and, further, the nanodimensioned composites are characterized by features therein which are separated by about 100 nm or less but greater than 0.1 nm (e.g., the distance between the MEIC and the MF in the nanodimensioned composite). The nanocomposite includes at least one member selected from the group consisting of a metal fluoride, a MEIC, and carbon. In some embodiments, the nanocomposite may be spherical in which the median physical dimension is the diameter of the sphere. In some embodiments, the nanocomposite is irregularly shaped and the maximum length of the irregularly shaped nanocomposite is the median physical dimension characteristic set forth herein. In some embodiments, the nanocomposite has nanodimensioned features within a micron sized nanocomposite particle. For example, the nanocomposite may be about a micron in size but have nanodimensioned features (e.g., protrusions, surface roughness, digitations, fingers, spacing between materials, grain boundaries, etc. . . . ). In some examples, the film is about 1-50 μm in thickness, the nanocomposite is 500 nm to 20 μm in median physical dimension and the nanocomposite also has protrusions, digitations, extended features, or distances between the MEIC and the MF which are about 1 nm to about 50 nm in characteristic dimension.

Also set forth herein are Li-secondary battery positive electrode films including annealed composite particles and methods of making films including such annealed composite particles. In some embodiments, the method can include preparing a composite including a mixed electronic ionic conductor (MEIC) comprising a member selected from metal oxides, metal sulfides, metal halides, metal oxyhalides, and combinations thereof, a nanodimensioned metal fluoride (MF), an optional binder, and an optional electrically conductive additive comprising carbon. The composite can be milled to form a milled composite having a characteristic dimension of about 300 nm to 100 μm. The milled composite can be heated to a temperature of about 150° C. to 600° C. for about 2 to 10 hours to form an annealed composite which can be optionally cooled to room temperature. A slurry can be prepared by mixing the annealed composite with a catholyte and an optional binder, with the slurry being cast as a film. the film can be heated to a temperature of about 80° C. to 400° C. with pressure being applied to the film.

In some embodiments, the Li-secondary battery positive electrode films can include annealed composite particles, a catholyte, and a binder. The annealed composite particles can comprise a mixed electronic ionic conductor (MEIC) selected from metal oxides, metal sulfides, metal halides, metal oxyhalides, and combinations thereof, a metal fluoride (MF), and an optional electrically conductive additive comprising carbon. The catholyte and binder in the film can contact the outer surfaces of the annealed composite particle outer surfaces without being contained therein. In some embodiments, the annealed composite particles can include an additional component including, but not limited to, a metal oxyfluoride and/or a metal oxide fluoride. In some embodiments, the annealed composite particles can be characterized by CuKαXRD peaks at one or more of 2θ=26°±1°, 27°±1°, 28°±1°, 29°±1°, 32°±1°, 34°±1°, 35°±1°, 49°±1°, 52.5°±1°, and 55°±1°.

### II. DEFINITIONS

As used herein, a “positive electrode” refers to the electrode in a secondary battery towards which positive ions, e.g., Li⁺, flow or move during discharge of the battery. As used herein, a “negative electrode” refers to the electrode in a secondary battery from where positive ions, e.g., Li⁺, flow or move during discharge of the battery. In a battery comprised of a Li-metal electrode and a conversion chemistry electrode, the electrode having the conversion chemistry materials (i.e., active material; e.g., NiFₓ), is referred to as the positive electrode. In some common usages, cathode is used in place of positive electrode, and anode is used in place of negative electrode. When a Li-secondary battery is charged, Li ions move from the positive electrode towards the negative electrode (e.g., Li-metal). When a Li-secondary battery is discharged, Li ions move towards the positive electrode and from the negative electrode (e.g., Li-metal).

As used herein, “about” when qualifying a number, e.g., 15% v/v, refers to the number qualified and optionally the numbers included in a range about that qualified number that includes ±10% of the number. For example, about 15% v/v includes 15% v/v as well as 13.5% v/v, 14% v/v, 14.5% v/v, 15.5% v/v, 16% v/v, or 16.5% v/v.

As used herein, the term “flash evaporation” refers to the process of flash evaporation set forth in International Patent Application No. PCT/US14/41203, filed Jun. 6, 2014, and entitled Flash Evaporation of Solid State Battery Components, the contents of which are incorporated by reference in their entirety. Flash evaporation refers to the process whereby precursor chemicals are heated, typically under a reduced pressure or vacuum atmosphere, to vaporize the precursor chemicals. The vaporized precursor chemicals are then transferred into a process region, through a nozzle or aperture that regulates gas flow, where the evaporated vapors can subsequently mix, react and condense on a substrate.

As used herein, the term “atomized particles” refers to particles prepared by an atomization process (e.g., an Endura machine, Flash Evaporation methods). Atomized particles are prepared, in some examples, by volatilization of substrates of elements or compounds under vacuum conditions followed by a layer-by-layer deposition process of those volatilized substrates. Atomized particles are also described, for example, in U.S. Patent Application Publication No. 2014/0170493, entitled NANOSTRUCTURED MATERIALS FOR ELECTROCHEMICAL CONVERSION REACTIONS, and filed Jun. 19, 2013 as U.S. patent application Ser. No. 13/922,214, the contents of which are incorporated by reference in their entirety.

As used herein, a “mixed electronic ionic conductor” (MEIC) refers to a material that conducts both ions (e.g., Li⁺ ions) and electrons. MEICs useful in the examples set forth herein include, but are not limited to, carbon (C), MoSₓ wherein 0<x≦3, MoS₂, MoS, LiV₃O₈, LiV₃O₆, MoOF, MoO₃₋ₓ wherein 0≦x≦1, LiₓVO_{y} wherein 0≦x≦2y and 1≦y≦2.5, V₂O₅, MnₐO_{b} where 1≦a≦2 and 1≦b≦7, MnO, Mn₃O₄, Mn₂O₃, MnO₂, LiAlCl₄, lithium super ionic conductor (LISICON), sodium super ionic conductor (NASICON), Na₁₊ₓZr₂SiₓP₃₋ₓO₁₂ wherein x in each instance is 0<x<3 and optionally wherein Na, Zr and/or Si are replaced by isovalent elements, NASICON-structured phosphates, Li_{c}Na_{c}V₂(PO₄)₃ wherein c in each instance is independently 0<c<1, Li_{d}Na_{d}MₑM′_{f}(PO₄)₃ wherein d in each instance is independently 0≦d≦2, and 0≦e≦2, 0≦f≦2, and M and M′ are metals selected from the group consisting of V, Nb, Ta, Cr, Fe, Al, Co, Ni, and Cu, Li_{g}MM′(SO₄)₃ where M and M′ are transition metals and g is selected so that the compound is charge neutral, and LiMXO₄ where X is Ge, Si, Sb, As, or P, LiₕNaV₂(PO₄)₃, LiₕNa₂FeV(PO₄)₃, LiₕFeTi(PO₄)₃, LiₕTiNb(PO₄)₃, LiₕFeNb(PO₄)₃, wherein 0≦h≦1, and antiperovskite.

As used herein, a “metal fluoride” (MF) refers to a material including a metal component and a fluorine (F) component. A MF can optionally include a lithium (Li) component. In the charged state, the MF includes a fluoride of a metal which can convert into a lithium fluoride salt and a reduced metal, in the discharged state. For example, the charged state MF can convert to a metal and lithium fluoride during discharge of a battery in accordance with the following reaction:

Li+MF→LiF+M

MFs useful in the disclosure set forth herein include, but are not limited to, LiF, Li_{z}FeF₃, Li_{z}CuF₂, Li_{z}NiF₂, Li_{z}CoF₂, Li_{z}CoF₃, Li_{z}MnF₂, Li_{z}MnF₃, where 0≦z≦3, and the like. In some embodiments, the MF can be nanodimensioned and, in some embodiments, the MF is in the form of nanodomains. In some embodiments, the MF can be LiF and can further include a nanodimensioned metal including, Fe, Co, Mn, Cu, Ni, Zr, or combinations thereof. MFs useful in the disclosure set forth herein include those set forth in U.S. Patent Application Publication No. 2014/0170493, entitled NANOSTRUCTURED MATERIALS FOR ELECTROCHEMICAL CONVERSION REACTIONS, and filed Jun. 19, 2013 as U.S. patent application Ser. No. 13/922,214, the contents of which are incorporated by reference in their entirety. MFs useful in the in the disclosure set forth herein also include those set forth in U.S. Provisional Patent Application No. 62/038,059, entitled DOPED CONVERSION MATERIALS FOR SECONDARY BATTERY CATHODES, and filed Aug. 15, 2014, also U.S. Provisional Patent Application No. 62/189,669, entitled DOPED CONVERSION MATERIALS FOR SECONDARY BATTERY CATHODES, and filed Jul. 7, 2015, the contents of which are incorporated by reference in their entirety.

As used herein, “nanodimensioned” refers to a composite material wherein the constituent components are separated by nanodimensions. For example, a nanodimensioned composite material may include a Li-containing compound, e.g., LiF, and an Fe-containing compound, e.g., Fe, wherein the domains of Fe and the domains of LiF have median physical dimensions of about 1-100 nm, or 2-50 nm, or 1-10 nm, or 2-5 nm, or 5-15 nm, or 5-20 nm, or the like as measured in a TEM micrograph by identification of regions of visual contrast of different nanodomains. In some examples, nanodimensioned includes 1-5 nm, or 5-10 nm, or 0.1-1 nm, or 0.1-5 nm.

As used herein, “nanodomains” refers to a material having domains therein with a median characteristic dimension of about 20 nm or less. As used herein, characteristic dimension is the length of a straight line extending between the maximally spaced boundaries (e.g., edges) of a given nanodomain. For example, if the nanodomain is square shaped with a square side length of 10 nm, the characteristic dimension would be a diagonal across the square shaped particle having a length of about 14.14 nm (i.e., square root of 200). Nanodomains include a material component having a boundary edge that has a median characteristic dimension of about 20 nm or less at the maximum boundary edge separation. In some examples, the median characteristic dimension of the nanodomains is about 5 nm or less. In some examples, the median characteristic dimension of the nanodomains is about 10 nm or less. In some examples, the median characteristic dimension of the nanodomains is about 1 nm. In some materials, the metal in the MF includes metal nanodomains having a median dimension of less than about 20 nm. In some materials, the nanodomains are substantially homogeneous within a volume of about 1000 nm³.

As used herein, “electrically conductive additive comprising carbon” refers to a material that is included in the composite particles and/or mixed with the positive electrode materials in order to improve the electrical conductivity of the electrode. Electrically conductive additives comprising carbon useful in the disclosure set forth herein include, but are not limited to, activated carbon, carbon black, carbon fibers, carbon nanotubes, carbon nanofibers, graphite, graphene, C65 carbon, fullerenes, ketjen black, vapor grown carbon fiber (VGCF), acetylene black, and the like.

As used herein, a “catholyte” refers to an ion conductor that is intimately mixed with, or that surrounds, or that contacts the MF, the composite particles including a MF and optionally an MEIC, composite particles including an MEIC and a conversion chemistry material, or composite particles including an MEIC and any other suitable active material. Catholytes suitable with the embodiments described herein include, but are not limited to, LSS, LXPS, LXPSO, where X is Si, Ge, Sn, As, Al, LATS, also Li-stuffed garnets, or combinations thereof, and the like. Catholytes may also be liquid, gel, semi-liquid, semi-solid, polymer, and/or solid polymer ion conductors known in the art. Catholytes include those catholytes set forth in International PCT Patent Application No. PCT/US14/38283, entitled SOLID STATE CATHOLYTE OR ELECTROLYTE FOR BATTERY USING Li_{A}MP_{B}S_{C} (M=Si, Ge, AND/OR Sn), filed May 15, 2014, the contents of which are incorporated by reference in their entirety. Catholytes include those catholytes set forth in International PCT Patent Application No. PCT/US2014/059575, entitled GARNET MATERIALS FOR LI SECONDARY BATTERIES AND METHODS OF MAKING AND USING GARNET MATERIALS, filed Oct. 7, 2014, the contents of which are incorporated by reference in their entirety.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≦x≦0.5, 0.1≦y≦0.2, 0.4≦z≦0.55, and it may include up to 10 atomic % oxygen. LSS also refers to an electrolyte material comprising Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≦5 and 0<y≦5.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≦x≦0.65, 0.05≦y≦0.2, and 0.25≦z≦0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein, “LXPS” refers to a catholyte material characterized by the formula LiₐMP_{b}S_{c}, where M is Si, Ge, Sn, and/or Al, and where 2≦a≦8, 0.5≦b≦2.5, 4≦c≦12. “LSPS” refers to an electrolyte material characterized by the formula LₐSiP_{b}S_{c}, where 2≦a≦8, 0.5≦b≦2.5, 4≦c≦12. Exemplary LXPS materials are found, for example, in International Patent Application No. PCT/US2014/038283, filed May 16, 2014, and entitled SOLID STATE CATHOLYTE OR ELECTROLYTE FOR BATTERY USING LI_{A}MP_{B}S_{C} (M=Si, Ge, AND/OR Sn), which is incorporated by reference herein in its entirety. When M is Sn and Si—both are present—the LXPS material is referred to as LSTPS. As used herein, “LSTPSO,” refers to LSTPS that is doped with, or has, O present. In some examples, “LSTPSO,” is a LSTPS material with an oxygen content between 0.01 and 10 atomic %. “LSPS,” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some examples, “LSPSO,” is a LSPS material with an oxygen content between 0.01 and 10 atomic %. As used herein, “LATP,” refers to an electrolyte material having Li, As, Sn, and P chemical constituents. As used herein

“LAGP,” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≦a≦8, 0.5≦b≦2.5, 4≦c≦12, d<3. LXPSO refers to LXPS, as defined above, and having oxygen doping at from 0.1 to about 10 atomic %.

As used herein, “LPS,” refers to an electrolyte having Li, P, and S chemical constituents. As used herein, “LPSO,” refers to LPS that is doped with or has O present. In some examples, “LPSO,” is a LPS material with an oxygen content between 0.01 and 10 atomic %. LPS refers to an electrolyte material that can be characterized by the formula LiₓP_{y}S_{z} where 0.33≦x≦0.67, 0.07≦y≦0.2 and 0.4≦z≦0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %.

As used herein, “LPSO” refers to an electrolyte material characterized by the formula LiₓP_{y}S_{z}O_{w} where 0.33≦x≦0.67, 0.07≦y≦0.2, 0.4≦z≦0.55, 0≦w≦0.15. Also, LPSO refers to LPS, as defined above, that includes an oxygen content of from 0.01 to 10 atomic %. In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, “Li-stuffed garnet” refers to oxides that are characterized by a crystal structure related to a garnet crystal structure. Li-stuffed garnets include compounds having the formula LiₐLa_{b}M′_{c}M″_{d}ZrₑO_{f}, LiₐLa_{b}M′_{c}M″_{d}TaₑO_{f}, or LiₐLa_{b}M′_{c}M″_{d}NbₑO_{f}, where 4<a<8.5, 1.5<b<4, 0≦c≦2, 0≦d≦2; 0≦e≦2, 10<f<13, and M′ and M″ are, independently in each instance, selected from Al, Mo, W, Nb, Sb, Ca, Ba, Sr, Ce, Hf, Rb, or Ta, or LiₐLa_{b}Zr_{c}Al_{d}Me″ₑO_{f}, where 5<a<7.7, 2<b<4, 0<c≦2.5, 0≦d<2, 0≦e<2, 10<f<13 and Me″ is a metal selected from Nb, Ta, V, W, Mo, or Sb and as described herein. “Garnets,” as used herein, also include those garnets described above that are doped with Al₂O₃. Garnets, as used herein, also include those garnets described above that are doped so that Al³′ substitutes for Lit As used herein, Li-stuffed garnets, and garnets, generally, include, but are not limited to, Li_{7.0}La₃(Zrₜ₁+Nbₜ₂+Taₜ₃)O₁₂+0.35Al₂O₃, wherein (t1+t2+t3=subscript 2) so that the La:(Zr/Nb/Ta) ratio is 3:2. Also, garnet and lithium-stuffed garnets as used herein can include LiₓLa₃Zr₂O₁₂+yAl₂O₃, where x ranges from 5.5 to 9 and y ranges from 0 to 1. In some embodiments, x is 7 and y is 1.0. In some embodiments, x is 7 and y is 0.35. In some embodiments, x is 7 and y is 0.7. In some embodiments x is 7 and y is 0.4. Also, garnets as used herein can include LiₓLa₃Zr₂O₁₂+yAl₂O₃. Exemplary lithium-stuffed garnets are found in the compositions set forth in International Patent Application Nos. PCT/US2014/059575 and PCT/US2014/059578, filed Oct. 7, 2014, entitled GARNET MATERIALS FOR LI SECONDARY BATTERIES AND METHODS OF MAKING AND USING GARNET MATERIALS.

As used herein, a “binder” refers to a material that assists in the adhesion of another material. Binders useful in the disclosure set forth herein include, but are not limited to, polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), stereoblock polypropylenes, polypropylene polymethylpentene copolymer, polyethylene oxide (PEO), PEO block copolymers, silicone, and the like.

As used herein, “porosity” refers to a measure of the void (i.e., empty) spaces in a material, and can be a fraction or percentage of the volume of voids over the total volume of the material. Porosity may depend on temperature as a result of thermal expansion. In some embodiments, positive electrode films described herein can have a porosity of less than about 15% v/v at 25° C. In some other embodiments, positive electrodes films described herein can have a porosity of less than about 10%, 5%, or less than about 3%. Porosity herein is measured, for example, by pycnometry techniques described above.

As used herein, “discharge voltage” refers to the voltage (or potential) v. Li metal at which Li ions spontaneously move from the negative electrode to the positive electrode.

As used herein, “discharge voltage window” refers to the range of voltages v. Li metal within which Li ions spontaneously move from the negative electrode to the positive electrode.

As used herein, “charge voltage window” refers to the range of voltages v. Li metal within which Li ions spontaneously move from the positive electrode to the negative electrode.

As used herein, a “dopant” refers to an impurity, or an added element, ion, chemical, or material, which is present in amounts less than the amount of the substance into which the dopant is added in order to alter the properties of the substance. In some embodiments, the MF can be doped with a dopant including, but not limited to, oxygen, carbon, a metal selected from the group consisting of Li, Mg, Al, Si, Ca, Ti, V, Cr, Mn, Mo, Fe, Co, Ni, Cu, Zn, Y, Zr, Nb, Ba, or Hf, a metal oxide of said metal, a cation of said metal, a metal fluoride of said metal, or combinations thereof. In some embodiments, the dopant can include Li₂O, Cu, CuF₂, Mo, MoO₂, MoO₃, NiF₂, ZrF₄, CaF₂, or AlF₃. In some embodiments, the dopant can include Li₂O, Cu, CuF₂, Mo, MoO₂, MoO₃, NiF₂, ZrF₄, CaF₂, or AlF₃, at from about 0.1 to 15 atomic % concentration in the doped material. In some embodiments, the dopant can include Li₂O, Cu, CuF₂, Mo, MoO₂, MoO₃, NiF₂, ZrF₄, CaF₂, or AlF₃, at from about 0.5 to 8 atomic % concentration in the doped material. In some embodiments, the dopant can include Li₂O, Cu, CuF₂, Mo, MoO₂, MoO₃, NiF₂, ZrF₄, CaF₂, or AlF₃, at from about 3 to 7 atomic % concentration in the doped material.

As used herein, the “substantially free from oxygen” refers to a material having less than about 5% atomic oxygen, or having less than about 3% atomic oxygen.

As used herein, a “thickness” by which is film is characterized refers to the distance, or median measured distance, between the top and bottom faces of a film. As used herein, the top and bottom faces refer to the sides of the film having the largest surface area.

As used herein “median diameter (d₅₀)” refers to the median size, in a distribution of sizes, measured by microscopy techniques or other particle size analysis techniques, including, but not limited to, scanning electron microscopy or dynamic light scattering. D₅₀ includes the characteristic dimension at which 50% of the particles are smaller than the recited size.

As used herein “diameter (d₉₀)” refers to the size, in a distribution of sizes, measured by microscopy techniques or other particle size analysis techniques, including, but not limited to, scanning electron microscopy or dynamic light scattering. D₉₀ includes the characteristic dimension at which 90% of the particles are smaller than the recited size.

As used herein “diameter (d₁₀)” refers to the size, in a distribution of sizes, measured by microscopy techniques or other particle size analysis techniques, including, but not limited to, scanning electron microscopy or dynamic light scattering. D₁₀ includes the characteristic dimension at which 10% of the particles are smaller than the recited size.

As used herein “conversion chemistry material” refers to a material that undergoes a chemical reaction during the charging and discharging cycles of a secondary battery. Conversion chemistry materials useful in the disclosure set forth herein include, but are not limited to, LiF, Fe, Cu, Ni, FeF₂, FeO_{d}F_{3-2d}, FeF₃, CoF₃, CoF₂, CuF₂, NiF₂, where 0≦d≦0.5, and the like. Exemplary conversion chemistry materials are found, for example, in U.S. Patent Publication No. 2014/0117291, filed Oct. 25, 2013, and entitled METAL FLUORIDE COMPOSITIONS FOR SELF FORMED BATTERIES, and in U.S. Provisional Patent Application No. 62/038,059, filed Aug. 15, 2014, entitled DOPED CONVERSION MATERIALS FOR SECONDARY BATTERY CATHODES, all of which are incorporated by reference herein in their entirety. Exemplary conversion chemistry materials are found, for example, in U.S. Patent Application Publication No. 2014/0170493, entitled NANOSTRUCTURED MATERIALS FOR ELECTROCHEMICAL CONVERSION REACTIONS, and filed Jun. 19, 2013 as U.S. patent application Ser. No. 13/922,214, the contents of which are incorporated by reference in their entirety. Other conversion chemistry materials suitable for use with the disclosure herein include active electrode materials selected from NCA (lithium nickel cobalt aluminum oxide), LMNO (lithium manganese nickel oxide), NMC (lithium nickel manganese cobalt oxide), LCO (lithium cobalt oxide, i.e., LiCoO₂), nickel fluoride (NiFₓ, wherein x is from 0 to 2.5), copper fluoride (CuF_{y}, wherein y is from 0 to 2.5), or FeF, (wherein z is selected from 0 to 3.5).

As used herein, “providing” refers to the provision, generation, presentation, or delivery of that which is provided. Providing includes making something available. For example, providing LiF refers to the process of making LiF available, or delivering LiF, such that LiF can be used as set forth in a method described herein.

As used herein, “heating” refers to a process whereby an external device transfers thermal energy to another material thereby increasing the temperature of the material. Devices useful in the disclosure set forth herein for transferring thermal energy to a material include, but are not limited to, calendering devices, sintering devices (e.g., hot pressing devices, field assisted sinter technique (FAST) devices, spark plasma sintering (SPS) devices, etc.), annealing devices (e.g., tube furnaces, ovens), and the like.

As used herein, “applying pressure,” refers to a process whereby an external device induces a pressure in another material. External devices suitable for use with the disclosure herein for inducing pressure in a material include, but are not limited to, calendering devices, sintering devices (e.g., hot pressing devices, field assisted sinter technique (FAST) devices, spark plasma sintering (SPS) devices, etc.), and the like.

As used herein, “casting a slurry” refers to a process wherein a slurry is deposited onto, or adhered to, a substrate. Casting can include, but is not limited to, slot casting and dip casting.

As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm.

As used herein, the phrase “dip casting” or “dip coating” refers to a deposition process whereby substrate is coated, or deposited, with a solution, liquid, slurry, or the like, by moving the substrate into and out of the solution, liquid, slurry, or the like, often in a vertical fashion.

As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot dye, slip and/or tape casting, and other methods known to those skilled in the art.

As used herein, “selected from the group consisting of refers to a single member from the group, more than one member from the group, or a combination of members from the group. A member selected from the group consisting of A, B, and C includes, for example, A only, B only, or C only, as well as A and B, A and C, B and C , as well as A, B, and C.

As used herein, the term “NASICON,” unless otherwise specified refers to sodium (Na) super ionic conductors which are often characterized by the chemical formula Na₁₊ₓZr₂SiₓP₃₋ₓO₁₂, 0<x<3, optionally wherein Na, Zr and/or Si are replaced by isovalent elements.

As used herein, the term “LISICON,” unless otherwise specified refers to lithium (Li) super ionic conductors which are often characterized by the chemical formula Li₂₊₂ₓZn₁₋ₓGeO₄.

As used herein, the term “characteristic length” and “characteristic particle size dimension” refers to the physical distance for a given particle or nanocomposite at the maximum separation of the boundaries of said particle or nanocomposite. For example, the characteristic length of a sphere is the diameter of the sphere. As used herein, the characteristic particle size dimension includes the largest dimension of a composite particle or the diameter for a spherically shaped composite particle. As used herein, the characteristic dimension for particle features in a composite includes, for example, the distance between MEIC and metal fluoride, or between composite particle protrusions, grain boundaries, material boundaries, digitation, or particle surface roughness.

As used herein, the term “annealing” refers to a thermal treatment process wherein a solid material (e.g., a ceramic, an oxide, a composite oxide, etc. . . . ) is controllably heated and cooled in order to densify the material, strengthen the material, reduce grain boundaries, increase crystallite size, and, or, reduce or minimize internal stress and strain.

As used herein, the term “milling” refers to a grinding process whereby a material is made smaller through the grinding, crushing, or similar milling process. Milling can be accomplished by a variety of milling techniques such as, but not limited to, wet milling, high energy milling, sonication milling, milling with a grinding media, solvent milling, jet milling and wet milling. In some examples, a ceramic or oxide is milling so that it has a uniform particle size distribution (e.g., small polydispersity) and, or, a smaller size than the oxide has before it is milled. Milling can include a grinding media (e.g., ZrO₂ grinding beads, or La₂O₃ grinding beads) which may be inert to the material being milled.

As used herein, the term “wet milling” refers to a milling process in which a solvent is mixed with, or suspends, the material being milled. In some examples, wet milling provides for a milling process that results in smaller sized particles as compared to a milling process that does not include a solvent.

As used herein, the term “cooling” refers to process whereby the temperature of an object cooled is lowered. Cooling refers to the process of removing or transferring heat energy away from an object being cooled.

As used herein, the term “annealed composite” refers to a composite material having a new in situ formed chemical composition, a composite material, which has been annealed, and having reduced grain boundaries, a composite material with improved contact between grains (e.g., a reduced “thickness” of grain boundaries), and/or a composite having larger grain sizes, as compared to the same composite material prior to annealed.

As used herein, the term “reduced grain boundaries” refers to a reduction or minimization of the surface area exposed between grains. Certain materials, such as oxides, are characterized by both crystalline and amorphous components, both having the same or similar chemical compositions. In these materials, crystalline components tend to aggregate into clusters referred to as grains, which comprise crystalline and amorphous materials or just crystalline materials. These grains often have irregular shapes which prevents them from packing in a solid without leaving porous vacant space between the grains. When these materials are heated (e.g., in annealing conditions), the materials may have grains which increase in physical size. As the grains increase in size, by for example becoming more crystalline and less amorphous, the grains may make more contact with neighboring grains such that the porous vacant space between the grains is reduced. In some examples, as the grains grow in size, they densify and pack with other grains in a denser fashion. In these examples, the reduction in grain boundaries is associated with an increased grain size, or a denser grain, or grains which contact other grains with less porous vacant space between the grains.

As used herein, the phrases “metal oxyfluoride” or a “metal oxide fluoride” refer to a compound that includes an oxidized metal, oxygen and fluorine. Example metal oxyfluorides, or metal oxide fluorides, include but are not limited to molybdenum oxyfluoride (e.g., MoOF₃, VOF₃, LaO₁₋ₓF₁₊₂ₓ wherein x is from 0 to 1). In some of these materials the metal oxide fluoride is characterized by a solid solution of a metal oxide and also a metal fluoride.

As used herein, a “transition metal” refers to an element in the “d-block” of the period table including Sc, Ti, V, Cr, Mn, Fe, Co, Ni, Cu, Zn, Y, Zr, Nb, Mo, Ru, Rh, Pd, Ag, Cd, Hf, Ta, W, Re, Os, Ir, Pt, Au, and Hg. Exemplary transition metals useful in the presentdisclosure include, but are not limited to, Fe, Cu, Ni, Mo, Co, alloys thereof, and combinations thereof

### III. POSITIVE ELECTRODE FILMS WITH MEIC/MF COMPOSITE PARTICLES

In some examples, set forth herein is a Li-secondary battery positive electrode film. In some embodiments, the disclosure herein provides a Li-secondary battery positive electrode film including composite particles that each include a mixed electronic ionic conductor (MEIC), a metal fluoride (MF), and, optionally, an electrically conductive additive comprising carbon. The film can further comprise a catholyte and a binder, where the catholyte and binder contact the composite particles surfaces but are not contained therein.

In the disclosure herein, metal fluoride can be substituted with other types of conversion chemistry materials in some embodiments.

In some embodiments, the film have a porosity of less than about 15% v/v at 25° C. In other embodiments, the film have a porosity of less than about 14% v/v at 25° C. In some other embodiments, the film have a porosity of less than about 13% v/v at 25° C. In some other embodiments, the film have a porosity of less than about 12% v/v at 25° C. In some other embodiments, the film have a porosity of less than about 11% v/v at 25° C. In some other embodiments, the film have a porosity of less than about 10% v/v at 25° C. In some other embodiments, the film have a porosity of less than about 9% v/v at 25° C. In some other embodiments, the film have a porosity of less than about 8% v/v at 25° C. In some other embodiments, the film have a porosity of less than about 7% v/v at 25° C. In some other embodiments, the film have a porosity of less than about 6% v/v at 25° C. In some other embodiments, the film have a porosity of less than about 5% v/v at 25° C. In some other embodiments, the film have a porosity of less than about 4% v/v at 25° C. In some other embodiments, the film have a porosity of less than about 3% v/v at 25° C.

The MEIC included in the composite particles includes any suitable material that conducts both ions and electrons. Suitable MEICs include MoS₂, MoO₃₋ₓ where 0≦x≦1, VOₓ where 1≦x≦2.5, MnOₓ where 1≦x≦3.5, LiAlCl₄, LiₓNa_{y}MₐM′_{b}(PO₄)₃ where 0≦x≦1, 0≦y≦2, 0≦a≦2, 0≦b≦2, and M and M′ are transition metals, LiₓMM′(SO₄)₃ where M and M′ are transition metals, or LiMXO₄ where M is a transitional metal and X is Ge, Si, Sb, As, or P. In some embodiments, the MEIC is MoS₂. In other embodiments, the MEIC is MoO₃₋ₓ where 0≦x≦1. In some other embodiments, the MEIC is VOₓ where 1≦x≦2.5. In some other embodiments, the MEIC is MnOₓ where 1≦x≦3.5. In some other embodiments, the MEIC is LiAlCl₄. In some other embodiments, the MEIC is LiₓNa_{y}MₐM′_{b}(PO₄)₃ where 0≦y≦2, 0≦a≦2, 0≦b≦2, and M and M′ are transition metals. In some other embodiments, the MEIC is LiₓMM′(SO₄)₃ where M and M′ are transition metals. In some other embodiments, the MEIC is LiMXO₄ where M is a transitional metal and X is Ge, Si, Sb, As, or P, and the like.

In some other examples, the MEIC is selected from carbon (C), MoS₂, MoS, LiV₃O₈, LiV₃O₆, MoOF, MoO₃, where 0≦x≦1, VO_{y} where 1≦y≦2.5, V₂O₅, MnₐO_{b} where 1≦a≦2 and 1≦b≦7, MnO, Mn₃O₄, Mn₂O₃, MnO₂, LiAlCl₄, LISICON, NASICON, Na₁₊ₓZr₂SiₓP₃₋ₓO₁₂, 0<x<3, optionally wherein Na, Zr and/or Si are replaced by isovalent elements, NASICON-structured phosphates, Li_{c}Na_{c}V₂(PO₄)₃ wherein c, in each instance is independently 0<c<1, Li_{d}Na_{d}MₑM′_{f}(PO₄)₃ wherein d, in each instance is independently 0≦d≦2, 0≦e≦2, 0≦f≦2, and M and M′ are metals selected from the group consisting of V, Nb, Ta, Cr, Fe, Al, Co, Ni, or Cu, Li_{g}MM′(SO₄)₃ where M and M′ are transition metals and g is selected so that the compound is charge neutral, or LiMXO₄ where X is Ge, Si, Sb, As, or P, LiₕNaV₂(PO₄)₃, LiₕNa₂FeV(PO₄)₃, LiₕFeTi(PO₄)₃, LiₙTiNb(PO₄)₃, LiₕFeNb(PO₄)₃, wherein 0≦h≦1, antiperosyskite, or combinations thereof.

In some examples, the MEIC is selected from LiTaAl(PO₄)₃, LiTi₂(PO₄)₃, or Li₁₊ₓTi₂₋ₓAlₓ(PO₄)₃, wherein x is from 0 to 2.

In some examples, the MEIC is selected from LiNbFe(PO₄)₃; LiTaAl(PO₄)₃; LiTaCr(PO₄)₃; LiTaFe(PO₄)₃; Li_{1.2}Ta_{0.9}Al_{1.1}(PO₄)₃; or LiZr₂(PO₄)₃. In some examples, the MEIC is selected from VO₂, MoO₂, MoO₃, MoS₂, V₂O₅, V₆O₃, NiO, CuO, carbon fluorides, nitrides, selenide, tellurides, silicates, molybdenum sulfides, molybdenum oxysulfides, titanium sulfide, chromium oxide, manganese oxide (MnO₂), and MoOₓF_{z}, wherein x is 0≦x≦3 and z is 0≦z≦5 wherein x and z are such that the effective cationic charge on the Mo is not more than 6⁺. In some examples, the MEIC is a lithium and phosphate containing compound selected from lithium iron phosphate, lithium iron fluorophosphate, Li₃PO₄, or LiH₂PO₄. In some examples, the MEIC is LiₐH₃₋ₐPO₄, wherein 0<a≦3.

In some embodiments, when a phosphate is present in the composite, the phosphate is present in an amount less than 1% w/w. In certain embodiments, when a phosphate is present, the phosphate is a coating on the MF. In certain of these embodiments, the phosphate coating is in an amount that is less than 1% w/w.

In some embodiments, the MEIC is a vanadium oxide (e.g., VOₓ) and the catholyte is LATS. Combinations such as, but not limited to, this combination, are observed to be air stable, highly conductive, and also stable over a large voltage v. Li range. In some of these embodiments, the composites includes 10-20% v/v VOₓ and 65-85% v/v FeF₃ and the composites are characterized by 10% v/v or less porosity when prepared according to the methods set forth herein which include heating and applying pressure to the composite. In certain embodiments, the FeF₃ is coated in an aluminum phosphate coating (e.g., AlPO₄). In some of these embodiments, the VOₓ is present at 10, 11, 12, 13, 14, 15, 16, 17, or 18% v/v, and the FeF₃ is present at 80, or 79, or 78, or 77, or 76, or 75, or 74, or 73, or 72% v/v, respectively. In some of these embodiments, the catholyte surrounding the composite is LATS. In some embodiments, PEO is the electrolyte separator between the positive and negative electrodes. Examples such as this are observed to have a capacity in excess of 420 mAh/g at C/20 rate and 80° C. In some of these examples, the catholyte is present in an amount of 10% w/w, carbon is present in an about of about 6% w/w. In some embodiments, the mass ratio of composite particles to catholyte is 8:1, 7:1, 6:1, 5:1, 4:1, 3:1, 2:1, or 1:1.

In some embodiments, the MEIC is polyethylene oxide (PEO). In some of these embodiments, PEO is an electrolyte separating the positive and negative electrodes.

In some embodiments, set forth herein, the composite does not include a phosphate MEIC. In some other embodiments, set forth herein, the composite does not include any phosphates.

The MF included in the composite particles is selected from a material including a metal component and a fluorine (F) component and optionally includes a lithium (Li) component such that the MF is present in the “charged state” and converts to a metal and lithium fluoride during discharge of the battery. Suitable MFs include LiF, Li_{z}FeF₃, Li_{z}CuF₂, Li_{z}NiF₂, Li_{z}CoF₂, Li_{z}CoF₃, Li_{z}MnF₂, or Li_{z}MnF₃, where 0≦z≦3. In some embodiments, the MF is LiF. In other embodiments, the MF is Li_{z}FeF₃where 0≦z≦3. In some other embodiments, the MF is Li_{z}CuF₂where 0≦z≦3. In some other embodiments, the MF is Li_{z}NiF₂ where 0≦z≦3. In some other embodiments, the MF is Li_{z}CoF₂where 0≦z≦3. In some other embodiments, the MF is Li_{z}CoF₃ where 0≦z≦3. In some other embodiments, the MF is Li_{z}MnF₂ where 0≦z≦3. In some other embodiments, the MF is Li_{z}MnF₃ where 0≦z≦3. In other embodiments, the MF is Li_{z}FeF_{z}where 0≦z≦3. In some other embodiments, the MF is Li_{z}CuF_{z} where 0≦z≦3. In some other embodiments, the MF is Li_{z}NiF_{z} where 0≦z≦3. In some other embodiments, the MF is Li_{z}CoF₂where 0≦z≦3. In some other embodiments, the MF is Li_{z}CoF_{z} where 0≦z≦3. In some other embodiments, the MF is Li_{z}MnF_{z} where 0≦z≦3. In some other embodiments, the MF is Li_{z}MnF_{z} where 0≦z≦3.

In some embodiments, the MF is nanodimensioned and, in some other embodiments, the MF is in the form of nanodomains.

In some embodiments, the MF is doped with a dopant including Li, Mg, Al, Si, Ca, Ti, V, Cr, Mn, Mo, Fe, Co, Ni, Cu, Zn, Y, Zr, Nb, Ba, or Hf, a metal oxide of said metal, a cation of said metal, a metal fluoride of said metal, or combinations thereof. In some embodiments, the dopant is Li. In other embodiments, the dopant is Mg. In some other embodiments, the dopant is Al. In some other embodiments, the dopant is Si. In some other embodiments, the dopant is Ca. In some other embodiments, the dopant is Ti. In some other embodiments, the dopant is V. In some other embodiments, the dopant is Cr. In some other embodiments, the dopant is Mn. In some other embodiments, the dopant is Fe. In some other embodiments, the dopant is Co. In some other embodiments, the dopant is Ni. In some other embodiments, the dopant is Cu. In some other embodiments, the dopant is Zn. In some other embodiments, the dopant is Y. In some other embodiments, the dopant is Zr. In some other embodiments, the dopant is Nb. In some other embodiments, the dopant is Ba. In some other embodiments, the dopant is Hf. In some other embodiments, the dopant is a metal oxide of Li (e.g., Li₂O). In some other embodiments, the dopant is Hf. In some other embodiments, the dopant is a metal oxide of Mg.

In some other embodiments, the dopant is a metal oxide of Al. In some other embodiments, the dopant is a metal oxide of Si. In some other embodiments, the dopant is a metal oxide of Ca. In some other embodiments, the dopant is a metal oxide of Ti. In some other embodiments, the dopant is a metal oxide of V. In some other embodiments, the dopant is a metal oxide of Cr. In some other embodiments, the dopant is a metal oxide of Mn. In some other embodiments, the dopant is a metal oxide of Fe. In some other embodiments, the dopant is a metal oxide of Co. In some other embodiments, the dopant is a metal oxide of Ni. In some other embodiments, the dopant is a metal oxide of Cu. In some other embodiments, the dopant is a metal oxide of Zn. In some other embodiments, the dopant is a metal oxide of Y. In some other embodiments, the dopant is a metal oxide of Zr. In some other embodiments, the dopant is a metal oxide of Nb. In some other embodiments, the dopant is a metal oxide of Ba. In some other embodiments, the dopant is a metal oxide of Hf. In some other embodiments, the dopant is a cation of Li. In some other embodiments, the dopant is a cation of Mg. In some other embodiments, the dopant is a cation of Al. In some other embodiments, the dopant is a cation of Si. In some other embodiments, the dopant is a cation of Ca. In some other embodiments, the dopant is a cation of Ti. In some other embodiments, the dopant is a cation of V. In some other embodiments, the dopant is a cation of Cr. In some other embodiments, the dopant is a cation of Mn. In some other embodiments, the dopant is a cation of Mo. In some other embodiments, the dopant is a cation of Fe. In some other embodiments, the dopant is a cation of Co. In some other embodiments, the dopant is a cation of Ni. In some other embodiments, the dopant is a cation of Cu. In some other embodiments, the dopant is a cation of Zn. In some other embodiments, the dopant is a cation of Y. In some other embodiments, the dopant is a cation of Zr. In some other embodiments, the dopant is a cation of Nb. In some other embodiments, the dopant is a cation of Ba. In some other embodiments, the dopant is a cation of Hf. In some other embodiments, the dopant is a fluoride of Li. In some other embodiments, the dopant is a fluoride of Mg. In some other embodiments, the dopant is a fluoride of Al. In some other embodiments, the dopant is a fluoride of Si. In some other embodiments, the dopant is a fluoride of Ca. In some other embodiments, the dopant is a fluoride of Ti. In some other embodiments, the dopant is a fluoride of V. In some other embodiments, the dopant is a fluoride of Cr. In some other embodiments, the dopant is a fluoride of Mn. In some other embodiments, the dopant is a fluoride of Fe. In some other embodiments, the dopant is a fluoride of Co. In some other embodiments, the dopant is a fluoride of Ni. In some other embodiments, the dopant is a fluoride of Cu. In some other embodiments, the dopant is a fluoride of Zn. In some other embodiments, the dopant is a fluoride of Y. In some other embodiments, the dopant is a fluoride of Zr. In some other embodiments, the dopant is a fluoride of Nb. In some other embodiments, the dopant is a fluoride of Ba. In some other embodiments, the dopant is a fluoride of Hf

In some embodiments, the MF is doped with a dopant including Li₂O, Cu, CuF₂, MoO₂, MoO₃, NiF₂, ZrF₄, CaF₂, or AlF₃. In some embodiments, the dopast is Li₂O. In other embodiments, the dopant is CuF₂. In some other embodiments, the dopant is NiF₂. In some other embodiments, the dopant is ZrF₄. In some other embodiments, the dopant is CaF₂. In some other embodiments, the dopant is AlF₃.

As used herein, the dopant may be present in an amount from about 0.1 to 15 atomic %, or the dopant may be present in an amount from about 0.1 to 10 atomic %, or the dopant may be present in an amount from about 5 to 15 atomic %, or the dopant may be present in an amount from about 5 to 10 atomic %.

In some embodiments, the MF is LiF and can further comprise a nanodimensioned metal including Fe, Co, Mn, Cu, Ni, Zr, or combinations thereof. In some embodiments, the nanodimensioned metal is Fe. In other embodiments, the nanodimensioned metal is Co. In some other embodiments, the nanodimensioned metal is Mn. In some other embodiments, the nanodimensioned metal is Cu. In some other embodiments, the nanodimensioned metal is Ni. In some other embodiments, the nanodimensioned metal is Zr. In some embodiments, the metal has median characteristic physical dimension of about 1-5 nm, or about 1-10 nm, or about 1-20 nm. In some embodiments, the metal has median characteristic physical dimension of about 1-5 nm, or about 1-10 nm, or about 1-20 nm and is uniformly mixed with LiF within a volume of 1000 nm³.

The optional electrically conductive additive comprising carbon includes any suitable carbon-containing material that improves the electrical conductivity of the electrode. Suitable electrically conductive additives can include activated carbon, carbon black, carbon fibers, carbon nanotubes, C65 carbon, carbon nanofibers, graphite, graphene, fullerenes, ketjen black, vapor grown carbon fiber (VGCF), or acetylene black. In some embodiments, the electrically conductive additive is activated carbon. In other embodiments, the electrically conductive additive is carbon black. In some other embodiments, the electrically conductive additive is carbon fibers. In some other embodiments, the electrically conductive additive is carbon nanotubes. In some other embodiments, the electrically conductive additive is carbon nanofibers. In some other embodiments, the electrically conductive additive is graphite. In some other embodiments, the electrically conductive additive is graphene. In some other embodiments, the electrically conductive additive is fullerenes. In some other embodiments, the electrically conductive additive is ketjen black. In some other embodiments, the electrically conductive additive is vapor grown carbon fiber (VGCF). In some other embodiments, the electrically conductive additive is acetylene black.

The catholyte includes any suitable ion conductor that is intimately mixed with, or that surrounds, composite particles including an MEIC and a MF. Suitable catholytes can include LSS, LXPS, LXPSO, Li-stuffed garnet, where X is Si, Ge, Sn, As, Al, or combinations thereof. In some embodiments, the catholyte is LSS. In other embodiments, the catholyte is LXPS where X is Si, Ge, Sn, As, Al, or combinations thereof. In some other embodiments, the catholyte is LXPS where X is Si. In some other embodiments, the catholyte is LXPS where X is Ge. In some other embodiments, the catholyte is LXPS where X is Si and Sn. In some other embodiments, the catholyte is LXPS where X is Sn. In some other embodiments, the catholyte is LXPS where X is Al. In some embodiments, the catholyte is LXPSO where X is Si, Ge, Sn, Al, or combinations thereof. In other embodiments, the catholyte is LXPSO where X is Si. In some other embodiments, the catholyte is LXPSO where X is Ge. In some other embodiments, the catholyte is LXPSO where X is Si and Sn. In some other embodiments, the catholyte is LXPSO where X is Sn. In some embodiments, the catholyte is LATS. In some other embodiments, the catholyte is LXPSO where X is Al. In some other embodiments, the catholyte is LXPSO where X is a combination of Si and Sn. In some embodiments, the catholyte is Li-stuffed garnet.

In some embodiments, the catholyte includes LXPS and is substantially free of oxygen, where X is Si, Ge, Sn, As, Al, or combinations thereof. In some embodiments, the catholyte is LXPS and is substantially free of oxygen, where X is Si. In other embodiments, the catholyte is LXPS and is substantially free of oxygen, where X is Ge. In some other embodiments, the catholyte is LXPS and is substantially free of oxygen, where X is Sn. In some other embodiments, the catholyte is LXPS and is substantially free of oxygen, where X is Al.

In some embodiments, the positive electrode film does not include a catholyte.

In other embodiments, the catholyte is a Li-stuffed garnet or Li₂B₄O₇. In some other embodiments, the catholyte is Li₂B₄O₇. In some other embodiments, the catholyte is a Li-stuffed garnet.

The binder includes any suitable material that assists in the adhesion of the composite particle components and/or adhesion of the composite particles to the other components of the positive electrode film. Suitable binders can include polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), stereoblock polypropylenes, polypropylene polymethylpentene copolymer, polyethylene oxide (PEO), PEO block co-polymers, or silicone. In some embodiments, the binder is polypropylene (PP). In other embodiments, the binder is atactic polypropylene (aPP). In other embodiments, the binder is PEO. In some other embodiments, the binder is isotactive polypropylene (iPP). In some other embodiments, the binder is ethylene propylene rubber (EPR). In some other embodiments, the binder is ethylene pentene copolymer (EPC). In some other embodiments, the binder is polyisobutylene (PIB). In some other embodiments, the binder is styrene butadiene rubber (SBR). In some other embodiments, the binder is polyolefins. In some other embodiments, the binder is polyethylene-co-poly-1-octene (PE-co-PO). In some other embodiments, the binder is PE-co-poly(methylene cyclopentane) (PE-co-PMCP). In some other embodiments, the binder is stereoblock polypropylenes. In some other embodiments, the binder is polypropylene polymethylpentene copolymer. In some other embodiments, the binder is silicone.

As used herein, a “binder” includes a material that assists in the adhesion of another material. For example, as used herein, polyvinyl butyral is a binder because it is useful for adhering garnet materials. Other binders include polycarbonates. Other binders may include polymethylmethacrylates. These examples of binders are not limiting as to the entire scope of binders contemplated here but merely serve as examples. Examples of binders include, but are not limited to, polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), poly methyl-methacrylate (and other acrylics), acrylic, polyvinylacetacetal resin, polyvinylbutylal resin, PVB, polyvinyl acetal resin, stereoblock polypropylenes, polypropylene polymethylpentene copolymer, polyethylene oxide (PEO), PEO block copolymers, silicone, and the like.

In some embodiments, the MEIC has a charge and/or discharge voltage window that overlaps the same of the MF. In some embodiments, the MEIC has a discharge voltage plateau plateau of between about 3 to 3.5 V v. Li. In other embodiments, the MEIC has a discharge voltage plateau of between about 2.9 to 3.4 V v. Li. In some other embodiments, the MEIC has a discharge voltage plateau of between about 2.8 to 3.3 V v. Li. In some other embodiments, the MEIC has a discharge voltage plateau of between about 2.7 to 3.2 V v. Li. In some other embodiments, the MEIC has a discharge voltage plateau of between about 2.6 to 3.1 V v. Li. In some other embodiments, the MEIC has a discharge voltage plateau of between about 2.5 to 3 V v. Li. In some other embodiments, the MEIC has a discharge voltage plateau of between about 2.4 to 2.9 V v. Li. In some other embodiments, the MEIC has a discharge voltage plateau of between about 2.3 to 2.8 V v. Li. In some other embodiments, the MEIC has a discharge voltage plateau of between about 2.2 to 2.7 V v. Li. In some other embodiments, the MEIC has a discharge voltage plateau of between about 2.1 to 2.6 V v. Li. In some other embodiments, the MEIC has a discharge voltage plateau of between about 2 to 2.5 V v. Li. In some other embodiments, the MEIC has a discharge voltage plateau of between about 3.1 to 3.6 V v. Li. In some other embodiments, the MEIC has a discharge voltage plateau of between about 3.2 to 3.7 V v. Li. In some other embodiments, the MEIC has a discharge voltage plateau of between about 3.3 to 3.8 V v. Li. In some other embodiments, the MEIC has a discharge voltage plateau of between about 3.4 to 3.9 V v. Li. In some other embodiments, the MEIC has a discharge voltage plateau of between about 3.5 to 4 V v. Li. In some other embodiments, the MEIC has a discharge voltage plateau of between about 3.6 to 4.1 V v. Li. In some other embodiments, the MEIC has a discharge voltage plateau of between about 3.7 to 4.2 V v. Li. In some other embodiments, the MEIC has a discharge voltage plateau of between about 3.8 to 4.3 V v. Li. In some other embodiments, the MEIC has a discharge voltage plateau of between about 3.9 to 4.4 V v. Li. In some other embodiments, the MEIC has a discharge voltage plateau of between about 4.0 to 4.5 V v. Li.

The positive electrode film, which includes a nanocomposite of MF and MEIC as described herein, can be characterized by any suitable thickness. In some embodiments, the film is characterized by a thickness of about 1 to 100 μm. In other embodiments, the film is characterized by a thickness of about 5 to 95 μm. In some other embodiments, the film is characterized by a thickness of about 10 to 90 μm. In some other embodiments, the film is characterized by a thickness of about 15 to 85 μm. In some other embodiments, the film is characterized by a thickness of about 20 to 80 μm. In some other embodiments, the film is characterized by a thickness of about 25 to 75 μm. In some other embodiments, the film is characterized by a thickness of about 30 to 70 μm. In some other embodiments, the film is characterized by a thickness of about 35 to 65 μm. In some other embodiments, the film is characterized by a thickness of about 40 to 60 μm. In some other embodiments, the film is characterized by a thickness of about 45 to 55 μm.

In some embodiments, the nanocomposite having a metal fluoride and MEIC therein has a median characteristic dimension that is 0.1 to 1 times the thickness of the film in which the nanocomposite is located. For example, in some examples, the film is characterized by a thickness of about 1 to 150 μm and the nanocomposite has a median characteristic dimension of about 0.1 to 150 μm. In some examples, the film is characterized by a thickness of about 1 to 150 μm and the nanocomposite has a median characteristic dimension of about 5 μm. In other embodiments, the film is characterized by a thickness of about 5 to 95 μm and the nanocomposite has a median characteristic dimension of about 0.5 to 80 μm. In some other embodiments, the film is characterized by a thickness of about 10 to 90 μm and the nanocomposite has a median characteristic dimension of about 1 to 90 μm. In some other embodiments, the film is characterized by a thickness of about 15 to 85 μm and the nanocomposite has a median characteristic dimension of about 0.15 to 85 μm. In some other embodiments, the film is characterized by a thickness of about 20 to 80 μm and the nanocomposite has a median characteristic dimension of about 0.2 to 80 μm. In some other embodiments, the film is characterized by a thickness of about 25 to 75 μm and the nanocomposite has a median characteristic dimension of about 0.25 to 75 μm. In some other embodiments, the film is characterized by a thickness of about 30 to 70 μm and the nanocomposite has a median characteristic dimension of about 0.3 to 70 μm. In some other embodiments, the film is characterized by a thickness of about 35 to 65 μm and the nanocomposite has a median characteristic dimension of about 0.35 to 65 μm. In some other embodiments, the film is characterized by a thickness of about 40 to 60 μm and the nanocomposite has a median characteristic dimension of about 0.4 to 60 μm. In some other embodiments, the film is characterized by a thickness of about 45 to 55 μm and the nanocomposite has a median characteristic dimension of about 0.45 to 55 μm.

In some embodiments, the film can be characterized by a thickness of about 10 to 100 μm. In other embodiments, the film is characterized by a thickness of about 20 to 90 μm. In some other embodiments, he film is characterized by a thickness of about 30 to 80 μm. In some other embodiments, the film is characterized by a thickness of about 40 to 70 μm. In some other embodiments, the film is characterized by a thickness of about 50 to 60 μm.

In some embodiments, the film can be characterized by a thickness of about 10 to 40 μm. In other embodiments, the film is characterized by a thickness of about 12 to 38 μm. In some other embodiments, he film is characterized by a thickness of about 14 to 36 μm. In some other embodiments, the film is characterized by a thickness of about 16 to 34 μm. In some other embodiments, the film is characterized by a thickness of about 18 to 32 μm. In some other embodiments, the film is characterized by a thickness of about 20 to 30 μm. In some other embodiments, the film is characterized by a thickness of about 22 to 28 μm. In some other embodiments, the film is characterized by a thickness of about 24 to 26 μm.

In some embodiments, the film can be characterized by a thickness of about 10 to 40 μm and the nanocomposite has a median characteristic dimension of about 0.1 to 40 μm. In other embodiments, the film is characterized by a thickness of about 12 to 38 μm and the nanocomposite has a median characteristic dimension of about 0.12 to 38 μm. In some other embodiments, he film is characterized by a thickness of about 14 to 36 μm and the nanocomposite has a median characteristic dimension of about 0.14 to 36 μm. In some other embodiments, the film is characterized by a thickness of about 16 to 34 μm and the nanocomposite has a median characteristic dimension of about 0.16 to 34 μm. In some other embodiments, the film is characterized by a thickness of about 18 to 32 μm and the nanocomposite has a median characteristic dimension of about 0.18 to 32 μm. In some other embodiments, the film is characterized by a thickness of about 20 to 30 μm and the nanocomposite has a median characteristic dimension of about 0.20 to 30 μm. In some other embodiments, the film is characterized by a thickness of about 22 to 28 μm and the nanocomposite has a median characteristic dimension of about 0.22 to 28 μm. In some other embodiments, the film is characterized by a thickness of about 24 to 26 μm and the nanocomposite has a median characteristic dimension of about 0.24 to 26 μm

In some embodiments, the positive electrode film is characterized by a thickness less than about 1 μm. For example, in some embodiments, the film is characterized by a thickness of about 15 to 800 nm. In other embodiments, the film is characterized by a thickness of about 15 to 700 nm. In some other embodiments, the film is characterized by a thickness of about 15 to 600 nm. In some other embodiments, the film is characterized by a thickness of about 15 to 500 nm. In some other embodiments, the film is characterized by a thickness of about 15 to 400 nm. In some other embodiments, the film is characterized by a thickness of about 15 to 300 nm. In some other embodiments, the film is characterized by a thickness of about 15 to 200 nm. In some other embodiments, the film is characterized by a thickness of about 15 to 100 nm. In some other embodiments, the film is characterized by a thickness of about 20 to 95 nm. In some other embodiments, the film is characterized by a thickness of about 25 to 90 nm. In some other embodiments, the film is characterized by a thickness of about 30 to 85 nm. In some other embodiments, the film is characterized by a thickness of about 35 to 80 nm. In some other embodiments, the film is characterized by a thickness of about 40 to 75 nm. In some other embodiments, the film is characterized by a thickness of about 45 to 70 nm. In some other embodiments, the film is characterized by a thickness of about 50 to 65 nm. In some other embodiments, the film is characterized by a thickness of about 55 to 60 nm.

The composite particles in the positive electrode film a variety of suitable sizes. In some embodiments, the composite particles are characterized by a median diameter (d₅₀) of about 0.1 to 7 μm. In other embodiments, the composite particles are characterized by a median diameter (d₅₀) of about 0.1 to 6.5 μm. In some other embodiments, the composite particles are characterized by a median diameter (d₅₀) of about 0.1 to 6.0 μm. In other embodiments, the composite particles are characterized by a median diameter (d₅₀) of about 0.1 to 5.5 μm. In other embodiments, the composite particles are characterized by a median diameter (d₅₀) of about 0.1 to 5.0 μm. In other embodiments, the composite particles are characterized by a median diameter (d₅₀) of about 0.1 to 4.5 μm. In some other embodiments, the composite particles are characterized by a median diameter (d₅₀) of about 0.1 to 4 μm. In some other embodiments, the composite particles are characterized by a median diameter (d₅₀) of about 0.1 to 3.5 μm. In some other embodiments, the composite particles are characterized by a median diameter (d₅₀) of about 0.1 to 3 μm. In some other embodiments, the composite particles are characterized by a median diameter (d₅₀) of about 0.1 to 2.5 μm. In some other embodiments, the composite particles are characterized by a median diameter (d₅₀) of about 0.1 to 2 μm. In some other embodiments, the composite particles are characterized by a median diameter (d₅₀) of about 0.1 to 1.5 μm.

In some embodiments, the composites are dry milled until they have a median diameter (d₅₀) of about 0.1 to 25 μm. In some embodiments, the composites are dry milled until they have a median diameter (d₅₀) of about 1 to 20 μm. In some embodiments, the composites are dry milled until they have a median diameter (d₅₀) of about 5 to 20 μm. In some embodiments, the composites are dry milled until they have a particle size (d₉₀) of about 1 to 400 μm. In some embodiments, the composites are dry milled until they have a particle size (d₉₀) of about 10 to 300 μm. In some embodiments, the composites are dry milled until they have a median diameter (d₅₀) of about 20 to 200 μm. In some embodiments, the composites are dry milled until they have a median diameter (d₅₀) of about 1 to 10 μm. In some embodiments, the composites are dry milled until they have a median diameter (d₅₀) of about 1 to 5 μm. In some embodiments, the composites are dry milled until they have a median diameter (d₅₀) of about 0.5 to 5 μm.

In some embodiments, the metal fluorides that are formulated into composite particles are wet (i.e., solvent) milled until they have a median diameter (d₅₀) of about 0.1 to 15 μm. In some embodiments, the metal fluorides are wet milled until they have a median diameter (d₅₀) of about 1 to 500 nm. In some embodiments, the metal fluorides are solvent milled until they have a median diameter (d₅₀) of about 10 nm to 400 nm. In some embodiments, the metal fluorides are wet milled until they have a particle size (d₉₀) of about 1 to 500 nm. In some embodiments, the metal fluorides are wet milled until they have a particle size (d₉₀) of about 100 nm to 20 μm. In some embodiments, the metal fluorides are wet milled until they have a median diameter (d₅₀) of about 100 to 300 nm. In some embodiments, the metal fluorides are wet milled until they have a median grain size (d₅₀) of about 1-5 nm, 1-10 nm, or 5-10 nm. In some embodiments, the metal fluorides are prepared by an atomization process that produces particles having a median grain size (d₅₀) of about 1-5 nm, 1-10 nm, or 5-10 nm.

In some embodiments, the composites have an oxide coating as a result of the milling process.

In some embodiments, the size ratio of the catholyte (e.g., LATS) to the composite (e.g., including FeF₃) is 0.76 for D₁₀/D₉₀, or 2.5 for D₅₀/D₉₀, or 5.5 for D₉₀/D₉₀, or 17.5 for D₅₀/D₅₀. In some embodiments, the size ratio of the composite (e.g., including FeF₃) to the catholyte (e.g., LATS) is 0.76 for D₁₀/D₉₀, or 2.5 for D₅₀/D₉₀, or 5.5 for D₉₀/D₉₀, or 17.5 for D₅₀/D₅₀. In some embodiments, the size ratio of the catholyte (e.g., LATS) to the composite (e.g., including FeF₃) is 0.55 for D₁₀/D₉₀, or 2.0 for D₅₀/D₉₀, or 5.0 for D₉₀/D₉₀, or 16 for D₅₀/D₅₀. In some embodiments, the size ratio of the composite (e.g., including FeF₃) to the catholyte (e.g., LATS) is 0.55 for D₁₀/D₉₀, or 2.0 for D₅₀/D₉₀, or 5.0 for D₉₀/D₉₀, or 16 for D₅₀/D₅₀. In some embodiments, the size ratio of the catholyte (e.g., LATS) to the composite (e.g., including FeF₃) is 0.8 for D₁₀/D₉₀, or 3 for D₅₀/D₉₀, or 6 for D₉₀/D₉₀, or 18 for D₅₀/D₅₀. In some embodiments, the size ratio of the composite (e.g., including FeF₃) to the catholyte (e.g., LATS) is 0.8 for D₁₀/D₉₀, or 3 for D₅₀/D₉₀, or 6 for D₉₀/D₉₀, or 18 for D₅₀/D₅₀.

In some embodiments, the composite particles are characterized by a median diameter (d₅₀) of about 1 to 5 μm. This median diameter represents the distance between maximally spaced composite particle boundaries, wherein the composites are approximately spherically shaped. In other embodiments, the composite particles are characterized by a median diameter (d₅₀) of about 1.5 to 4.5 μm. In some other embodiments, the composite particles are characterized by a median diameter (d₅₀) of about 2 to 4 μm. In some other embodiments, the composite particles are characterized by a median diameter (d₅₀) of about 2.5 to 3.5 μm. In some other embodiments, the composite particles are characterized by a median diameter (d₅₀) of about 1 μm. In some other embodiments, the composite particles are characterized by a median diameter (d₅₀) of about 2 μm. In some other embodiments, the composite particles are characterized by a median diameter (d₅₀) of about 3 μm. In some other embodiments, the composite particles are characterized by a median diameter (d₅₀) of about 4 μm. In some other embodiments, the composite particles are characterized by a median diameter (d₅₀) of about 5 μm.

In some embodiments, the composite particles are characterized by a median diameter (d₅₀) of about 0.1 to 1 μm. In other embodiments, the composite particles are characterized by a median diameter (d₅₀) of about 0.2 to 0.9 μm. In some other embodiments, the composite particles are characterized by a median diameter (d₅₀) of about 0.3 to 0.8 μm. In some other embodiments, the composite particles are characterized by a median diameter (d₅₀) of about 0.4 to 0.7 μm. In some other embodiments, the composite particles are characterized by a median diameter (d₅₀) of about 0.5 to 0.6 μm. In some other embodiments, the composite particles are characterized by a median diameter (d₅₀) of about 0.1 μm. In some other embodiments, the composite particles are characterized by a median diameter (d₅₀) of about 0.2 μm. In some other embodiments, the composite particles are characterized by a median diameter (d₅₀) of about 0.3 μm. In some other embodiments, the composite particles are characterized by a median diameter (d₅₀) of about 0.4 μm. In some other embodiments, the composite particles are characterized by a median diameter (d₅₀) of about 0.5 μm. In some other embodiments, the composite particles are characterized by a median diameter (d₅₀) of about 0.6 μm. In some other embodiments, the composite particles are characterized by a median diameter (d₅₀) of about 0.7 μm. In some other embodiments, the composite particles are characterized by a median diameter (d₅₀) of about 0.8 μm. In some other embodiments, the composite particles are characterized by a median diameter (d₅₀) of about 0.9 μm.

The MF can comprise atomized particles having a variety of sizes. In some embodiments, the MF comprises atomized particles characterized by a median diameter (d₅₀) of about 1 nm to 6 μm. In other embodiments, the MF comprises atomized particles characterized by a median diameter (d₅₀) of about 1 nm to 100 nm. In some other embodiments, the MF comprises atomized particles characterized by a median diameter (d₅₀) of about 1 nm to 10 nm. In other embodiments, the MF comprises atomized particles characterized by a median diameter (d₅₀) of about 1 nm to 9 nm. In some other embodiments, the MF comprises atomized particles characterized by a median diameter (d₅₀) of about 2 nm to 20 nm. In some other embodiments, the MF comprises atomized particles characterized by a median diameter (d₅₀) of about 1 nm to 8 nm. In some other embodiments, the MF comprises atomized particles characterized by a median diameter (d₅₀) of about 10 nm to 30 nm. In some other embodiments, the MF comprises atomized particles characterized by a median diameter (d₅₀) of about 1 nm to 30 nm. In some other embodiments, the MF comprises atomized particles characterized by a median diameter (d₅₀) of about 1 nm to 5 nm. In some other embodiments, the MF comprises atomized particles characterized by a median diameter (d₅₀) of about 1 nm to 40 nm. In some other embodiments, the MF comprises atomized particles characterized by a median diameter (d₅₀) of about 1 nm to 3 nm. In some other embodiments, the MF comprises atomized particles characterized by a median diameter (d₅₀) of about 5 nm to 20 nm. In some other embodiments, the MF comprises atomized particles characterized by a median diameter (d₅₀) of about 5 nm to 100 nm. In some other embodiments, the MF comprises atomized particles characterized by a median diameter (d₅₀) of about 5 nm to 200 nm. In some other embodiments, the MF comprises atomized particles characterized by a median diameter (d₅₀) of about 1 nm to 300 nm. In some other embodiments, the MF comprises atomized particles characterized by a median diameter (d₅₀) of about 1 nm to 400 nm. In some other embodiments, the MF comprises atomized particles characterized by a median diameter (d₅₀) of about 1 nm to 500 nm. In some other embodiments, the MF comprises atomized particles characterized by a median diameter (d₅₀) of about 10 nm to 500 nm. In some other embodiments, the MF comprises atomized particles characterized by a median diameter (d₅₀) of about 20 nm to 100 nm.

The composite particles can have any suitable weight ratio of MEIC to MF. In some embodiments, the weight ratio of MEIC to MF in the composite particles is about 8:92 to 17:83. In some embodiments, the weight ratio of MEIC to MF in the composite particles is about 1:99 to 25:75. In other embodiments, the weight ratio of MEIC to MF in the composite particles is about 8.5:91.5 to 16.5:83.5. In some other embodiments, the weight ratio of MEIC to MF in the composite particles is about 9:91 to 16:84. In some other embodiments, the weight ratio of MEIC to MF in the composite particles is about 9.5:90.5 to 15.5:84.5. In some other embodiments, the weight ratio of MEIC to MF in the composite particles is about 10:90 to 15:85. In some other embodiments, the weight ratio of MEIC to MF in the composite particles is about 10.5:89.5 to 14.5:85.5. In some other embodiments, the weight ratio of MEIC to MF in the composite particles is about 11:89 to 14:86. In some other embodiments, the weight ratio of MEIC to MF in the composite particles is about 11.5:88.5 to 13.5:86.5. In some other embodiments, the weight ratio of MEIC to MF in the composite particles is about 12:88 to 13:87.

In some embodiments, the weight percent of the MEIC and MF, the catholyte, the binder, and the electrically conductive additive in the film is about 55-57, 14-16, 1-6, and 1-6% w/w, respectively. In other embodiments, the weight percent of the MEIC and MF, the catholyte, the binder, and the electrically conductive additive in the film is about 55.2-56.8, 14.2-15.8, 1.5-5.5, and 1.5-5.5% w/w, respectively. In some other embodiments, the weight percent of the MEIC and MF, the catholyte, the binder, and the electrically conductive additive in the film is about 55.4-56.6, 14.4-15.6, 2-5, and 2-5% w/w, respectively. In other embodiments, the weight percent of the MEIC and MF, the catholyte, the binder, and the electrically conductive additive in the film is about 55-80, 0-20, 0.5-5.5, and 0.5-5.5% w/w, respectively. In some other embodiments, the weight percent of the MEIC and MF, the catholyte, the binder, and the electrically conductive additive in the film is about 60-85, 0-15, 0.5-5, and 0.5-5% w/w, respectively. In some other embodiments, the weight percent of the MEIC and MF, the catholyte, the binder, and the electrically conductive additive in the film is about 55.6-56.4, 14.6-15.4, 2.5-4.5, and 2.5-4.5% w/w, respectively. In some other embodiments, the weight percent of the MEIC and MF, the catholyte, the binder, and the electrically conductive additive in the film is about 55.8-56.2, 14.8-15.2, 3-4, and 3-4% w/w, respectively.

In some embodiments, the weight percent of the MEIC and MF, the catholyte, the binder, and the electrically conductive additive in the film is about 55, 16, 6, and 6% w/w, respectively. In other embodiments, the weight percent of the MEIC and MF, the catholyte, the binder, and the electrically conductive additive in the film is about 55, 16, 5, and 5% w/w, respectively. In some other embodiments, the weight percent of the MEIC and MF, the catholyte, the binder, and the electrically conductive additive in the film is about 55, 16, 4, and 4% w/w, respectively. In some other embodiments, the weight percent of the MEIC and MF, the catholyte, the binder, and the electrically conductive additive in the film is about 55, 16, 3, and 3% w/w, respectively. In some other embodiments, the weight percent of the MEIC and MF, the catholyte, the binder, and the electrically conductive additive in the film is about 55, 16, 2, and 2% w/w, respectively. In some other embodiments, the weight percent of the MEIC and MF, the catholyte, the binder, and the electrically conductive additive in the film is about 55, 16, 1, and 1% w/w, respectively.

In some embodiments, the weight percent of the MEIC and MF, the catholyte, the binder, and the electrically conductive additive in the film is about 56, 15, 6, and 6% w/w, respectively. In other embodiments, the weight percent of the MEIC and MF, the catholyte, the binder, and the electrically conductive additive in the film is about 56, 15, 5, and 5% w/w, respectively. In some other embodiments, the weight percent of the MEIC and MF, the catholyte, the binder, and the electrically conductive additive in the film is about 56, 15, 4, and 4% w/w, respectively. In some other embodiments, the weight percent of the MEIC and MF, the catholyte, the binder, and the electrically conductive additive in the film is about 56, 15, 3, and 3% w/w, respectively. In some other embodiments, the weight percent of the MEIC and MF, the catholyte, the binder, and the electrically conductive additive in the film is about 56, 15, 2, and 2% w/w, respectively. In some other embodiments, the weight percent of the MEIC and MF, the catholyte, the binder, and the electrically conductive additive in the film is about 56, 15, 1, and 1% w/w, respectively.

In some embodiments, the weight percent of the MEIC and MF, the catholyte, the binder, and the electrically conductive additive in the film is about 57, 14, 6, and 6% w/w, respectively. In other embodiments, the weight percent of the MEIC and MF, the catholyte, the binder, and the electrically conductive additive in the film is about 57, 14, 5, and 5% w/w, respectively. In some other embodiments, the weight percent of the MEIC and MF, the catholyte, the binder, and the electrically conductive additive in the film is about 57, 14, 4, and 4% w/w, respectively. In some other embodiments, the weight percent of the MEIC and MF, the catholyte, the binder, and the electrically conductive additive in the film is about 57, 14, 3, and 3% w/w, respectively. In some other embodiments, the weight percent of the MEIC and MF, the catholyte, the binder, and the electrically conductive additive in the film is about 57, 14, 2, and 2% w/w, respectively. In some other embodiments, the weight percent of the MEIC and MF, the catholyte, the binder, and the electrically conductive additive in the film is about 57, 14, 1, and 1% w/w, respectively.

### IV. POSITIVE ELECTRODE FILMS WITH MEIC/CONVERSION CHEMISTRY MATERIAL COMPOSITE PARTICLES

In some examples, the disclosure set forth herein further provides a Li-secondary battery positive electrode film comprising composite particles that comprise a mixed electronic ionic conductor (MEIC), a conversion chemistry material, and, optionally, an electrically conductive additive comprising carbon. The film can further comprise a catholyte and a binder, where the catholyte and binder contact the composite particles surfaces but are not contained therein. In certain examples, the film have a porosity of less than about 15% v/v at 25° C.

The low porosity (e.g., less than about 15% v/v) nanocomposites set forth herein are characterized by unexpectedly low porosity values. For example, when hard spheres randomly close pack, the maximum density which results is approximately 64% of a given volume which also includes 36% void space (i.e., porosity). In contrast, the nanocomposites set forth herein, however, show porosity values less than 15% v/v which corresponds to greater than 75% v/v density of the packed material.

The conversion chemistry material included in the composite particles can be any suitable material that undergoes a conversion chemical reaction during the charging and discharging cycles of a secondary battery. Suitable conversion chemistry materials can include LiF, Fe, Cu, Ni, FeF₂, FeO_{d}F_{3-2d}, FeF₃, CoF₃, CoF₂, CuF₂, NiF_{2.5}, or NiF₂, where 0≦d≦0.5. In some embodiments, the conversion chemistry material is LiF. In other embodiments, the conversion chemistry material is Fe. In some other embodiments, the conversion chemistry material is Cu. In some other embodiments, the conversion chemistry material is Ni. In some other embodiments, the conversion chemistry material is FeF₂. In some other embodiments, the conversion chemistry material is FeO_{d}F_{3-2d} where 0≦d≦0.5. In some other embodiments, the conversion chemistry material is FeF₃. In some other embodiments, the conversion chemistry material is CoF₃. In some other embodiments, the conversion chemistry material is CoF₂. In some other embodiments, the conversion chemistry material is CuF₂. In some other embodiments, the conversion chemistry material is NiF₂.

The MEIC included in the composite particles can be any suitable material that conducts both ions and electrons. Suitable MEICs can include MoS₂, MoO₃₋ₓ where 0≦x≦1, VOₓ where 1≦x≦2.5, MnOₓ where 1≦x≦3.5, LiAlCl₄, LiₓNa_{y}MₐM′_{b}(PO₄)₃ where 0≦y≦2, 0≦a≦2, 0≦b≦2, and M and M′ are transition metals, LiₓMM′(SO₄)₃ where M and M′ are transition metals, or LiMXO₄ where M is a transitional metal and X is Ge, Si, Sb, As, or P. In some embodiments, the MEIC is MoS₂. In other embodiments, the MEIC is MoO₃₋ₓ where 0≦x≦1. In some other embodiments, the MEIC is VOₓ where 1≦x≦2.5. In some other embodiments, the MEIC is MnOₓ where 1≦x≦3.5. In some other embodiments, the MEIC is LiAlCl₄. In some other embodiments, the MEIC is LiₓNa_{y}MₐM′_{b}(PO₄)₃ where 0≦y≦2, 0≦a≦2, 0≦b≦2, and M and M′ are transition metals. In some other embodiments, the MEIC is LiₓMM′(SO₄)₃ where M and M′ are transition metals. In some other embodiments, the MEIC is LiMXO₄ where M is a transitional metal and X is Ge, Si, Sb, As, or P, and the like.

In some embodiments, the conversion chemistry material is nanodimensioned and, in some other embodiments, the conversion chemistry material is in the form of nanodomains.

In some embodiments, the conversion chemistry material is doped with a dopant including Li, Mg, Al, Si, Ca, Ti, V, Cr, Mn, Mo, Fe, Co, Ni, Cu, Zn, Y, Zr, Nb, Ba, or Hf, a metal oxide of said metal, a cation of said metal, a metal fluoride of said metal, or combinations thereof. In some embodiments, the dopant is Li. In other embodiments, the dopant is Mg. In some other embodiments, the dopant is Al. In some other embodiments, the dopant is Si. In some other embodiments, the dopant is Ca. In some other embodiments, the dopant is Ti. In some other embodiments, the dopant is V. In some other embodiments, the dopant is Cr. In some other embodiments, the dopant is Mn. In other embodiments, the dopant is Mo. In some other embodiments, the dopant is Fe. In some other embodiments, the dopant is Co. In some other embodiments, the dopant is Ni. In some other embodiments, the dopant is Cu. In some other embodiments, the dopant is Zn. In some other embodiments, the dopant is Y. In some other embodiments, the dopant is Zr. In some other embodiments, the dopant is Nb. In some other embodiments, the dopant is Ba. In some other embodiments, the dopant is Hf. In some other embodiments, the dopant is a metal oxide of Li (e.g., Li₂O). In some other embodiments, the dopant is Hf. In some other embodiments, the dopant is a metal oxide of Mg. In some other embodiments, the dopant is a metal oxide of Al. In some other embodiments, the dopant is a metal oxide of Si. In some other embodiments, the dopant is a metal oxide of Ca. In some other embodiments, the dopant is a metal oxide of Ti. In some other embodiments, the dopant is a metal oxide of V. In some other embodiments, the dopant is a metal oxide of Cr. In some other embodiments, the dopant is a metal oxide of Mn. In some other embodiments, the dopant is a metal oxide of Fe. In some other embodiments, the dopant is a metal oxide of Co. In some other embodiments, the dopant is a metal oxide of Ni. In some other embodiments, the dopant is a metal oxide of Cu. In some other embodiments, the dopant is a metal oxide of Zn. In some other embodiments, the dopant is a metal oxide of Y. In some other embodiments, the dopant is a metal oxide of Zr. In some other embodiments, the dopant is a metal oxide of Nb. In some other embodiments, the dopant is a metal oxide of Ba. In some other embodiments, the dopant is a metal oxide of Hf. In some other embodiments, the dopant is a cation of Li. In some other embodiments, the dopant is a cation of Mg. In some other embodiments, the dopant is a cation of Al. In some other embodiments, the dopant is a cation of Si. In some other embodiments, the dopant is a cation of Ca. In some other embodiments, the dopant is a cation of Ti. In some other embodiments, the dopant is a cation of V. In some other embodiments, the dopant is a cation of Cr. In some other embodiments, the dopant is a cation of Mn. In some other embodiments, the dopant is a cation of Fe. In some other embodiments, the dopant is a cation of Co. In some other embodiments, the dopant is a cation of Ni. In some other embodiments, the dopant is a cation of Cu. In some other embodiments, the dopant is a cation of Zn. In some other embodiments, the dopant is a cation of Y. In some other embodiments, the dopant is a cation of Zr. In some other embodiments, the dopant is a cation of Nb. In some other embodiments, the dopant is a cation of Ba. In some other embodiments, the dopant is a cation of Hf. In some other embodiments, the dopant is a fluoride of Li. In some other embodiments, the dopant is a fluoride of Mg. In some other embodiments, the dopant is a fluoride of Al. In some other embodiments, the dopant is a fluoride of Si. In some other embodiments, the dopant is a fluoride of Ca. In some other embodiments, the dopant is a fluoride of Ti. In some other embodiments, the dopant is a fluoride of V. In some other embodiments, the dopant is a fluoride of Cr. In some other embodiments, the dopant is a fluoride of Mn. In some other embodiments, the dopant is a fluoride of Fe. In some other embodiments, the dopant is a fluoride of Co. In some other embodiments, the dopant is a fluoride of Ni. In some other embodiments, the dopant is a fluoride of Cu. In some other embodiments, the dopant is a fluoride of Zn. In some other embodiments, the dopant is a fluoride of Y. In some other embodiments, the dopant is a fluoride of Zr. In some other embodiments, the dopant is a fluoride of Nb. In some other embodiments, the dopant is a fluoride of Ba. In some other embodiments, the dopant is a fluoride of Hf

In some embodiments, the conversion chemistry material is doped with a dopant including Li₂O, Cu, CuF₂, NiF₂, ZrF₄, CaF₂, or AlF₃. In some embodiments, the dopant is Li₂O. In other embodiments, the dopant is CuF₂. In some other embodiments, the dopant is NiF₂. In some other embodiments, the dopant is MoO₂. In some other embodiments, the dopant is MoO₃. In some other embodiments, the dopant is ZrF₄. In some other embodiments, the dopant is CaF₂. In some other embodiments, the dopant is AlF₃.

In some embodiments, the dopant is present in an amount from about 0.1 to 15 atomic %.

In some embodiments, the conversion chemistry material is LiF and can further comprise a nanodimensioned metal including Fe, Co, Mn, Cu, Ni, Zr, or combinations thereof. In some embodiments, the nanodimensioned metal is Fe. In other embodiments, the nanodimensioned metal is Co. In some other embodiments, the nanodimensioned metal is Mn. In some other embodiments, the nanodimensioned metal is Cu. In some other embodiments, the nanodimensioned metal is Ni. In some other embodiments, the nanodimensioned metal is Zr.

The optional electrically conductive additive comprising carbon can be any suitable carbon-containing material that improves the electrical conductivity of the electrode. Suitable electrically conductive additives can include activated carbon, carbon black, carbon fibers, carbon nanotubes, carbon nanofibers, graphite, graphene, fullerenes, ketjen black, vapor grown carbon fiber (VGCF), or acetylene black. In some embodiments, the electrically conductive additive is activated carbon. In other embodiments, the electrically conductive additive is carbon black. In some other embodiments, the electrically conductive additive is carbon fibers. In some other embodiments, the electrically conductive additive is carbon nanotubes. In some other embodiments, the electrically conductive additive is carbon nanofibers. In some other embodiments, the electrically conductive additive is graphite. In some other embodiments, the electrically conductive additive is graphene. In some other embodiments, the electrically conductive additive is fullerenes. In some other embodiments, the electrically conductive additive is ketjen black. In some other embodiments, the electrically conductive additive is vapor grown carbon fiber (VGCF). In some other embodiments, the electrically conductive additive is acetylene black.

The catholyte can be any suitable ion conductor that is intimately mixed with, or that surrounds, composite particles including an MEIC and a conversion chemistry material. Suitable catholytes can include LSS, LXPS, LXPSO, Li-stuffed garnet, where X is Si, Ge, Sn, As, Al, or combinations thereof. In some embodiments, the catholyte is LSS. In other embodiments, the catholyte is LXPS where X is Si, Ge, Sn, Al, or combinations thereof. In some other embodiments, the catholyte is LXPS where X is Si. In some other embodiments, the catholyte is LXPS where X is Ge. In some other embodiments, the catholyte is LXPS where X is Sn. In some other embodiments, the catholyte is LXPS where X is Al. In some embodiments, the catholyte is LXPSO where X is Si, Ge, Sn, Al, or combinations thereof. In other embodiments, the catholyte is LXPSO where X is Si. In some other embodiments, the catholyte is LXPSO where X is Ge. In some other embodiments, the catholyte is LXPSO where X is Sn. In some other embodiments, the catholyte is LXPSO where X is Al. In some other embodiments, the catholyte is LXPSO where X is As. In some embodiments, the catholyte is Li-stuffed garnet.

In some embodiments, the catholyte is LXPS and is substantially free of oxygen, where X is Si, Ge, Sn, As, Al, or combinations thereof. In some embodiments, the catholyte is LXPS and is substantially free of oxygen, where X is Si. In some embodiments, the catholyte is LXPS and is substantially free of oxygen, where X is As. In other embodiments, the catholyte is LXPS and is substantially free of oxygen, where X is Ge. In some other embodiments, the catholyte is LXPS and is substantially free of oxygen, where X is Sn. In some other embodiments, the catholyte is LXPS and is substantially free of oxygen, where X is Al.

In some embodiments, the positive electrode film may not include a catholyte. In other embodiments, the catholyte is Li-stuffed garnet or Li₂B₄O₇. In some other embodiments, the catholyte is Li₂B₄O₇. In other embodiments, the catholyte is Li-stuffed garnet.

The binder can be any suitable material that assists in the adhesion of the composite particle components and/or adhesion of the composite particles to the other components of the positive electrode film. Suitable binders include polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), stereoblock polypropylenes, polypropylene polymethylpentene copolymer, or silicone. In some embodiments, the binder is polypropylene (PP). In other embodiments, the binder is atactic polypropylene (aPP). In some other embodiments, the binder is isotactive polypropylene (iPP). In some other embodiments, the binder is ethylene propylene rubber (EPR). In some other embodiments, the binder is ethylene pentene copolymer (EPC). In some other embodiments, the binder is polyisobutylene (PIB). In some other embodiments, the binder is styrene butadiene rubber (SBR). In some other embodiments, the binder is polyolefins. In some other embodiments, the binder is polyethylene-co-poly-1-octene (PE-co-PO). In some other embodiments, the binder is PE-co-poly(methylene cyclopentane) (PE-co-PMCP). In some other embodiments, the binder is stereoblock polypropylenes. In some other embodiments, the binder is polypropylene polymethylpentene copolymer. In some other embodiments, the binder is a polyethylene polymer. In some other embodiments, the binder is a polyethylene copolymer. In some other embodiments, the binder is silicone.

In some embodiments, the MEIC has a charge and/or discharge voltage window that overlaps the same of the conversion chemistry material. In some embodiments, the MEIC has a discharge voltage of between about 3 to 3.5 V v. Li. In other embodiments, the MEIC has a discharge voltage of between about 2.9 to 3.4 V v. Li. In some other embodiments, the MEIC has a discharge voltage of between about 2.8 to 3.3 V v. Li. In some other embodiments, the MEIC has a discharge voltage of between about 2.7 to 3.2 V v. Li. In some other embodiments, the MEIC has a discharge voltage of between about 2.6 to 3.1 V v. Li. In some other embodiments, the MEIC has a discharge voltage of between about 2.5 to 3 V v. Li. In some other embodiments, the MEIC has a discharge voltage of between about 2.4 to 2.9 V v. Li. In some other embodiments, the MEIC has a discharge voltage of between about 2.3 to 2.8 V v. Li. In some other embodiments, the MEIC has a discharge voltage of between about 2.2 to 2.7 V v. Li. In some other embodiments, the MEIC has a discharge voltage of between about 2.1 to 2.6 V v. Li. In some other embodiments, the MEIC has a discharge voltage of between about 2 to 2.5 V v. Li. In some other embodiments, the MEIC has a discharge voltage of between about 3.1 to 3.6 V v. Li. In some other embodiments, the MEIC has a discharge voltage of between about 3.2 to 3.7 V v. Li. In some other embodiments, the MEIC has a discharge voltage of between about 3.3 to 3.8 V v. Li. In some other embodiments, the MEIC has a discharge voltage of between about 3.4 to 3.9 V v. Li. In some other embodiments, the MEIC has a discharge voltage of between about 3.5 to 4 V v. Li. In some other embodiments, the MEIC has a discharge voltage of between about 3.6 to 4.1 V v. Li. In some other embodiments, the MEIC has a discharge voltage of between about 3.7 to 4.2 V v. Li. In some other embodiments, the MEIC has a discharge voltage of between about 3.8 to 4.3 V v. Li. In some other embodiments, the MEIC has a discharge voltage of between about 3.9 to 4.4 V v. Li. In some other embodiments, the MEIC has a discharge voltage of between about 4.0 to 4.5 V v. Li.

The positive electrode film can be characterized by a variety of suitable thickness. In some embodiments, the film is characterized by a thickness of about 1 to 100 μm. In other embodiments, the film is characterized by a thickness of about 5 to 95 μm. In some other embodiments, the film is characterized by a thickness of about 10 to 90 μm. In some other embodiments, the film is characterized by a thickness of about 15 to 85 μm. In some other embodiments, the film is characterized by a thickness of about 20 to 80 μm. In some other embodiments, the film is characterized by a thickness of about 25 to 75 μm. In some other embodiments, the film is characterized by a thickness of about 30 to 70 μm. In some other embodiments, the film is characterized by a thickness of about 35 to 65 μm. In some other embodiments, the film is characterized by a thickness of about 40 to 60 μm. In some other embodiments, the film is characterized by a thickness of about 45 to 55 μm.

The positive electrode film can be characterized by a variety of suitable thickness. In some embodiments, the film is characterized by a thickness of about 1 to 20 μm. In other embodiments, the film is characterized by a thickness of about 5 to 150 μm. In some other embodiments, the film is characterized by a thickness of about 10 to 120 μm. In some other embodiments, the film is characterized by a thickness of about 15 to 110 μm. In some other embodiments, the film is characterized by a thickness of about 20 to 100 μm. In some other embodiments, the film is characterized by a thickness of about 25 to 90 μm. In some other embodiments, the film is characterized by a thickness of about 30 to 85 μm. In some other embodiments, the film is characterized by a thickness of about 35 to 80 μm. In some other embodiments, the film is characterized by a thickness of about 40 to 75 μm. In some other embodiments, the film is characterized by a thickness of about 45 to 70 μm.

In some embodiments, the film can be characterized by a thickness of about 10 to 40 μm. In other embodiments, the film is characterized by a thickness of about 12 to 38 μm. In some other embodiments. The film is characterized by a thickness of about 14 to 36 μm. In some other embodiments. The film is characterized by a thickness of about 16 to 34 μm. In some other embodiments. The film is characterized by a thickness of about 18 to 32 μm. In some other embodiments. The film is characterized by a thickness of about 20 to 30 μm. In some other embodiments. The film is characterized by a thickness of about 22 to 28 μm. In some other embodiments. The film is characterized by a thickness of about 24 to 26 μm.

In some embodiments, the positive electrode film can be characterized by a thickness less than about 1 μm. For example, in some embodiments, the film is characterized by a thickness of about 15 to 800 nm. In other embodiments, the film can be characterized by a thickness of about 15 to 700 nm. In some other embodiments, the film is characterized by a thickness of about 15 to 600 nm. In some other embodiments, the film is characterized by a thickness of about 15 to 500 nm. In some other embodiments, the film is characterized by a thickness of about 15 to 400 nm. In some other embodiments, the film is characterized by a thickness of about 15 to 300 nm. In some other embodiments, the film is characterized by a thickness of about 15 to 200 nm. In some other embodiments, the film is characterized by a thickness of about 15 to 100 nm. In some other embodiments, the film is characterized by a thickness of about 20 to 95 nm. In some other embodiments, the film is characterized by a thickness of about 25 to 90 nm. In some other embodiments, the film is characterized by a thickness of about 30 to 85 nm. In some other embodiments, the film is characterized by a thickness of about 35 to 80 nm. In some other embodiments, the film is characterized by a thickness of about 40 to 75 nm. In some other embodiments, the film is characterized by a thickness of about 45 to 70 nm. In some other embodiments, the film is characterized by a thickness of about 50 to 65 nm. In some other embodiments, the film is characterized by a thickness of about 55 to 60 nm.

In some embodiments, the film can be characterized by a porosity less than 20% v/v. In other embodiments, the film is characterized by a porosity less than 19% v/v. In some other embodiments, the film is characterized by a porosity less than 18% v/v. In some other embodiments, the film is characterized by a porosity less than 17% v/v. In some embodiments, the film can be characterized by a porosity less than 16% v/v. In other embodiments, the film is characterized by a porosity less than 15% v/v. In some other embodiments, the film is characterized by a porosity less than 14% v/v. In some other embodiments, the film is characterized by a porosity less than 13% v/v. In some embodiments, the film can be characterized by a porosity less than 12% v/v. In other embodiments, the film is characterized by a porosity less than 11% v/v. In some other embodiments, the film is characterized by a porosity less than 10% v/v. In some other embodiments, the film is characterized by a porosity less than 9% v/v. In some embodiments, the film can be characterized by a porosity less than 8% v/v. In other embodiments, the film is characterized by a porosity less than 7% v/v. In some other embodiments, the film is characterized by a porosity less than 6% v/v. In some other embodiments, the film is characterized by a porosity less than 5% v/v. In some other embodiments, the film is characterized by a porosity less than 4% v/v. In some embodiments, the film can be characterized by a porosity less than 3% v/v. In other embodiments, the film is characterized by a porosity less than 2% v/v. In some other embodiments, the film is characterized by a porosity less than 1% v/v.

In some embodiments, the composite in the film can be characterized by a porosity less than 20% v/v. In other embodiments, the composite in the film is characterized by a porosity less than 19% v/v. In some other embodiments, the composite in the film is characterized by a porosity less than 18% v/v. In some other embodiments, the composite in the film is characterized by a porosity less than 17% v/v. In some embodiments, the composite in the film can be characterized by a porosity less than 16% v/v. In other embodiments, the composite in the film is characterized by a porosity less than 15% v/v. In some other embodiments, the composite in the film is characterized by a porosity less than 14% v/v. In some other embodiments, the composite in the film is characterized by a porosity less than 13% v/v. In some embodiments, the composite in the film can be characterized by a porosity less than 12% v/v. In other embodiments, the composite in the film is characterized by a porosity less than 11% v/v. In some other embodiments, the composite in the film is characterized by a porosity less than 10% v/v. In some other embodiments, the composite in the film is characterized by a porosity less than 9% v/v. In some embodiments, the composite in the film can be characterized by a porosity less than 8% v/v. In other embodiments, the composite in the film is characterized by a porosity less than 7% v/v. In some other embodiments, the composite in the film is characterized by a porosity less than 6% v/v. In some other embodiments, the composite in the film is characterized by a porosity less than 5% v/v. In some other embodiments, the composite in the film is characterized by a porosity less than 4% v/v. In some embodiments, the composite in the film can be characterized by a porosity less than 3% v/v. In other embodiments, the composite in the film is characterized by a porosity less than 2% v/v. In some other embodiments, the composite in the film is characterized by a porosity less than 1% v/v.

The composite particles in the positive electrode film can have a variety of suitable sizes. In some embodiments, the composite particles are characterized by a median diameter (d₅₀) of about 0.1 to 5 μm. In other embodiments, the composite particles are characterized by a median diameter (d₅₀) of about 0.1 to 4.5 μm. In some other embodiments, the composite particles are characterized by a median diameter (d₅₀) of about 0.1 to 4 μm. In some other embodiments, the composite particles are characterized by a median diameter (d₅₀) of about 0.1 to 3.5 μm. In some other embodiments, the composite particles are characterized by a median diameter (d₅₀) of about 0.1 to 3 μm. In some other embodiments, the composite particles are characterized by a median diameter (d₅₀) of about 0.1 to 2.5 μm. In some other embodiments, the composite particles are characterized by a median diameter (d₅₀) of about 0.1 to 2 μm. In some other embodiments, the composite particles are characterized by a median diameter (d₅₀) of about 0.1 to 1.5 μm.

In some embodiments, the composite particles are characterized by a median diameter (d₅₀) of about 1 to 5 μm. In other embodiments, the composite particles are characterized by a median diameter (d₅₀) of about 1.5 to 4.5 μm. In some other embodiments, the composite particles are characterized by a median diameter (d₅₀) of about 2 to 4 μm. In some other embodiments, the composite particles are characterized by a median diameter (d₅₀) of about 2.5 to 3.5 μm. In some other embodiments, the composite particles are characterized by a median diameter (d₅₀) of about 1 μm. In some other embodiments, the composite particles are characterized by a median diameter (d₅₀) of about 2 μm. In some other embodiments, the composite particles are characterized by a median diameter (d₅₀) of about 3 μm. In some other embodiments, the composite particles are characterized by a median diameter (d₅₀) of about 4 μm. In some other embodiments, the composite particles are characterized by a median diameter (d₅₀) of about 5 μm.

In some embodiments, the composite particles are characterized by a median diameter (d₅₀) of about 0.1 to 1 μm. In other embodiments, the composite particles are characterized by a median diameter (d₅₀) of about 0.2 to 0.9 μm. In some other embodiments, the composite particles are characterized by a median diameter (d₅₀) of about 0.3 to 0.8 μm. In some other embodiments, the composite particles are characterized by a median diameter (d₅₀) of about 0.4 to 0.7 μm. In some other embodiments, the composite particles are characterized by a median diameter (d₅₀) of about 0.5 to 0.6 μm. In some other embodiments, the composite particles are characterized by a median diameter (d₅₀) of about 0.1 μm. In some other embodiments, the composite particles are characterized by a median diameter (d₅₀) of about 0.2 μm. In some other embodiments, the composite particles are characterized by a median diameter (d₅₀) of about 0.3 μm. In some other embodiments, the composite particles are characterized by a median diameter (d₅₀) of about 0.4 μm. In some other embodiments, the composite particles are characterized by a median diameter (d₅₀) of about 0.5 μm. In some other embodiments, the composite particles are characterized by a median diameter (d₅₀) of about 0.6 μm. In some other embodiments, the composite particles are characterized by a median diameter (d₅₀) of about 0.7 μm. In some other embodiments, the composite particles are characterized by a median diameter (d₅₀) of about 0.8 μm. In some other embodiments, the composite particles are characterized by a median diameter (d₅₀) of about 0.9 μm.

The conversion chemistry material can comprise atomized particles having a variety of sizes. In some embodiments, the conversion chemistry material comprises atomized particles characterized by a median diameter (d₅₀) of about 1 nm to 6 μm. In other embodiments, the conversion chemistry material comprises atomized particles characterized by a median diameter (d₅₀) of about 1 nm to 100 nm. In some other embodiments, the conversion chemistry material comprises atomized particles characterized by a median diameter (d₅₀) of about 1 nm to 10 nm. In other embodiments, the conversion chemistry material comprises atomized particles characterized by a median diameter (d₅₀) of about 1 nm to 9 nm. In some other embodiments, the conversion chemistry material comprises atomized particles characterized by a median diameter (d₅₀) of about 2 nm to 20 nm. In some other embodiments, the conversion chemistry material comprises atomized particles characterized by a median diameter (d₅₀) of about 1 nm to 8 nm. In some other embodiments, the conversion chemistry material comprises atomized particles characterized by a median diameter (d₅₀) of about 10 nm to 30 nm. In some other embodiments, the conversion chemistry material comprises atomized particles characterized by a median diameter (d₅₀) of about 1 nm to 30 nm. In some other embodiments, the conversion chemistry material comprises atomized particles characterized by a median diameter (d₅₀) of about 1 nm to 5 nm. In some other embodiments, the conversion chemistry material comprises atomized particles characterized by a median diameter (d₅₀) of about 1 nm to 40 nm. In some other embodiments, the conversion chemistry material comprises atomized particles characterized by a median diameter (d₅₀) of about 1 nm to 3 nm. In some other embodiments, the conversion chemistry material comprises atomized particles characterized by a median diameter (d₅₀) of about 5 nm to 20 nm. In some other embodiments, the conversion chemistry material comprises atomized particles characterized by a median diameter (d₅₀) of about 5 nm to 100 nm. In some other embodiments, the conversion chemistry material comprises atomized particles characterized by a median diameter (d₅₀) of about 5 nm to 200 nm. In some other embodiments, the conversion chemistry material comprises atomized particles characterized by a median diameter (d₅₀) of about 1 nm to 300 nm. In some other embodiments, the conversion chemistry material comprises atomized particles characterized by a median diameter (d₅₀) of about 1 nm to 400 nm. In some other embodiments, the conversion chemistry material comprises atomized particles characterized by a median diameter (d₅₀) of about 1 nm to 500 nm. In some other embodiments, the conversion chemistry material comprises atomized particles characterized by a median diameter (d₅₀) of about 10 nm to 500 nm. In some other embodiments, the conversion chemistry material comprises atomized particles characterized by a median diameter (d₅₀) of about 20 nm to 100 nm.

The composite particles can have any suitable weight ratio of MEIC to conversion chemistry material. In some embodiments, the weight ratio of MEIC to conversion chemistry material in the composite particles can be about 8:92 to 17:83 w/w. In some embodiments, the weight ratio of MEIC to conversion chemistry material in the composite particles can be about 1:99 to 15:75 w/w. In other embodiments, the weight ratio of MEIC to conversion chemistry material in the composite particles is about 8.5:91.5 to 16.5:83.5. In some other embodiments, the weight ratio of MEIC to conversion chemistry material in the composite particles is about 9:91 to 16:84. In some other embodiments, the weight ratio of MEIC to conversion chemistry material in the composite particles is about 9.5:90.5 to 15.5:84.5. In some other embodiments, the weight ratio of MEIC to conversion chemistry material in the composite particles is about 10:90 to 15:85. In some other embodiments, the weight ratio of MEIC to conversion chemistry material in the composite particles is about 10.5:89.5 to 14.5:85.5. In some other embodiments, the weight ratio of MEIC to conversion chemistry material in the composite particles is about 11:89 to 14:86. In some other embodiments, the weight ratio of MEIC to conversion chemistry material in the composite particles is about 11.5:88.5 to 13.5:86.5. In some other embodiments, the weight ratio of MEIC to conversion chemistry material in the composite particles is about 12:88 to 13:87.

In some embodiments, the weight percent of the MEIC and conversion chemistry material the catholyte, the binder, and the electrically conductive additive in the film is about 55-57, 14-16, 1-6, and 1-6% w/w, respectively. In other embodiments, the weight percent of the MEIC and conversion chemistry material, the catholyte, the binder, and the electrically conductive additive in the film is about 55.2-56.8, 14.2-15.8, 1.5-5.5, and 1.5-5.5% w/w, respectively. In some other embodiments, the weight percent of the MEIC and conversion chemistry material, the catholyte, the binder, and the electrically conductive additive in the film is about 55.4-56.6, 14.4-15.6, 2-5, and 2-5% w/w, respectively. In some other embodiments, the weight percent of the MEIC and conversion chemistry material, the catholyte, the binder, and the electrically conductive additive in the film is about 55.6-56.4, 14.6-15.4, 2.5-4.5, and 2.5-4.5% w/w, respectively. In some other embodiments, the weight percent of the MEIC and conversion chemistry material, the catholyte, the binder, and the electrically conductive additive in the film is about 55.8-56.2, 14.8-15.2, 3-4, and 3-4% w/w, respectively.

In some embodiments, the weight percent of the MEIC and conversion chemistry material, the catholyte, the binder, and the electrically conductive additive in the film is about 55, 16, 6, and 6% w/w, respectively. In other embodiments, the weight percent of the MEIC and conversion chemistry material, the catholyte, the binder, and the electrically conductive additive in the film is about 55, 16, 5, and 5% w/w, respectively. In some other embodiments, the weight percent of the MEIC and conversion chemistry material, the catholyte, the binder, and the electrically conductive additive in the film is about 55, 16, 4, and 4% w/w, respectively. In some other embodiments, the weight percent of the MEIC and conversion chemistry material, the catholyte, the binder, and the electrically conductive additive in the film is about 55, 16, 3, and 3% w/w, respectively. In some other embodiments, the weight percent of the MEIC and conversion chemistry material, the catholyte, the binder, and the electrically conductive additive in the film is about 55, 16, 2, and 2% w/w, respectively. In some other embodiments, the weight percent of the MEIC and conversion chemistry material, the catholyte, the binder, and the electrically conductive additive in the film is about 55, 16, 1, and 1% w/w, respectively.

In some embodiments, the weight percent of the MEIC and conversion chemistry material, the catholyte, the binder, and the electrically conductive additive in the film is about 56, 15, 6, and 6% w/w, respectively. In other embodiments, the weight percent of the MEIC and conversion chemistry material, the catholyte, the binder, and the electrically conductive additive in the film is about 56, 15, 5, and 5% w/w, respectively. In some other embodiments, the weight percent of the MEIC and conversion chemistry material, the catholyte, the binder, and the electrically conductive additive in the film is about 56, 15, 4, and 4% w/w, respectively. In some other embodiments, the weight percent of the MEIC and conversion chemistry material, the catholyte, the binder, and the electrically conductive additive in the film is about 56, 15, 3, and 3% w/w, respectively. In some other embodiments, the weight percent of the MEIC and conversion chemistry material, the catholyte, the binder, and the electrically conductive additive in the film is about 56, 15, 2, and 2% w/w, respectively. In some other embodiments, the weight percent of the MEIC and conversion chemistry material, the catholyte, the binder, and the electrically conductive additive in the film is about 56, 15, 1, and 1% w/w, respectively.

In some embodiments, the weight percent of the MEIC and conversion chemistry material, the catholyte, the binder, and the electrically conductive additive in the film is about 57, 14, 6, and 6% w/w, respectively. In other embodiments, the weight percent of the MEIC and conversion chemistry material, the catholyte, the binder, and the electrically conductive additive in the film is about 57, 14, 5, and 5% w/w, respectively. In some other embodiments, the weight percent of the MEIC and conversion chemistry material, the catholyte, the binder, and the electrically conductive additive in the film is about 57, 14, 4, and 4% w/w, respectively. In some other embodiments, the weight percent of the MEIC and conversion chemistry material, the catholyte, the binder, and the electrically conductive additive in the film is about 57, 14, 3, and 3% w/w, respectively. In some other embodiments, the weight percent of the MEIC and conversion chemistry material, the catholyte, the binder, and the electrically conductive additive in the film is about 57, 14, 2, and 2% w/w, respectively. In some other embodiments, the weight percent of the MEIC and conversion chemistry material, the catholyte, the binder, and the electrically conductive additive in the film is about 57, 14, 1, and 1% w/w, respectively.

### V. METHODS FOR FORMING POSITIVE ELECTRODE FILMS WITH MEIC/MF COMPOSITE PARTICLES

In some examples, the disclosure set forth herein further provides a method of making the Li-secondary battery positive electrode films described herein comprising composite particles that comprise an MEIC and a MF. In some examples, the composites have a porosity that is less than 15% v/v as measured by pycnometry. In some examples, the composites have a porosity that is less than 10% v/v. In some examples, the composites have a porosity that is less than 5% v/v. The method can include providing a combination of a MEIC, a MF, a catholyte, and a binder. An electrically conductive additive comprising carbon can optionally be included in the combination. In some examples, the combination is heated to a temperature of about 80 to 400° C., and pressure is applied to the combination, thereby forming the positive electrode film. In some examples, the combination is heated to a temperature of about 100 to 400° C., and pressure is applied to the combination, thereby forming the positive electrode film.

In some embodiments, the combination is heated to a temperature of about 305 to 395° C. In other embodiments, the combination is heated to a temperature of about 310 to 390° C. In some other embodiments, the combination is heated to a temperature of about 315 to 385° C. In some other embodiments, the combination is heated to a temperature of about 320 to 380° C. In some other embodiments, the combination is heated to a temperature of about 325 to 375° C. In some other embodiments, the combination is heated to a temperature of about 330 to 370° C. In some other embodiments, the combination is heated to a temperature of about 335 to 365° C. In some other embodiments, the combination is heated to a temperature of about 340 to 360° C. In some other embodiments, the combination is heated to a temperature of about 345 to 355° C.

In some embodiments, the combination is heated to a temperature of about 300° C. In other embodiments, the combination is heated to a temperature of about 310° C. In some other embodiments, the combination is heated to a temperature of about 320° C. In some other embodiments, the combination is heated to a temperature of about 330° C. In some other embodiments, the combination is heated to a temperature of about 340° C. In some other embodiments, the combination is heated to a temperature of about 350° C. In some other embodiments, the combination is heated to a temperature of about 360° C. In some other embodiments, the combination is heated to a temperature of about 370° C. In some other embodiments, the combination is heated to a temperature of about 380° C. In some other embodiments, the combination is heated to a temperature of about 390° C. In some other embodiments, the combination is heated to a temperature of about 400° C.

In some embodiments, providing the combination can comprise casting a slurry comprising the combination.

In some embodiments, the pressure applied to the composite is between about 1 to 10,000 PSI. In some embodiments, the pressure is applied while heating as set forth above. In other embodiments, the pressure is between about 10 to 90 PSI. In some other embodiments, the pressure is between about 20 to 80 PSI. In some other embodiments, the pressure is between about 30 to 70 PSI. In some other embodiments, the pressure is between about 40 to 60 PSI. In some other embodiments, the pressure is between about 50 to 100 PSI. In some other embodiments, the pressure is between about 60 to 100 PSI. In some other embodiments, the pressure is between about 70 to 100 PSI. In some other embodiments, the pressure is between about 80 to 100 PSI. In some other embodiments, the pressure is between about 1,000 to 100 PSI. In some other embodiments, the pressure is about 2,000 PSI. In some other embodiments, the pressure is about 3,000 PSI. In some other embodiments, the pressure is about 4,000 PSI. In some other embodiments, the pressure is about 5,000 PSI. In some other embodiments, the pressure is about 6,000 PSI. In some other embodiments, the pressure is about 7,000 PSI. In some other embodiments, the pressure is about 8,000 PSI. In some other embodiments, the pressure is about 9,000 PSI. In some other embodiments, the pressure is about 10,000 PSI. In some other embodiments, the pressure is about 15,000 PSI. In some other embodiments, the pressure is about 20,000 PSI. In some embodiments, the pressure is applied in a calendering device that applies heat and pressure simultaneously.

The heating and pressure can be provided by one or more suitable devices configured to apply pressure to the combination and to transfer thermal energy to the combination. In some embodiments, heat and/or pressure are provided by a calendering device, a sintering device (e.g., a hot pressing device, a field assisted sinter technique (FAST) device, a spark plasma sintering (SPS) devices, etc.), or combinations thereof.

In some examples, the methods herein include the use of solutions and slurries which are cast or deposited onto substrates. In certain examples, chemical precursors are milled prior to being mixed in a slurry. In some examples, these precursors are formulated into a slurry. In some examples, these milled precursors are formulated into a slurry. After milling, in some examples, the precursors are formulated into coating formulations, e.g., slurries with binders and solvents. These slurries and formulations may include solvents, binders, dispersants, and surfactants. In some examples, the binder is polyvinyl butyral (PVB) and the solvent is toluene and/or ethanol and/or diacetone alcohol. In some examples, PVB is both a binder and a dispersant. In some examples, the binders also include PVB, PVP, Ethyl Cellulose, Celluloses, PVA, and PVDF. In some examples, the dispersants include surfactants, fish oil, fluorosurfactants, Triton, PVB, and PVP. In some slurries, 10% to 60% by weight (w/w) of the slurry is solid precursors. Binders and dispersants can each, in some slurries, make up 50% w/w of the slurry, with solvents comprising the remainder weight percentages.

In some examples disclosed herein, slurries include a conductive additive that is carbon. In certain embodiments, the carbon is a member selected from the group consisting of ketjen black, VGCF, acetylene black, graphite, graphene, nanotubes, nanofibers, the like, and combinations thereof. In certain embodiments, the carbon is ketjen black. In certain other embodiments, the carbon is VGCF. In yet other embodiments, the carbon is acetylene black. In other embodiments, the carbon is graphite. In some embodiments, the carbon is graphene. In other embodiments, the carbon is nanotube. In other embodiments, the carbon is nanofibers.

In some examples, the solvent is selected from toluene, ethanol, toluene:ethanol, or combinations thereof. In certain embodiments disclosed herein, the binder is polyvinyl butyral (PVB). In certain embodiments disclosed herein, the binder is polypropylene carbonate. In certain embodiments disclosed herein, the binder is a polymethylmethacrylate.

In some examples, the solvent is toluene, ethanol, toluene:ethanol, or combinations thereof. In some examples, the binder is polyvinyl butyral (PVB). In other examples, the binder is polypropylene carbonate. In yet other examples, the binder is a polymethylmethacrylate. In some embodiments disclosed herein, the removing the solvent includes evaporating the solvent. In some of these embodiments, the removing the solvent includes heating the film. In some embodiments, the removing includes using a reduced atmosphere. In still other embodiments, the removing includes using a vacuum to drive off the solvent. In yet other embodiments, the removing includes heating the film and using a vacuum to drive off the solvent.

### VI. METHODS FOR FORMING POSITIVE ELECTRODE FILMS WITH ANNEALED MEIC/MF COMPOSITE PARTICLES

The disclosure set forth herein further provides a method of making Li-secondary battery positive electrode films including annealed composite particles. In some embodiments, the method can include preparing a composite comprising a mixed electronic ionic conductor (MEIC) selected from metal oxides, metal sulfides, metal halides, metal oxyhalides, and combinations thereof, a nanodimensioned metal fluoride (MF), an optional binder, and an optional electrically conductive additive comprising carbon. The composite can be milled to form a milled composite having a characteristic dimension of about 300 nm to 100 μm. The milled composite can be heated to a temperature of about 150° C. to 600° C. for about 2 to 10 hours to form an annealed composite. The annealed composite can be optionally cooled to room temperature. A slurry can be prepared by mixing the annealed composite with a catholyte and optionally a binder, and the slurry can be cast as a film. The film can be heated to a temperature of about 80° C. to 400° C., and pressure can be applied to the film, thereby forming the positive electrode film.

In some embodiments, the composite can comprise the binder. The binder can be any suitable material that assists in the adhesion of the composite particle components and/or adhesion of the composite particles to the other components of the positive electrode film. Suitable binders can include, but are not limited to, polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), stereoblock polypropylenes, polypropylene polymethylpentene copolymer, polyethylene oxide (PEO), PEO block co-polymers, and silicone. In some embodiments, the binder is polypropylene (PP). In other embodiments, the binder is atactic polypropylene (aPP). In other embodiments, the binder is PEO. In some other embodiments, the binder is isotactive polypropylene (iPP). In some other embodiments, the binder is ethylene propylene rubber (EPR). In some other embodiments, the binder is ethylene pentene copolymer (EPC). In some other embodiments, the binder is polyisobutylene (PIB). In some other embodiments, the binder is styrene butadiene rubber (SBR). In some other embodiments, the binder is polyolefins. In some other embodiments, the binder is polyethylene-co-poly-1-octene (PE-co-PO). In some other embodiments, the binder is PE-co-poly(methylene cyclopentane) (PE-co-PMCP). In some other embodiments, the binder is stereoblock polypropylenes. In some other embodiments, the binder is polypropylene polymethylpentene copolymer. In some other embodiments, the binder is silicone.

In some embodiments, the composite can comprise the electrically conductive additive comprising carbon, which can be any suitable carbon-containing material that improves the electrical conductivity of the positive electrode film. Suitable electrically conductive additives can include, but are not limited to, activated carbon, carbon black, carbon fibers, carbon nanotubes, carbon nanofibers, graphite, graphene, fullerenes, ketjen black, vapor grown carbon fiber (VGCF), and acetylene black. In some embodiments, the electrically conductive additive is activated carbon. In other embodiments, the electrically conductive additive is carbon black. In some other embodiments, the electrically conductive additive is carbon fibers. In some other embodiments, the electrically conductive additive is carbon nanotubes. In some other embodiments, the electrically conductive additive is carbon nanofibers. In some other embodiments, the electrically conductive additive is graphite. In some other embodiments, the electrically conductive additive is graphene. In some other embodiments, the electrically conductive additive is fullerenes. In some other embodiments, the electrically conductive additive is ketjen black. In some other embodiments, the electrically conductive additive is vapor grown carbon fiber (VGCF). In some other embodiments, the electrically conductive additive is acetylene black.

In some embodiments, the method includes the step of cooling the annealed composite to room temperature. Any suitable cooling rate can be used including, but not limited to, 500° C./min to 0.1° C./min.

In some embodiments, preparing the composite comprises individually milling the MEIC, MF, optional binder, and optional electrically conductive additive prior to combining the MEIC, MF, optional binder, and optional electrically conductive additive. In other embodiments, the preparing the composite comprises individually milling the MEIC or the MF prior to combining the MEIC, MF, optional binder, and optional electrically conductive additive. In some other embodiments, preparing the composite comprises individually milling the MEIC and the optional binder prior to combining the MEIC, MF, optional binder, and optional electrically conductive additive. In some other embodiments, preparing the composite individually milling the MF and the optional binder prior to combining the MEIC, MF, optional binder, and optional electrically conductive additive.

The milling of one or more of the MEIC, MF, optional binder, and optional electrically conductive additive can be accomplished using a wet milling process. In some embodiments, milling the composite comprises wet milling one or more of the MEIC, MF, optional binder, and optional electrically conductive additive in a solvent selected from methanol, ethanol, isopropanol, butanol, pentanol, hexanol, toluene, toluene:ethanol, acetone, N-methyl-2-pyrrolidone (NMP), diacetone alcohol, ethyl acetate, hexane, nonane, dodecane, and combinations thereof. In some embodiments, one or more of the MEIC, MF, optional binder, and optional electrically conductive additive can be wet milled in methanol. In other embodiments, one or more of the MEIC, MF, optional binder, and optional electrically conductive additive can be wet milled in ethanol. In some other embodiments, one or more of the MEIC, MF, optional binder, and optional electrically conductive additive can be wet milled in isopropanol. In some other embodiments, one or more of the MEIC, MF, optional binder, and optional electrically conductive additive can be wet milled in butanol. In some other embodiments, one or more of the MEIC, MF, optional binder, and optional electrically conductive additive can be wet milled in pentanol. In some other embodiments, one or more of the MEIC, MF, optional binder, and optional electrically conductive additive can be wet milled in hexanol. In some other embodiments, one or more of the MEIC, MF, optional binder, and optional electrically conductive additive can be wet milled in toluene. In some other embodiments, one or more of the MEIC, MF, optional binder, and optional electrically conductive additive can be wet milled in toluene:ethanol. In some other embodiments, one or more of the MEIC, MF, optional binder, and optional electrically conductive additive can be wet milled in acetone. In some other embodiments, one or more of the MEIC, MF, optional binder, and optional electrically conductive additive can be wet milled in N-methyl-2-pyrrolidone (NMP). In some other embodiments, one or more of the MEIC, MF, optional binder, and optional electrically conductive additive can be wet milled in diacetone alcohol. In some other embodiments, one or more of the MEIC, MF, optional binder, and optional electrically conductive additive can be wet milled in ethyl acetate. In some other embodiments, one or more of the MEIC, MF, optional binder, and optional electrically conductive additive can be wet milled in hexane. In some other embodiments, one or more of the MEIC, MF, optional binder, and optional electrically conductive additive can be wet milled in nonane. In some other embodiments, one or more of the MEIC, MF, optional binder, and optional electrically conductive additive can be wet milled in dodecane. In some other embodiments, one or more of the MEIC, MF, optional binder, and optional electrically conductive additive can be wet milled in a combination of two or more of methanol, ethanol, isopropanol, butanol, pentanol, hexanol, toluene, toluene:ethanol, acetone, N-methyl-2-pyrrolidone (NMP), diacetone alcohol, ethyl acetate, hexane, nonane, and dodecane.

The MEIC can comprise any suitable volume percentage of the composite. In some embodiments, the volume percent of the MEIC in the composite is about 30% (v/v) or less. In other embodiments, the volume percent of the MEIC in the composite is about 27% (v/v) or less. In some other embodiments, the volume percent of the MEIC in the composite is about 24% (v/v) or less. In some other embodiments, the volume percent of the MEIC in the composite is about 21% (v/v) or less. In some other embodiments, the volume percent of the MEIC in the composite is about 18% (v/v) or less. In some other embodiments, the volume percent of the MEIC in the composite is about 15% (v/v) or less. In some other embodiments, the volume percent of the MEIC in the composite is about 14% (v/v) or less. In some other embodiments, the volume percent of the MEIC in the composite is about 13% (v/v) or less. In some other embodiments, the volume percent of the MEIC in the composite is about 12% (v/v) or less. In some other embodiments, the volume percent of the MEIC in the composite is about 11% (v/v) or less. In some other embodiments, the volume percent of the MEIC in the composite is about 10% (v/v) or less. In some other embodiments, the volume percent of the MEIC in the composite is about 9% (v/v) or less. In some other embodiments, the volume percent of the MEIC in the composite is about 8% (v/v) or less. In some other embodiments, the volume percent of the MEIC in the composite is about 7% (v/v) or less. In some other embodiments, the volume percent of the MEIC in the composite is about 6% (v/v) or less. In some other embodiments, the volume percent of the MEIC in the composite is about 5% (v/v) or less.

The MEIC included in the composite can be any suitable material that conducts both ions and electrons. Suitable MEICs can include, but are not limited to, MoO₃₋ₓ where 0≦x≦1, MoOF₄, FeMoO₂, FeMoO₄, MoS₂, MoS, VO_{y} where 1≦y≦2.5, LiV₃O₈, LiV₃O₆, VOF₃, fluorinated vanadium oxide, fluorinated molybdenum oxide, and MoOF. In some embodiments, the MEIC is MoO₃₋ₓ where 0≦x≦1. In other embodiments, the MEIC is MoOF4. In some other embodiments, the MEIC is FeMoO₂. In some other embodiments, the MEIC is FeMoO₄. In some other embodiments, the MEIC is MoS₂. In some other embodiments, the MEIC is MoS. In some other embodiments, the MEIC is VO_{y} where 1≦y≦2.5. In some other embodiments, the MEIC is LiV₃O₈. In some other embodiments, the MEIC is LiV₃O₆. In some other embodiments, the MEIC is VOF₃. In some other embodiments, the MEIC is fluorinated vanadium oxide. In some other embodiments, the MEIC is fluorinated molybdenum oxide. In some other embodiments, the MEIC is and MoOF.

The milled composite can be heated to any suitable temperature sufficient to provide the structural changes that result in the enhanced electrochemical properties described herein (i.e., annealed to produce an annealed nanocomposite). In some embodiments, the milled composite is heated to about 300° C., 325° C., 350° C., 375° C., 400° C., 425° C., 450° C., 475° C., or about 500° C. In some embodiments, the milled composite is heated to about 300° C. In other embodiments, the milled composite is heated to about 325° C. In some other embodiments, the milled composite is heated to about 350° C. In some other embodiments, the milled composite is heated to about 325° C. In some other embodiments, the milled composite is heated to about 375° C. In some other embodiments, the milled composite is heated to about 325° C. In some other embodiments, the milled composite is heated to about 400° C. In some other embodiments, the milled composite is heated to about 325° C. In some other embodiments, the milled composite is heated to about 425° C. In some other embodiments, the milled composite is heated to about 450° C. In some other embodiments, the milled composite is heated to about 475° C. In some other embodiments, the milled composite is heated to about 500° C. In some embodiments, the milled composite is heated to a temperature of about 300° C. to 400° C.

The milled composite can also be heated for any suitable period of time sufficient to provide the structural changes that result in the enhanced electrochemical properties described herein. In some embodiments, the milled composite is heated for about 2, 4, 6, 8, or about 10 hours. In some embodiments, the milled composite is heated for about 2 hours. In other embodiments, the milled composite is heated for about 4 hours. In some other embodiments, the milled composite is heated for about 6 hours. In some other embodiments, the milled composite is heated for about 8 hours. In some other embodiments, the milled composite is heated for about 10 hours. In some embodiments, the milled composite is heated for about 3 to 5 hours.

In some embodiments, the milled composite is heated to a temperature of about 150° C. for about 2, 4, 6, or 8 hours. In other embodiments, the milled composite is heated to a temperature of about 250° C. for about 2, 4, 6, or 8 hours. In some other embodiments, the milled composite is heated to a temperature of about 350° C. for about 2, 4, 6, or 8 hours. In some other embodiments, the milled composite is heated to a temperature of about 450° C. for 2, 4, 6, or 8 hours.

In some embodiments, heating the milled composite reduces the grain boundaries between the constituent components in the milled composite. In some embodiments, heating the milled composite reduces the porosity of the milled composite. In some embodiments, heating the milled composite increases the density of the milled composite. In some embodiments, heating the milled composite reduces the thickness of grain boundaries between the constituent components. In some embodiments, heating the milled composite causes the size of the grains of the constituent components to increase.

In some embodiments, heating the milled composite produces an additional chemical component different than the MEIC, MF, optional binder, and optional electrically conductive additive, where the additional chemical component is selected from FeF₂, FeMoO₄, FeOF, and MoOₓF_{y}, where 1≦x≦2, and 1≦y≦4. In some embodiments, the additional chemical component is FeF₂. In other embodiments, the additional chemical component is FeMoO₄. In some other embodiments, the additional chemical component is FeOF. In some other embodiments, the additional chemical component is MoOₓF_{y}, where 1≦x≦2 and 1≦y≦4.

In some embodiments, the milled composite is coated prior to heating the milled composite, and/or the annealed composite is coated prior to preparing the slurry. Any suitable coating material can be used. In some embodiments, the coating is selected from alumina, aluminum phosphate, aluminum fluoride, titania, lithium titanate, lithium niobate, lithium zirconate, lithium phosphate, lithiated versions of the preceding compounds, and combinations thereof. In some embodiments, the coating is alumina. In other embodiments, the coating is aluminum phosphate. In some other embodiments, the coating is aluminum fluoride. In some other embodiments, the coating is titania. In some other embodiments, the coating is lithium titanate. In some other embodiments, the coating is lithium niobate. In some other embodiments, the coating is lithium zirconate. In some other embodiments, the coating is lithium phosphate. In some other embodiments, the coating is lithiated versions and/or combinations of alumina, aluminum phosphate, aluminum fluoride, titania, lithium titanate, lithium niobate, lithium zirconate, or lithium phosphate.

The MF included in the composite can be a material including a metal component and a fluorine (F) component and optionally including a lithium (Li) component such that the MF is present in the “charged state” and converts to a metal and lithium fluoride during discharge of the battery. Suitable MFs include, but are not limited to, LiF, Li_{z}FeF₃, Li_{z}CuF₂, Li_{z}NiF₂, Li_{z}NiF_{2.5}, Li_{z}NiF₃, Li_{z}CoF₂, Li_{z}CoF₃, Li_{z}MnF₂, and Li_{z}MnF₃, where 0≦z≦3. In some embodiments, the MF is LiF. In other embodiments, the MF is Li_{z}FeF₃ where 0≦z≦3. In some other embodiments, the MF is Li_{z}CuF₂ where 0≦z≦3. In some other embodiments, the MF is Li_{z}NiF₂ 0≦z≦3. In some other embodiments, the MF is Li_{z}NiF_{2.5} where 0≦z≦3. In some other embodiments, the MF is Li_{z}NiF₃ 0≦z≦3. In some other embodiments, the MF is Li_{z}CoF₂ 0≦z≦3. In some other embodiments, the MF is Li_{z}CoF₃ 0≦z≦3. In some other embodiments, the MF is Li_{z}MnF₂ 0≦z≦3. In some other embodiments, the MF is Li_{z}MnF₃, where 0≦z≦3.

In some embodiments, the MF is Li_{d}MF_{g} where d and g are, independently in each instance, selected from the range of 0 to 3, and where M is a metal selected from Fe, Cu, Ni, Co, Mn, alloys thereof, and combinations thereof.

In some embodiments, the MF is doped with a dopant including oxygen, carbon, a metal selected from Li, Mg, Al, Si, Ca, Ti, V, Cr, Mn, Mo, Fe, Co, Ni, Cu, Zn, Y, Zr, Nb, Ba, and Hf, a metal oxide of said metal, a cation of said metal, a metal fluoride of said metal, or combinations thereof. In some embodiments, the dopant is Li. In other embodiments, the dopant is Mg. In some other embodiments, the dopant is Al. In some other embodiments, the dopant is Si. In some other embodiments, the dopant is Ca. In some other embodiments, the dopant is Ti. In some other embodiments, the dopant is V. In some other embodiments, the dopant is Cr. In some other embodiments, the dopant is Mn. In some other embodiments, the dopant is Mo. In some other embodiments, the dopant is Fe. In some other embodiments, the dopant is Co. In some other embodiments, the dopant is Ni. In some other embodiments, the dopant is Cu. In some other embodiments, the dopant is Zn. In some other embodiments, the dopant is Y. In some other embodiments, the dopant is Zr. In some other embodiments, the dopant is Nb. In some other embodiments, the dopant is Ba. In some other embodiments, the dopant is Hf. In some other embodiments, the dopant is a metal oxide of Li (e.g., Li₂O). In some other embodiments, the dopant is Hf. In some other embodiments, the dopant is a metal oxide of Mg. In some other embodiments, the dopant is a metal oxide of Al. In some other embodiments, the dopant is a metal oxide of Si. In some other embodiments, the dopant is a metal oxide of Ca. In some other embodiments, the dopant is a metal oxide of Ti. In some other embodiments, the dopant is a metal oxide of V. In some other embodiments, the dopant is a metal oxide of Cr. In some other embodiments, the dopant is a metal oxide of Mn. In some other embodiments, the dopant is a metal oxide of Fe. In some other embodiments, the dopant is a metal oxide of Co. In some other embodiments, the dopant is a metal oxide of Ni. In some other embodiments, the dopant is a metal oxide of Cu. In some other embodiments, the dopant is a metal oxide of Zn. In some other embodiments, the dopant is a metal oxide of Y. In some other embodiments, the dopant is a metal oxide of Zr. In some other embodiments, the dopant is a metal oxide of Nb. In some other embodiments, the dopant is a metal oxide of Ba. In some other embodiments, the dopant is a metal oxide of Hf. In some other embodiments, the dopant is a cation of Li. In some other embodiments, the dopant is a cation of Mg. In some other embodiments, the dopant is a cation of Al. In some other embodiments, the dopant is a cation of Si. In some other embodiments, the dopant is a cation of Ca. In some other embodiments, the dopant is a cation of Ti. In some other embodiments, the dopant is a cation of V. In some other embodiments, the dopant is a cation of Cr. In some other embodiments, the dopant is a cation of Mn. In some other embodiments, the dopant is a cation of Fe. In some other embodiments, the dopant is a cation of Co. In some other embodiments, the dopant is a cation of Ni. In some other embodiments, the dopant is a cation of Cu. In some other embodiments, the dopant is a cation of Zn. In some other embodiments, the dopant is a cation of Y. In some other embodiments, the dopant is a cation of Zr. In some other embodiments, the dopant is a cation of Nb. In some other embodiments, the dopant is a cation of Ba. In some other embodiments, the dopant is a cation of Hf. In some other embodiments, the dopant is a fluoride of Li. In some other embodiments, the dopant is a fluoride of Mg. In some other embodiments, the dopant is a fluoride of Al. In some other embodiments, the dopant is a fluoride of Si. In some other embodiments, the dopant is a fluoride of Ca. In some other embodiments, the dopant is a fluoride of Ti. In some other embodiments, the dopant is a fluoride of V. In some other embodiments, the dopant is a fluoride of Cr. In some other embodiments, the dopant is a fluoride of Mn. In some other embodiments, the dopant is a fluoride of Fe. In some other embodiments, the dopant is a fluoride of Co. In some other embodiments, the dopant is a fluoride of Ni. In some other embodiments, the dopant is a fluoride of Cu. In some other embodiments, the dopant is a fluoride of Zn. In some other embodiments, the dopant is a fluoride of Y. In some other embodiments, the dopant is a fluoride of Zr. In some other embodiments, the dopant is a fluoride of Nb. In some other embodiments, the dopant is a fluoride of Ba. In some other embodiments, the dopant is a fluoride of Hf

In some embodiments, the MF is doped with a dopant including Li₂O, Cu, CuF₂, NiF₂, ZrF₄, CaF₂, or AlF₃. In some embodiments, the dopant is Li₂O. In other embodiments, the dopant is CuF₂. In some other embodiments, the dopant is NiF₂. In some other embodiments, the dopant is ZrF₄. In some other embodiments, the dopant is CaF₂. In some other embodiments, the dopant is AlF₃.

As used herein, the dopant may be present in the MF an amount from about 0.1 to 10 atomic %.

In some embodiments, the MF is LiF and can further comprise a nanodimensioned metal including Fe, Co, Mn, Cu, Ni, Zr, or combinations thereof. In some embodiments, the nanodimensioned metal is Fe. In other embodiments, the nanodimensioned metal is Co. In some other embodiments, the nanodimensioned metal is Mn. In some other embodiments, the nanodimensioned metal is Cu. In some other embodiments, the nanodimensioned metal is Ni. In some other embodiments, the nanodimensioned metal is Zr.

The catholyte can include any suitable ion conductor. Suitable catholytes can include, but are not limited to, LSS, LXPS, LXPSO, Li-stuffed garnet, where X is Si, Ge, Sn, As, Al, or combinations thereof. In some embodiments, the catholyte is LSS. In other embodiments, the catholyte is LXPS where X is Si, Ge, Sn, As, Al, or combinations thereof. In some other embodiments, the catholyte is LXPS where X is Si. In some other embodiments, the catholyte is LXPS where X is Ge. In some other embodiments, the catholyte is LXPS where X is Si and Sn. In some other embodiments, the catholyte is LXPS where X is Sn. In some other embodiments, the catholyte is LXPS where X is Al. In some embodiments, the catholyte is LXPSO where X is Si, Ge, Sn, Al, or combinations thereof. In some other embodiments, the catholyte is LXPSO where X is Si. In some other embodiments, the catholyte is LXPSO where X is Ge. In some other embodiments, the catholyte is LXPSO where X is Si and Sn. In some other embodiments, the catholyte is LXPSO where X is Sn. In some embodiments, the catholyte is LATS. In some other embodiments, the catholyte is LXPSO where X is Al. In some other embodiments, the catholyte is LXPSO where X is a combination of Si and Sn. In some embodiments, the catholyte is Li-stuffed garnet.

In some embodiments, the catholyte includes LXPS and is substantially free of oxygen, where X is Si, Ge, Sn, As, Al, or combinations thereof. In some embodiments, the catholyte is LXPS and is substantially free of oxygen, where X is Si. In other embodiments, the catholyte is LXPS and is substantially free of oxygen, where X is Ge. In some other embodiments, the catholyte is LXPS and is substantially free of oxygen, where X is Sn. In some other embodiments, the catholyte is LXPS and is substantially free of oxygen, where X is Al.

In some embodiments, the catholyte includes LXPS and has an oxygen content between about 0 and 10 atomic %, where X is Si, Ge, Sn, As, Al, or combinations thereof. In some embodiments, the catholyte includes LXPS and has an oxygen content of about 1, 2, 3, 4, 5, 6, 7, 8, 9, or about 10 atomic %, where X is Si, Ge, Sn, As, Al, or combinations thereof. In some embodiments, the catholyte includes LXPS and has an oxygen content of about 1, 2, 3, 4, 5, 6, 7, 8, 9, or about 10 atomic %, where X is Si. In other embodiments, the catholyte includes LXPS and has an oxygen content of about 1, 2, 3, 4, 5, 6, 7, 8, 9, or about 10 atomic %, where X is Ge. In some other embodiments, the catholyte includes LXPS and has an oxygen content of about 1, 2, 3, 4, 5, 6, 7, 8, 9, or about 10 atomic %, where X is Sn. In some other embodiments, the catholyte includes LXPS and has an oxygen content of about 1, 2, 3, 4, 5, 6, 7, 8, 9, or about 10 atomic %, where X is As. In some other embodiments, the catholyte includes LXPS and has an oxygen content of about 1, 2, 3, 4, 5, 6, 7, 8, 9, or about 10 atomic %, where Xis Al. In some other embodiments, the catholyte includes LXPS and has an oxygen content of about 1, 2, 3, 4, 5, 6, 7, 8, 9, or about 10 atomic %, where Xis a combination of two or more of Si, Ge, Sn, As, and Al.

In other embodiments, the catholyte is a Li-stuffed garnet or Li₂B₄O₇. In some other embodiments, the catholyte is Li₂B₄O₇. In some other embodiments, the catholyte is a Li-stuffed garnet. In some embodiments, the positive electrode film does not include a catholyte.

In some embodiments, the film is heated to a temperature of about 305 to 395° C. In other embodiments, the film is heated to a temperature of about 310 to 390° C. In some other embodiments, the film is heated to a temperature of about 315 to 385° C. In some other embodiments, the film is heated to a temperature of about 320 to 380° C. In some other embodiments, the film is heated to a temperature of about 325 to 375° C. In some other embodiments, the film is heated to a temperature of about 330 to 370° C. In some other embodiments, the film is heated to a temperature of about 335 to 365° C. In some other embodiments, the film is heated to a temperature of about 340 to 360° C. In some other embodiments, the film is heated to a temperature of about 345 to 355° C.

In some embodiments, the film is heated to a temperature of about 300° C. In other embodiments, the film is heated to a temperature of about 310° C. In some other embodiments, the film is heated to a temperature of about 320° C. In some other embodiments, the film is heated to a temperature of about 330° C. In some other embodiments, the film is heated to a temperature of about 340° C. In some other embodiments, the film is heated to a temperature of about 350° C. In some other embodiments, the film is heated to a temperature of about 360° C. In some other embodiments, the film is heated to a temperature of about 370° C. In some other embodiments, the film is heated to a temperature of about 380° C. In some other embodiments, the film is heated to a temperature of about 390° C. In some other embodiments, the film is heated to a temperature of about 400° C. In some embodiments, the film is heated to a temperature of about 80° C. to 150° C. In other embodiments, the film is heated to a temperature of about 100° C. to 150° C.

In some embodiments, the pressure applied to the film is about 1 to 20,000 PSI. In other embodiments, the pressure applied to the film is about 1 to 10,000 PSI. In some other embodiments, the pressured applied to the film is about 1 to 100 PSI. In some other embodiments, the pressure applied to the film is about 1 to 10,000 PSI. In some other embodiments, the pressure applied to the film is about 10 to 90 PSI. In some other embodiments, the pressure applied to the film is about 20 to 80 PSI. In some other embodiments, the applied to the film is about 30 to 70 PSI. In some other embodiments, the pressure applied to the film is about 40 to 60 PSI. In some other embodiments, the pressure applied to the film is about 50 to 100 PSI. In some other embodiments, the pressure applied to the film is about 60 to 100 PSI. In some other embodiments, the pressure applied to the film is about 70 to 100 PSI. In some other embodiments, the pressure applied to the film is about 80 to 100 PSI. In some other embodiments, the pressure applied to the film is about 1,000 to 100 PSI. In some other embodiments, the pressure applied to the film is about 2,000 PSI. In some other embodiments, the pressure applied to the film is about 3,000 PSI. In some other embodiments, the pressure applied to the film is about 4,000 PSI. In some other embodiments, the pressure applied to the film is about 5,000 PSI. In some other embodiments, the pressure applied to the film is about 6,000 PSI. In some other embodiments, the pressure applied to the film is about 7,000 PSI. In some other embodiments, the pressure applied to the film is about 8,000 PSI. In some other embodiments, the pressure applied to the film is about 9,000 PSI. In some other embodiments, the pressure applied to the film is about 10,000 PSI. In some other embodiments, the pressure applied to the film is about 15,000 PSI. In some other embodiments, the pressure applied to the film is about 20,000 PSI. In some embodiments, the pressure is applied in a calendering device that applies the heat and the pressure simultaneously.

The heating and pressure can be provided by one or more suitable devices configured to apply pressure to the combination and to transfer thermal energy to the combination. In some embodiments, heat and/or pressure are provided by a calendering device, a sintering device (e.g., a hot pressing device, a field assisted sinter technique (FAST) device, a spark plasma sintering (SPS) devices, etc.), or combinations thereof.

### VII. POSITIVE ELECTRODE FILMS WITH ANNEALED MEIC/MF COMPOSITE PARTICLES

The disclosure set forth herein further provides a Li-secondary battery positive electrode films including annealed composite particles, a catholyte, and a binder. The annealed composite particles can comprise a mixed electronic ionic a mixed electronic ionic conductor (MEIC) selected from metal oxides, metal sulfides, metal halides, metal oxyhalides, and combinations thereof, a metal fluoride (MF), and an optional electrically conductive additive comprising carbon. The catholyte and binder can contact the annealed composite particle outer surfaces without being contained therein.

The annealed composite particles can further comprise an additional chemical component that forms as a result of annealing the composite particles. In some embodiments, the annealed composite particles further comprise metal oxyfluoride or a metal oxide fluoride. For example, in some embodiments, the annealed composite particles further comprise iron oxyfluoride, iron oxide fluoride, copper oxyfluoride, copper oxide fluoride, nickel oxyfluoride, nickel oxide fluoride, cobalt oxyfluoride, cobalt oxide fluoride, or combinations thereof. In some embodiments, the annealed composite particles further comprise an oxide of two or more transition metals. For example, in some embodiments, the annealed composite particles further comprise iron molybdenum oxide, iron oxide:molybdenum oxide mixture, iron molybdenum oxyfluoride, or iron molybdenum oxide fluoride. As another example, in some embodiments, the annealed composite particles further comprise copper molybdenum oxide, copper oxide:molybdenum oxide mixture, copper molybdenum oxyfluoride, or copper molybdenum oxide fluoride.

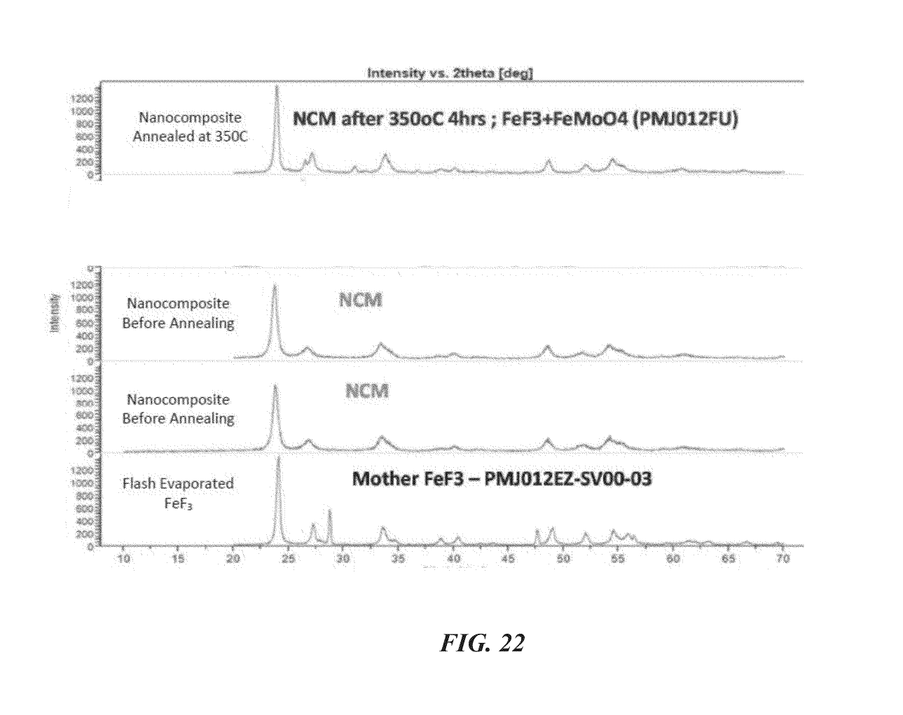

In some embodiments, the annealed composites are characterized by the x-ray diffraction (XRD) peaks substantially as shown in FIG. 22. In some embodiments, the annealed composite particles are characterized by CuKα XRD peaks at one or more of 2θ=26°±1°, 27°±1°, 28°±1°, 29°±1°, 32°±1°, 34°±1°, 35°±1°, 49°±1°, 52.5°±1°, and 55°±1°. In some embodiments, the annealed composite particles are characterized by a CuKα XRD peak at 2θ=26°±1°. In some embodiments, the annealed composite particles are characterized by a CuKα XRD peak at 2θ=27°±1°. In some embodiments, the annealed composite particles are characterized by a CuKα XRD peak at 2θ=28°±1°. In some embodiments, the annealed composite particles are characterized by a CuKα XRD peak at 2θ=29°±1°. In some embodiments, the annealed composite particles are characterized by a CuKα XRD peak at 2θ=32°±1°. In some embodiments, the annealed composite particles are characterized by a CuKα XRD peak at 2θ=34°±1°. In some embodiments, the annealed composite particles are characterized by a CuKα XRD peak at 2θ=35°±1°. 49°±1°. In some embodiments, the annealed composite particles are characterized by a CuKα XRD peak at 2θ=52.5°±1°. In some embodiments, the annealed composite particles are characterized by a CuKα XRD peak at 2θ=55°±1°.

The MEIC included in the annealed composite particles can be any suitable material that conducts both ions and electrons. Suitable MEICs can include, but are not limited to, MoO₃₋ₓ where 0≦x≦1, MoOF₄, FeMoO₂, FeMoO₄, MoS₂, MoS, VO_{y} where 1≦y≦2.5, LiV₃O₈, LiV₃O₆, VOF₃, fluorinated vanadium oxide, fluorinated molybdenum oxide, and MoOF. In some embodiments, the MEIC is MoO₃, where 0≦x≦1. In other embodiments, the MEIC is MoOF₄. In some other embodiments, the MEIC is FeMoO₂. In some other embodiments, the MEIC is FeMoO₄. In some other embodiments, the MEIC is MoS₂. In some other embodiments, the MEIC is MoS. In some other embodiments, the MEIC is VO_{y} where 1≦y≦2.5. In some other embodiments, the MEIC is LiV₃O₈. In some other embodiments, the MEIC is LiV₃O₆. In some other embodiments, the MEIC is VOF₃. In some other embodiments, the MEIC is fluorinated vanadium oxide. In some other embodiments, the MEIC is fluorinated molybdenum oxide. In some other embodiments, the MEIC is and MoOF.

The MEIC can comprise any suitable volume percentage of the annealed composite particles. In some embodiments, the volume percent of the MEIC in the annealed composite particles is about 30% (v/v) or less. In other embodiments, the volume percent of the MEIC in the annealed composite particles is about 27% (v/v) or less. In some other embodiments, the volume percent of the MEIC in the annealed composite particles is about 24% (v/v) or less. In some other embodiments, the volume percent of the MEIC in the annealed composite particles is about 21% (v/v) or less. In some other embodiments, the volume percent of the MEIC in the annealed composite particles is about 18% (v/v) or less. In some other embodiments, the volume percent of the MEIC in the annealed composite particles is about 15% (v/v) or less. In some other embodiments, the volume percent of the MEIC in the annealed composite particles is about 14% (v/v) or less. In some other embodiments, the volume percent of the MEIC in the annealed composite particles is about 13% (v/v) or less. In some other embodiments, the volume percent of the MEIC in the annealed composite particles is about 12% (v/v) or less. In some other embodiments, the volume percent of the MEIC in the annealed composite particles is about 11% (v/v) or less. In some other embodiments, the volume percent of the MEIC in the annealed composite particles is about 10% (v/v) or less. In some other embodiments, the volume percent of the MEIC in the annealed composite particles is about 9% (v/v) or less. In some other embodiments, the volume percent of the MEIC in the annealed composite particles is about 8% (v/v) or less. In some other embodiments, the volume percent of the MEIC in the annealed composite particles is about 7% (v/v) or less. In some other embodiments, the volume percent of the MEIC in the annealed composite particles is about 6% (v/v) or less. In some other embodiments, the volume percent of the MEIC in the annealed composite particles is about 5% (v/v) or less.

In some embodiments, the MEIC and MF are nanodimensioned. In some embodiments, the MEIC and MF are nanodimensioned and substantially homogenous within a volume of 100 nm³.

The MEIC can be characterized by any suitable size. In some embodiments, the MEIC is characterized by a median diameter (d₅₀) of about 300 nm or less. In other embodiments, the MEIC is characterized by a median diameter (d₅₀) of about 280 nm or less. In some other embodiments, the MEIC is characterized by a median diameter (d₅₀) of about 260 nm or less. In some other embodiments, the MEIC is characterized by a median diameter (d₅₀) of about 240 nm or less. In some other embodiments, the MEIC is characterized by a median diameter (d₅₀) of about 220 nm or less. In some other embodiments, the MEIC is characterized by a median diameter (d₅₀) of about 200 nm or less. In some other embodiments, the MEIC is characterized by a median diameter (d₅₀) of about 180 nm or less. In some other embodiments, the MEIC is characterized by a median diameter (d₅₀) of about 160 nm or less. In some other embodiments, the MEIC is characterized by a median diameter (d₅₀) of about 140 nm or less. In some other embodiments, the MEIC is characterized by a median diameter (d₅₀) of about 120 nm or less. In some other embodiments, the MEIC is characterized by a median diameter (d₅₀) of about 100 nm or less. In some other embodiments, the MEIC is characterized by a median diameter (d₅₀) of about 80 nm or less.

The annealed composite particles can have any suitable size. In some embodiments, the annealed composite particles have a characteristic dimension of about 300 nm to 10 μm. In other embodiments, the annealed composite particles have a characteristic dimension of about 400 nm to 9 μm. In some other embodiments, the annealed composite particles have a characteristic dimension of about 500 nm to 8 μm. In some other embodiments, the annealed composite particles have a characteristic dimension of about 600 nm to 7 μm. In some other embodiments, the annealed composite particles have a characteristic dimension of about 700 nm to 6 μm. In some other embodiments, the annealed composite particles have a characteristic dimension of about 800 nm to 5 μm. In some other embodiments, the annealed composite particles have a characteristic dimension of about 900 nm to 4 μm. In some other embodiments, the annealed composite particles have a characteristic dimension of about 1 to 3 μm.

In some embodiments, the annealed composite particles are characterized by a median diameter (d₅₀) of about 0.1 to 15 μm. In other embodiments, the annealed composite particles are characterized by a median diameter (d₅₀) of about 0.5 to 14 μm. In some other embodiments, the annealed composite particles are characterized by a median diameter (d₅₀) of about 1 to 13 μm. In some other embodiments, the annealed composite particles are characterized by a median diameter (d₅₀) of about 1 to 12 μm. In some other embodiments, the annealed composite particles are characterized by a median diameter (d₅₀) of about 1 to 11 μm. In some other embodiments, the annealed composite particles are characterized by a median diameter (d₅₀) of about 1 to 10 μm. In some other embodiments, the annealed composite particles are characterized by a median diameter (d₅₀) of about 1 to 9 μm. In some other embodiments, the annealed composite particles are characterized by a median diameter (d₅₀) of about 2 to 8 μm. In some other embodiments, the annealed composite particles are characterized by a median diameter (d₅₀) of about 3 to 7 μm.

In some embodiments, the annealed composite particles are micron sized and have a median physical dimension of about the thickness of the film in which the annealed composite particles are located.

In some embodiments, the MEIC has a charge and/or discharge voltage window that overlaps that of the MF. In some embodiments, the MEIC has a discharge voltage of between about 3 to 3.5 V v. Li. In other embodiments, the MEIC has a discharge voltage of between about 2.9 to 3.4 V v. Li. In some other embodiments, the MEIC has a discharge voltage of between about 2.8 to 3.3 V v. Li. In some other embodiments, the MEIC has a discharge voltage of between about 2.7 to 3.2 V v. Li. In some other embodiments, the MEIC has a discharge voltage of between about 2.6 to 3.1 V v. Li. In some other embodiments, the MEIC has a discharge voltage of between about 2.5 to 3 V v. Li. In some other embodiments, the MEIC has a discharge voltage of between about 2.4 to 2.9 V v. Li. In some other embodiments, the MEIC has a discharge voltage of between about 2.3 to 2.8 V v. Li. In some other embodiments, the MEIC has a discharge voltage of between about 2.2 to 2.7 V v. Li. In some other embodiments, the MEIC has a discharge voltage of between about 2.1 to 2.6 V v. Li. In some other embodiments, the MEIC has a discharge voltage of between about 2 to 2.5 V v. Li. In some other embodiments, the MEIC has a discharge voltage of between about 3.1 to 3.6 V v. Li. In some other embodiments, the MEIC has a discharge voltage of between about 3.2 to 3.7 V v. Li. In some other embodiments, the MEIC has a discharge voltage of between about 3.3 to 3.8 V v. Li. In some other embodiments, the MEIC has a discharge voltage of between about 3.4 to 3.9 V v. Li. In some other embodiments, the MEIC has a discharge voltage of between about 3.5 to 4 V v. Li. In some other embodiments, the MEIC has a discharge voltage of between about 3.6 to 4.1 V v. Li. In some other embodiments, the MEIC has a discharge voltage of between about 3.7 to 4.2 V v. Li. In some other embodiments, the MEIC has a discharge voltage of between about 3.8 to 4.3 V v. Li. In some other embodiments, the MEIC has a discharge voltage of between about 3.9 to 4.4 V v. Li. In some other embodiments, the MEIC has a discharge voltage of between about 4.0 to 4.5 V v. Li. In some embodiments, the MEIC has a discharge voltage of between about 1.8 to 4 V v. Li.

The MF included in the annealed composite particles can be a material including a metal component and a fluorine (F) component and optionally including a lithium (Li) component such that the MF is present in the “charged state” and converts to a metal and lithium fluoride during discharge of the battery. Suitable MFs include, but are not limited to, LiF, Li_{z}FeF₃, Li_{z}CuF₂, Li_{z}NiF₂, Li_{z}NiF_{2.5}, Li_{z}NiF₃, Li_{z}CoF₂, Li_{z}CoF₃, Li_{z}MnF₂, and Li_{z}MnF₃, where 0≦z≦3. In some embodiments, the MF is LiF. In other embodiments, the MF is Li_{z}FeF₃ where 0≦z≦3. In some other embodiments, the MF is Li_{z}CuF₂ where 0≦z≦3. In some other embodiments, the MF is Li_{z}NiF₂ 0≦z≦3. In some other embodiments, the MF is Li_{z}NiF_{2.5} where 0≦z≦3. In some other embodiments, the MF is Li_{z}NiF₃ 0≦z≦3. In some other embodiments, the MF is Li_{z}CoF₂ 0≦z≦3. In some other embodiments, the MF is Li_{z}CoF₃ 0≦z≦3. In some other embodiments, the MF is Li_{z}MnF₂ 0≦z≦3. In some other embodiments, the MF is Li_{z}MnF₃, where 0≦z≦3.

In some embodiments, the MF is Li_{d}MF_{g} where d and g are, independently in each instance, selected from the range of 0 to 3, and where M is a metal selected from Fe, Cu, Ni, Co, Mn, alloys thereof, and combinations thereof.

The MF can have any suitable size. In some embodiments, the MF is nanodimensioned. In some embodiments, the MF is in the form of nanodomains. In some embodiments, the MF can be characterized by a median diameter (d₅₀) of about 5 nm to 5 μm. In other embodiments, the MF can be characterized by a median diameter (d₅₀) of about 100 nm to 4.8 μm. In some other embodiments, the MF can be characterized by a median diameter (d₅₀) of about 200 nm to 4.6 μm. In some other embodiments, the MF can be characterized by a median diameter (d₅₀) of about 300 nm to 4.4 μm. In some other embodiments, the MF can be characterized by a median diameter (d₅₀) of about 400 nm to 4.2 μm. In some other embodiments, the MF can be characterized by a median diameter (d₅₀) of about 500 nm to 4 μm. In some other embodiments, the MF can be characterized by a median diameter (d₅₀) of about 600 nm to 3.8 μm. In some other embodiments, the MF can be characterized by a median diameter (d₅₀) of about 700 nm to 3.6 μm. In some other embodiments, the MF can be characterized by a median diameter (d₅₀) of about 800 nm to 3.4 μm. In some other embodiments, the MF can be characterized by a median diameter (d₅₀) of about 900 nm to 3.2 μm. In some other embodiments, the MF can be characterized by a median diameter (d₅₀) of about 1 to 3 μm.

In some embodiments, the MF can comprise atomized particles having a variety of sizes. In some embodiments, the MF comprises atomized MF particles characterized by a median grain size (d₅₀) of about 1-5 nm, 1-10 nm, or 5-10 nm. In some examples, the MF particles have a d₅₀ particle size of 1, 1.5, 2, 2.5, 3, 3.5, 4, 4.5, 5, 5.5, 6, 6.5, 7, 7.5, 8, 8.5, 9, 9.5, 10, 10.5, 20, 20.5, 30, 30.5, 40, 40.5, 50, 50.5, 60, 60.5, 70, 70.5, 80, 80.5, 90, 90.5, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000 nm. In some examples, the MF particles have a d₅₀ particle size of 1. In some examples, the MF particles have a d₅₀ particle size of 1.5 In some examples, the MF particles have a d₅₀ particle size of 2 nm. In some examples, the MF particles have a d₅₀ particle size of 2.5 nm. In some examples, the MF particles have a d₅₀ particle size of 3 nm. In some examples, the MF particles have a d₅₀ particle size of 3.5 nm. In some examples, the MF particles have a d₅₀ particle size of 4 nm. In some examples, the MF particles have a d₅₀ particle size of 4.5 nm. In some examples, the MF particles have a d₅₀ particle size of 5 nm. In some examples, the MF particles have a d₅₀ particle size of 5.5 nm. In some examples, the MF particles have a d₅₀ particle size of 6 nm. In some examples, the MF particles have a d₅₀ particle size of 6.5 nm. In some examples, the MF particles have a d₅₀ particle size of 7 nm. In some examples, the MF particles have a d₅₀ particle size of 7.5 nm. In some examples, the MF particles have a d₅₀ particle size of 8 nm. In some examples, the MF particles have a d₅₀ particle size of 8.5 nm. In some examples, the MF particles have a d₅₀ particle size of 9 nm. In some examples, the MF particles have a d₅₀ particle size of 9.5 nm. In some examples, the MF particles have a d₅₀ particle size of 10 nm. In some examples, the MF particles have a d₅₀ particle size of 10.5 nm. In some examples, the MF particles have a d₅₀ particle size of 20 nm. In some examples, the MF particles have a d₅₀ particle size of 20.5 nm. In some examples, the MF particles have a d₅₀ particle size of 30 nm. In some examples, the MF particles have a d₅₀ particle size of 30.5 nm. In some examples, the MF particles have a d₅₀ particle size of 40 nm. In some examples, the MF particles have a d₅₀ particle size of 40.5 nm. In some examples, the MF particles have a d₅₀ particle size of 50 nm. In some examples, the MF particles have a d₅₀ particle size of 50.5 nm. In some examples, the MF particles have a d₅₀ particle size of 60 nm. In some examples, the MF particles have a d₅₀ particle size of 60.5 nm. In some examples, the MF particles have a d₅₀ particle size of 70 nm. In some examples, the MF particles have a d₅₀ particle size of 70.5 nm. In some examples, the MF particles have a d₅₀ particle size of 80 nm. In some examples, the MF particles have a d₅₀ particle size of 80.5 nm. In some examples, the MF particles have a d₅₀ particle size of 90 nm. In some examples, the MF particles have a d₅₀ particle size of 90.5 nm. In some examples, the MF particles have a d₅₀ particle size of 100 nm. In some examples, the MF particles have a d₅₀ particle size of 110 nm. In some examples, the MF particles have a d₅₀ particle size of 120 nm. In some examples, the MF particles have a d₅₀ particle size of 130 nm. In some examples, the MF particles have a d₅₀ particle size of 140 nm. In some examples, the MF particles have a d₅₀ particle size of 150 nm. In some examples, the MF particles have a d₅₀ particle size of 160 nm. In some examples, the MF particles have a d₅₀ particle size of 170 nm. In some examples, the MF particles have a d₅₀ particle size of 180 nm. In some examples, the MF particles have a d₅₀ particle size of 190 nm. In some examples, the MF particles have a d₅₀ particle size of 200 nm. In some examples, the MF particles have a d₅₀ particle size of 210 nm. In some examples, the MF particles have a d₅₀ particle size of 220 nm. In some examples, the MF particles have a d₅₀ particle size of 230 nm. In some examples, the MF particles have a d₅₀ particle size of 240 nm. In some examples, the MF particles have a d₅₀ particle size of 250 nm. In some examples, the MF particles have a d₅₀ particle size of 260 nm. In some examples, the MF particles have a d₅₀ particle size of 270 nm. In some examples, the MF particles have a d₅₀ particle size of 280 nm. In some examples, the MF particles have a d₅₀ particle size of 290 nm. In some examples, the MF particles have a d₅₀ particle size of 300 nm. In some examples, the MF particles have a d₅₀ particle size of 310 nm. In some examples, the MF particles have a d₅₀ particle size of 320 nm. In some examples, the MF particles have a d₅₀ particle size of 330 nm. In some examples, the MF particles have a d₅₀ particle size of 340 nm. In some examples, the MF particles have a d₅₀ particle size of 350 nm. In some examples, the MF particles have a d₅₀ particle size of 360 nm. In some examples, the MF particles have a d₅₀ particle size of 370 nm. In some examples, the MF particles have a d₅₀ particle size of 380 nm. In some examples, the MF particles have a d₅₀ particle size of 390 nm. In some examples, the MF particles have a d₅₀ particle size of 400 nm. In some examples, the MF particles have a d₅₀ particle size of 510 nm. In some examples, the MF particles have a d₅₀ particle size of 520 nm. In some examples, the MF particles have a d₅₀ particle size of 530 nm. In some examples, the MF particles have a d₅₀ particle size of 540 nm. In some examples, the MF particles have a d₅₀ particle size of 550 nm. In some examples, the MF particles have a d₅₀ particle size of 560 nm. In some examples, the MF particles have a d₅₀ particle size of 570 nm. In some examples, the MF particles have a d₅₀ particle size of 580 nm. In some examples, the MF particles have a d₅₀ particle size of 590 nm. In some examples, the MF particles have a d₅₀ particle size of 600 nm. In some examples, the MF particles have a d₅₀ particle size of 610 nm. In some examples, the MF particles have a d₅₀ particle size of 620 nm. In some examples, the MF particles have a d₅₀ particle size of 630 nm. In some examples, the MF particles have a d₅₀ particle size of 640 nm. In some examples, the MF particles have a d₅₀ particle size of 650 nm. In some examples, the MF particles have a d₅₀ particle size of 660 nm. In some examples, the MF particles have a d₅₀ particle size of 670 nm. In some examples, the MF particles have a d₅₀ particle size of 680 nm. In some examples, the MF particles have a d₅₀ particle size of 690 nm. In some examples, the MF particles have a d₅₀ particle size of 700 nm. In some examples, the MF particles have a d₅₀ particle size of 710 nm. In some examples, the MF particles have a d₅₀ particle size of 720 nm. In some examples, the MF particles have a d₅₀ particle size of 730 nm. In some examples, the MF particles have a d₅₀ particle size of 740 nm. In some examples, the MF particles have a d₅₀ particle size of 750 nm. In some examples, the MF particles have a d₅₀ particle size of 760 nm. In some examples, the MF particles have a d₅₀ particle size of 770 nm. In some examples, the MF particles have a d₅₀ particle size of 780 nm. In some examples, the MF particles have a d₅₀ particle size of 790 nm. In some examples, the MF particles have a d₅₀ particle size of 800 nm. In some examples, the MF particles have a d₅₀ particle size of 810 nm. In some examples, the MF particles have a dₘ) particle size of 820 nm. In some examples, the MF particles have a d₅₀ particle size of 830 nm. In some examples, the MF particles have a d₅₀ particle size of 840 nm. In some examples, the MF particles have a d₅₀ particle size of 850 nm. In some examples, the MF particles have a d₅₀ particle size of 860 nm. In some examples, the MF particles have a d₅₀ particle size of 870 nm. In some examples, the MF particles have a d₅₀ particle size of 880 nm. In some examples, the MF particles have a d₅₀ particle size of 890 nm. In some examples, the MF particles have a d₅₀ particle size of 900 nm. In some examples, the MF particles have a d₅₀ particle size of 910 nm. In some examples, the MF particles have a d₅₀ particle size of 920 nm. In some examples, the MF particles have a d₅₀ particle size of 930 nm. In some examples, the MF particles have a d₅₀ particle size of 940 nm. In some examples, the MF particles have a d₅₀ particle size of 950 nm. In some examples, the MF particles have a d₅₀ particle size of 960 nm. In some examples, the MF particles have a d₅₀ particle size of 970 nm. In some examples, the MF particles have a d₅₀ particle size of 980 nm. In some examples, the MF particles have a d₅₀ particle size of 990 nm. In some examples, the MF particles have a d₅₀ particle size of 1000 nm.

In some embodiments, the MF is doped with a dopant including oxygen, carbon, a metal selected from Li, Mg, Al, Si, Ca, Ti, V, Cr, Mn, Mo, Fe, Co, Ni, Cu, Zn, Y, Zr, Nb, Ba, and Hf, a metal oxide of said metal, a cation of said metal, a metal fluoride of said metal, or combinations thereof. In some embodiments, the dopant is Li. In other embodiments, the dopant is Mg. In some other embodiments, the dopant is Al. In some other embodiments, the dopant is Si. In some other embodiments, the dopant is Ca. In some other embodiments, the dopant is Ti. In some other embodiments, the dopant is V. In some other embodiments, the dopant is Cr. In some other embodiments, the dopant is Mn. In some other embodiments, the dopant is Mo. In some other embodiments, the dopant is Fe. In some other embodiments, the dopant is Co. In some other embodiments, the dopant is Ni. In some other embodiments, the dopant is Cu. In some other embodiments, the dopant is Zn. In some other embodiments, the dopant is Y. In some other embodiments, the dopant is Zr. In some other embodiments, the dopant is Nb. In some other embodiments, the dopant is Ba. In some other embodiments, the dopant is Hf. In some other embodiments, the dopant is a metal oxide of Li (e.g., Li₂O). In some other embodiments, the dopant is Hf. In some other embodiments, the dopant is a metal oxide of Mg. In some other embodiments, the dopant is a metal oxide of Al. In some other embodiments, the dopant is a metal oxide of Si. In some other embodiments, the dopant is a metal oxide of Ca. In some other embodiments, the dopant is a metal oxide of Ti. In some other embodiments, the dopant is a metal oxide of V. In some other embodiments, the dopant is a metal oxide of Cr. In some other embodiments, the dopant is a metal oxide of Mn. In some other embodiments, the dopant is a metal oxide of Fe. In some other embodiments, the dopant is a metal oxide of Co. In some other embodiments, the dopant is a metal oxide of Ni. In some other embodiments, the dopant is a metal oxide of Cu. In some other embodiments, the dopant is a metal oxide of Zn. In some other embodiments, the dopant is a metal oxide of Y. In some other embodiments, the dopant is a metal oxide of Zr. In some other embodiments, the dopant is a metal oxide of Nb. In some other embodiments, the dopant is a metal oxide of Ba. In some other embodiments, the dopant is a metal oxide of Hf. In some other embodiments, the dopant is a cation of Li. In some other embodiments, the dopant is a cation of Mg. In some other embodiments, the dopant is a cation of Al. In some other embodiments, the dopant is a cation of Si. In some other embodiments, the dopant is a cation of Ca. In some other embodiments, the dopant is a cation of Ti. In some other embodiments, the dopant is a cation of V. In some other embodiments, the dopant is a cation of Cr. In some other embodiments, the dopant is a cation of Mn. In some other embodiments, the dopant is a cation of Fe. In some other embodiments, the dopant is a cation of Co. In some other embodiments, the dopant is a cation of Ni. In some other embodiments, the dopant is a cation of Cu. In some other embodiments, the dopant is a cation of Zn. In some other embodiments, the dopant is a cation of Y. In some other embodiments, the dopant is a cation of Zr. In some other embodiments, the dopant is a cation of Nb. In some other embodiments, the dopant is a cation of Ba. In some other embodiments, the dopant is a cation of Hf. In some other embodiments, the dopant is a fluoride of Li. In some other embodiments, the dopant is a fluoride of Mg. In some other embodiments, the dopant is a fluoride of Al. In some other embodiments, the dopant is a fluoride of Si. In some other embodiments, the dopant is a fluoride of Ca. In some other embodiments, the dopant is a fluoride of Ti. In some other embodiments, the dopant is a fluoride of V. In some other embodiments, the dopant is a fluoride of Cr. In some other embodiments, the dopant is a fluoride of Mn. In some other embodiments, the dopant is a fluoride of Fe. In some other embodiments, the dopant is a fluoride of Co. In some other embodiments, the dopant is a fluoride of Ni. In some other embodiments, the dopant is a fluoride of Cu. In some other embodiments, the dopant is a fluoride of Zn. In some other embodiments, the dopant is a fluoride of Y. In some other embodiments, the dopant is a fluoride of Zr. In some other embodiments, the dopant is a fluoride of Nb. In some other embodiments, the dopant is a fluoride of Ba. In some other embodiments, the dopant is a fluoride of Hf

In some embodiments, the MF is doped with a dopant including Li₂O, Cu, CuF₂, NiF₂, ZrF₄, CaF₂, or AlF₃. In some embodiments, the dopant is Li₂O. In other embodiments, the dopant is CuF₂. In some other embodiments, the dopant is NiF₂. In some other embodiments, the dopant is ZrF₄. In some other embodiments, the dopant is CaF₂. In some other embodiments, the dopant is AlF₃.

As used herein, the dopant may be present in the MF an amount from about 0.1 to 10 atomic %.

In some embodiments, the MF is LiF and can further comprise a nanodimensioned metal including Fe, Co, Mn, Cu, Ni, Zr, or combinations thereof. In some embodiments, the nanodimensioned metal is Fe. In other embodiments, the nanodimensioned metal is Co. In some other embodiments, the nanodimensioned metal is Mn. In some other embodiments, the nanodimensioned metal is Cu. In some other embodiments, the nanodimensioned metal is Ni. In some other embodiments, the nanodimensioned metal is Zr.

The annealed composite particles can have any suitable weight ratio of MEIC to MF. In some embodiments, the weight ratio of MEIC to MF in the annealed composite particles is between about 8:92 to 17:83 w/w. In some other embodiments, the weight ratio of MEIC to MF in the annealed composite particles is between about 1:99 to 15:85 w/w. In some other embodiments, the weight ratio of MEIC to MF in the annealed composite particles is 3:97 w/w. In some other embodiments, the weight ratio of MEIC to MF in the annealed composite particles is 1:99 w/w. In some other embodiments, the weight ratio of MEIC to MF in the annealed composite particles is 2:98 w/w. In some other embodiments, the weight ratio of MEIC to MF in the annealed composite particles is 3:97 w/w. In some other embodiments, the weight ratio of MEIC to MF in the annealed composite particles is 4:96 w/w. In some other embodiments, the weight ratio of MEIC to MF in the annealed composite particles is 5:95 w/w. In some other embodiments, the weight ratio of MEIC to MF in the annealed composite particles is 6:94 w/w. In some other embodiments, the weight ratio of MEIC to MF in the annealed composite particles is 7:93 w/w. In some other embodiments, the weight ratio of MEIC to MF in the annealed composite particles is 8:92 w/w. In some other embodiments, the weight ratio of MEIC to MF in the annealed composite particles is 9:91 w/w. In some other embodiments, the weight ratio of MEIC to MF in the annealed composite particles is 10:90 w/w. In some other embodiments, the weight ratio of MEIC to MF in the annealed composite particles is 11:89 w/w. In some other embodiments, the weight ratio of MEIC to MF in the annealed composite particles is 12:88 w/w. In some other embodiments, the weight ratio of MEIC to MF in the annealed composite particles is 13:87 w/w. In some other embodiments, the weight ratio of MEIC to MF in the annealed composite particles is 14:86 w/w. In some other embodiments, the weight ratio of MEIC to MF in the annealed composite particles is 15:85 w/w. In some other embodiments, the weight ratio of MEIC to MF in the annealed composite particles is 16:84 w/w. In some other embodiments, the weight ratio of MEIC to MF in the annealed composite particles is 17:83 w/w. In some other embodiments, the weight ratio of MEIC to MF in the annealed composite particles is 18:82 w/w. In some other embodiments, the weight ratio of MEIC to MF in the annealed composite particles is 19:81 w/w. In some other embodiments, the weight ratio of MEIC to MF in the annealed composite particles is 20:80 w/w. In some other embodiments, the weight ratio of MEIC to MF in the annealed composite particles is 21:79 w/w. In some other embodiments, the weight ratio of MEIC to MF in the annealed composite particles is 22:78 w/w. In some other embodiments, the weight ratio of MEIC to MF in the annealed composite particles is 23:77 w/w. In some other embodiments, the weight ratio of MEIC to MF in the annealed composite particles is 24:86 w/w. In some other embodiments, the weight ratio of MEIC to MF in the annealed composite particles is 25:85 w/w. In some other embodiments, the weight ratio of MEIC to MF in the annealed composite particles is 26:84 w/w. In some other embodiments, the weight ratio of MEIC to MF in the annealed composite particles is 27:83 w/w. In some other embodiments, the weight ratio of MEIC to MF in the annealed composite particles is 28:82 w/w. In some other embodiments, the weight ratio of MEIC to MF in the annealed composite particles is 29:81 w/w. In some other embodiments, the weight ratio of MEIC to MF in the annealed composite particles is 30:70 w/w.

In some embodiments, the annealed composite particles can comprise the electrically conductive additive comprising carbon, which can be any suitable carbon-containing material that improves the electrical conductivity of the positive electrode film. Suitable electrically conductive additives can include, but are not limited to, activated carbon, carbon black, carbon fibers, carbon nanotubes, carbon nanofibers, graphite, graphene, fullerenes, ketjen black, vapor grown carbon fiber (VGCF), and acetylene black. In some embodiments, the electrically conductive additive is activated carbon. In other embodiments, the electrically conductive additive is carbon black. In some other embodiments, the electrically conductive additive is carbon fibers. In some other embodiments, the electrically conductive additive is carbon nanotubes. In some other embodiments, the electrically conductive additive is carbon nanofibers. In some other embodiments, the electrically conductive additive is graphite. In some other embodiments, the electrically conductive additive is graphene. In some other embodiments, the electrically conductive additive is fullerenes. In some other embodiments, the electrically conductive additive is ketjen black. In some other embodiments, the electrically conductive additive is vapor grown carbon fiber (VGCF). In some other embodiments, the electrically conductive additive is acetylene black.

The catholyte included in the positive electrode film can be any suitable ion conductor. Suitable catholytes can include, but are not limited to, LSS, LXPS, LXPSO, Li-stuffed garnet, where X is Si, Ge, Sn, As, Al, or combinations thereof. In some embodiments, the catholyte is LSS. In other embodiments, the catholyte is LXPS where X is Si, Ge, Sn, As, Al, or combinations thereof. In some other embodiments, the catholyte is LXPS where X is Si. In some other embodiments, the catholyte is LXPS where X is Ge. In some other embodiments, the catholyte is LXPS where X is Si and Sn. In some other embodiments, the catholyte is LXPS where X is Sn. In some other embodiments, the catholyte is LXPS where X is Al. In some embodiments, the catholyte is LXPSO where X is Si, Ge, Sn, Al, or combinations thereof. In some other embodiments, the catholyte is LXPSO where X is Si. In some other embodiments, the catholyte is LXPSO where X is Ge. In some other embodiments, the catholyte is LXPSO where X is Si and Sn. In some other embodiments, the catholyte is LXPSO where X is Sn. In some embodiments, the catholyte is LATS. In some other embodiments, the catholyte is LXPSO where X is Al. In some other embodiments, the catholyte is LXPSO where X is a combination of Si and Sn. In some embodiments, the catholyte is Li-stuffed garnet.

In some embodiments, the catholyte includes LXPS and is substantially free of oxygen, where X is Si, Ge, Sn, As, Al, or combinations thereof. In some embodiments, the catholyte is LXPS and is substantially free of oxygen, where X is Si. In other embodiments, the catholyte is LXPS and is substantially free of oxygen, where X is Ge. In some other embodiments, the catholyte is LXPS and is substantially free of oxygen, where X is Sn. In some other embodiments, the catholyte is LXPS and is substantially free of oxygen, where X is Al.

In some embodiments, the catholyte includes LXPS and has an oxygen content between about 0 and 10 atomic %, where X is Si, Ge, Sn, As, Al, or combinations thereof. In some embodiments, the catholyte includes LXPS and has an oxygen content of about 1, 2, 3, 4, 5, 6, 7, 8, 9, or about 10 atomic %, where X is Si, Ge, Sn, As, Al, or combinations thereof. In some embodiments, the catholyte includes LXPS and has an oxygen content of about 1, 2, 3, 4, 5, 6, 7, 8, 9, or about 10 atomic %, where X is Si. In other embodiments, the catholyte includes LXPS and has an oxygen content of about 1, 2, 3, 4, 5, 6, 7, 8, 9, or about 10 atomic %, where X is Ge. In some other embodiments, the catholyte includes LXPS and has an oxygen content of about 1, 2, 3, 4, 5, 6, 7, 8, 9, or about 10 atomic %, where X is Sn. In some other embodiments, the catholyte includes LXPS and has an oxygen content of about 1, 2, 3, 4, 5, 6, 7, 8, 9, or about 10 atomic %, where X is As. In some other embodiments, the catholyte includes LXPS and has an oxygen content of about 1, 2, 3, 4, 5, 6, 7, 8, 9, or about 10 atomic %, where Xis Al. In some other embodiments, the catholyte includes LXPS and has an oxygen content of about 1, 2, 3, 4, 5, 6, 7, 8, 9, or about 10 atomic %, where Xis a combination of two or more of Si, Ge, Sn, As, and Al.

In other embodiments, the catholyte is a Li-stuffed garnet or Li₂B₄O₇. In some other embodiments, the catholyte is Li₂B₄O₇. In some other embodiments, the catholyte is a Li-stuffed garnet. In some embodiments, the positive electrode film does not include a catholyte.

The binder included in the positive electrode film can be any suitable material that assists in the adhesion of the annealed composite particle components and/or adhesion of the annealed composite particles to the other components of the positive electrode film. Suitable binders can include, but are not limited to, polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), stereoblock polypropylenes, polypropylene polymethylpentene copolymer, polyethylene oxide (PEO), PEO block co-polymers, and silicone. In some embodiments, the binder is polypropylene (PP). In other embodiments, the binder is atactic polypropylene (aPP). In other embodiments, the binder is PEO. In some other embodiments, the binder is isotactive polypropylene (iPP). In some other embodiments, the binder is ethylene propylene rubber (EPR). In some other embodiments, the binder is ethylene pentene copolymer (EPC). In some other embodiments, the binder is polyisobutylene (PIB). In some other embodiments, the binder is styrene butadiene rubber (SBR). In some other embodiments, the binder is polyolefins. In some other embodiments, the binder is polyethylene-co-poly-1-octene (PE-co-PO). In some other embodiments, the binder is PE-co-poly(methylene cyclopentane) (PE-co-PMCP). In some other embodiments, the binder is stereoblock polypropylenes. In some other embodiments, the binder is polypropylene polymethylpentene copolymer. In some other embodiments, the binder is silicone.

The positive electrode film can be characterized by any suitable thickness. In some embodiments, the film is characterized by a thickness of about 1 to 100 μm. In other embodiments, the film is characterized by a thickness of about 5 to 95 μm. In some other embodiments, the film is characterized by a thickness of about 10 to 90 μm. In some other embodiments, the film is characterized by a thickness of about 15 to 85 μm. In some other embodiments, the film is characterized by a thickness of about 20 to 80 μm. In some other embodiments, the film is characterized by a thickness of about 25 to 75 μm. In some other embodiments, the film is characterized by a thickness of about 30 to 70 μm. In some other embodiments, the film is characterized by a thickness of about 35 to 65 μm. In some other embodiments, the film is characterized by a thickness of about 40 to 60 μm. In some other embodiments, the film is characterized by a thickness of about 45 to 55 μm.

In some embodiments, the film is characterized by a thickness of about 10 to 60 μm. In other embodiments, the film is characterized by a thickness of about 20 to 80 μm. In some other embodiments, the film is characterized by a thickness of about 10 to 15 μm. In some embodiments, the film is characterized by a thickness of about 40, 50, 60, 70, or about 80 μm.

In some embodiments, the annealed composite particles each have a median characteristic dimension that is 0.04 to 1.5 times the thickness of the film. For example, in some embodiments, the annealed composite particles have a diameter of about 0.5 to 10 μm and the film has a thickness of about 30 to 90 μm. In other embodiments, the annealed composite particles have a diameter of about 1 to 9 μm and the film has a thickness of about 35 to 85 μm. In other embodiments, the annealed composite particles have a diameter of about 1.5 to 8 μm and the film has a thickness of about 40 to 80 μm. In some other embodiments, the annealed composite particles have a diameter of about 2 to 7 μm and the film has a thickness of about 45 to 75 μm. In some other embodiments, the annealed composite particles have a diameter of about 3 to 7 μm and the film has a thickness of about 50 to 70 μm. In some other embodiments, the annealed composite particles have a diameter of about 3.5 to 6.5 μm and the film has a thickness of about 55 to 65 μm.

In some embodiments, the volume percent of the MEIC and MF, the catholyte, the binder, and the optional electrically conductive additive in the film is about 25-85, 25-85, 1-6, and 1-6% v/v, respectively.

It should be noted that any details provided herein with respect to the positive electrode films and methods described in Sections III-V also apply to the annealed positive electrode films and methods described in Sections VI-VII of the present disclosure.

### VIII. EXAMPLES

### Example 1

### Forming a Positive Electrode Film Including FeF₃

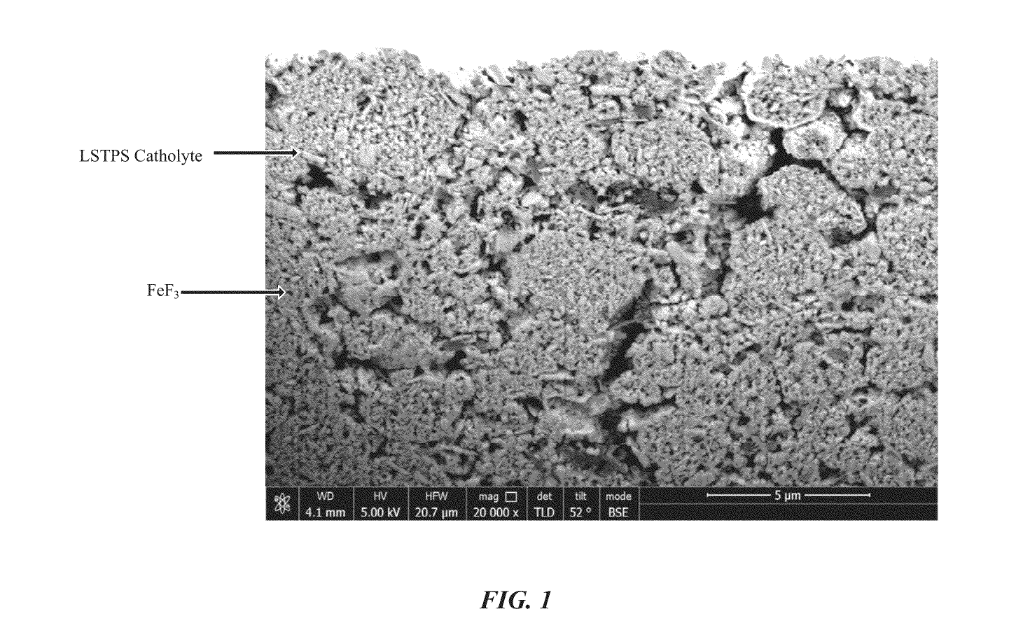

FeF₃ was prepared by Flash Evaporation, the details of which can be found in International Patent Application No. PCT/US2014/041203, filed Jun. 6, 2014, and entitled FLASH EVAPORATION OF SOLID STATE BATTERY COMPONENT, which is incorporated by reference herein in its entirety. The FeF₃ powder was then solvent milled until the median particle diameter d₅₀ was reduced to approximately 200-400 nm and then mixed with VGCF carbon and LSTPS catholyte (i.e., LiₐSiSnP_{b}S_{c}O_{d}, wherein 2≦a≦10, 0.5≦b≦2.5, 4≦c≦12, and 0<d≦3.4) Li₁₀SiSnP₂S₄O_{d}) with a binder in a solvent slurry. The slurry was cast onto a current-collecting metal and then dried in air. The resulting material was imaged as shown in FIG. 1.

### Example 2

### Forming a Positive Electrode Film Including FeF₃/MoS Nanocomposites

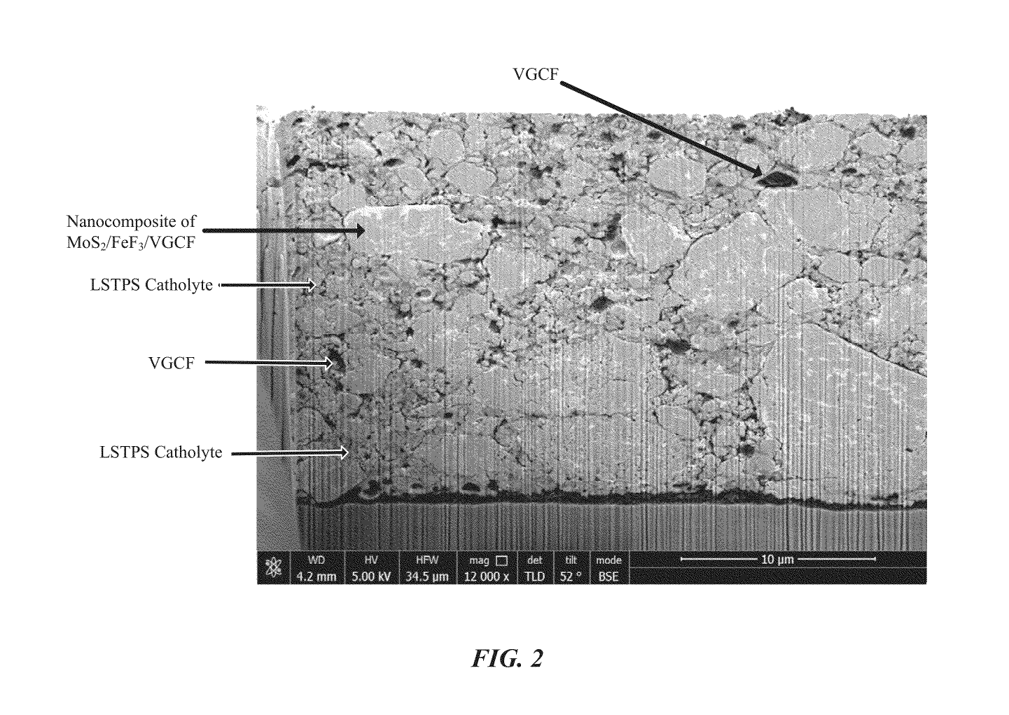

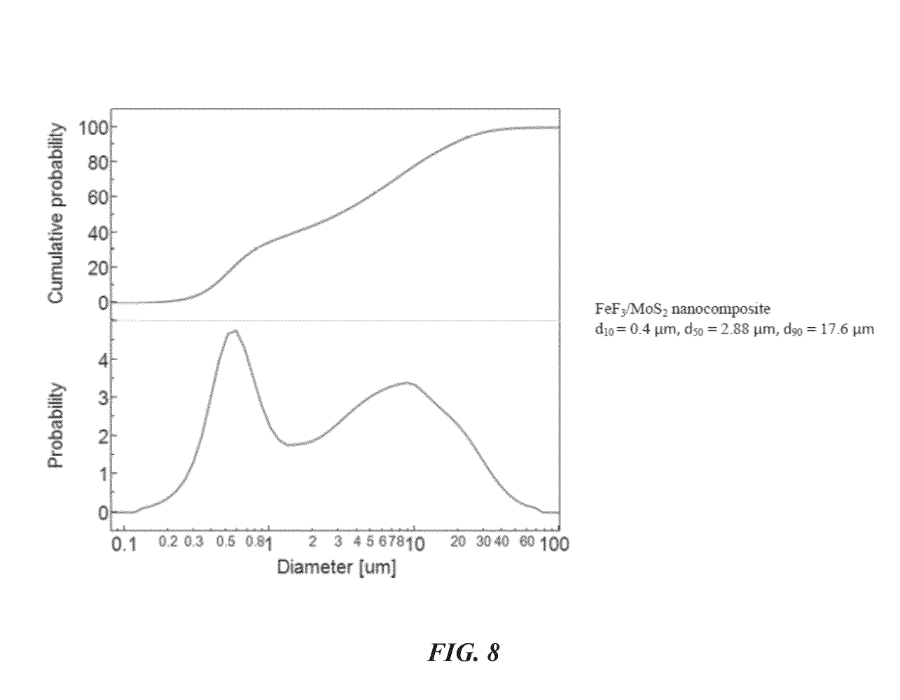

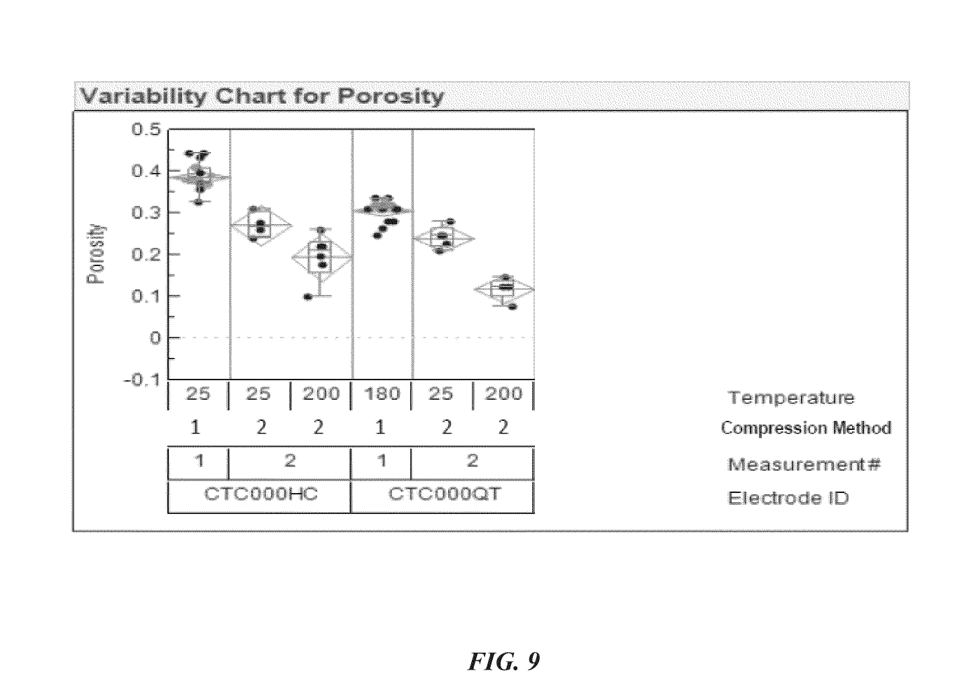

FeF₃ was prepared by Flash Evaporation, the details of which can be found in International Patent Application No. PCT/US2014/041203, filed Jun. 6, 2014, and entitled FLASH EVAPORATION OF SOLID STATE BATTERY COMPONENT, which is incorporated by reference herein in its entirety. The FeF₃ powder was solvent milled until the median particle diameter d₅₀ was reduced to approximately 200-400 nm and then mixed with VGCF carbon and MoS₂ (MEIC), to form a composite particle in which the weight ratio of MEIC:FeF₃ was about 1:8 to about 1:12. The composite particles were milled to have a d₁₀=0.4 μm, d₅₀=2.88 μm, and d₉₀=17.6 μm (per FIG. 8). The composite particles were size selected to have a median (d₅₀) diameter of 1-5 μm and then mixed with a binder and LSTPS catholyte in a slurry and cast onto a current-collecting metal. The subsequently dried film was hot-calendered at either about 1-1000 pounds per square inch (PSI) and at about 25° C. to about 200° C. (compression method 2 as noted in FIG. 9) or at about 25° C. by applying mechanical pressure to construct a coin cell. The resulting film is shown in FIG. 2, in which a low porosity composite was observed. The low porosity of the composite particles was observed and recorded in FIG. 9. The results in FIG. 9 show the advantage of hot-calendering (compression method 2) as compared to compression method 1 which does not involve the large temperature and pressures used in compression method 2. Compression method 2 results in low porosity films that have a porosity less than 25%, less than 20%, less than 15%, and less than 10% by volume.

### Example 3

### Forming a Positive Electrode Film Including FeF₃/V₂O₅ Nanocomposites

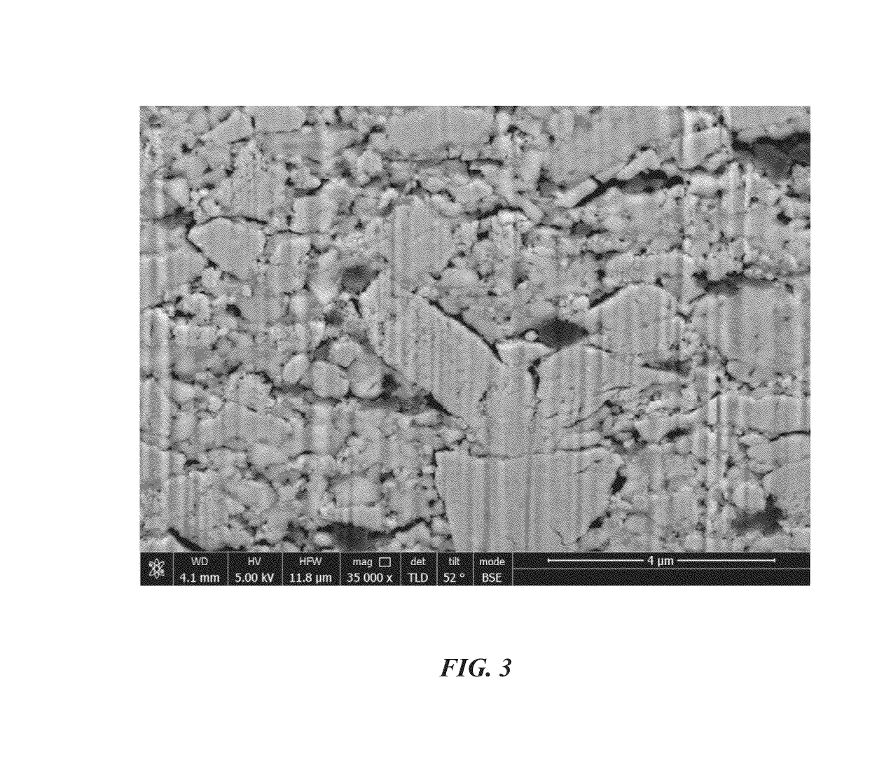

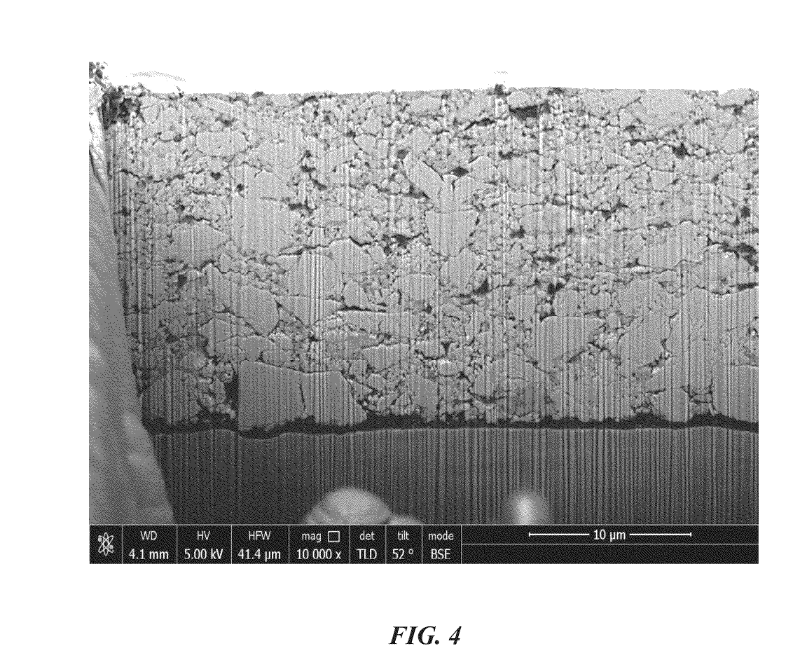

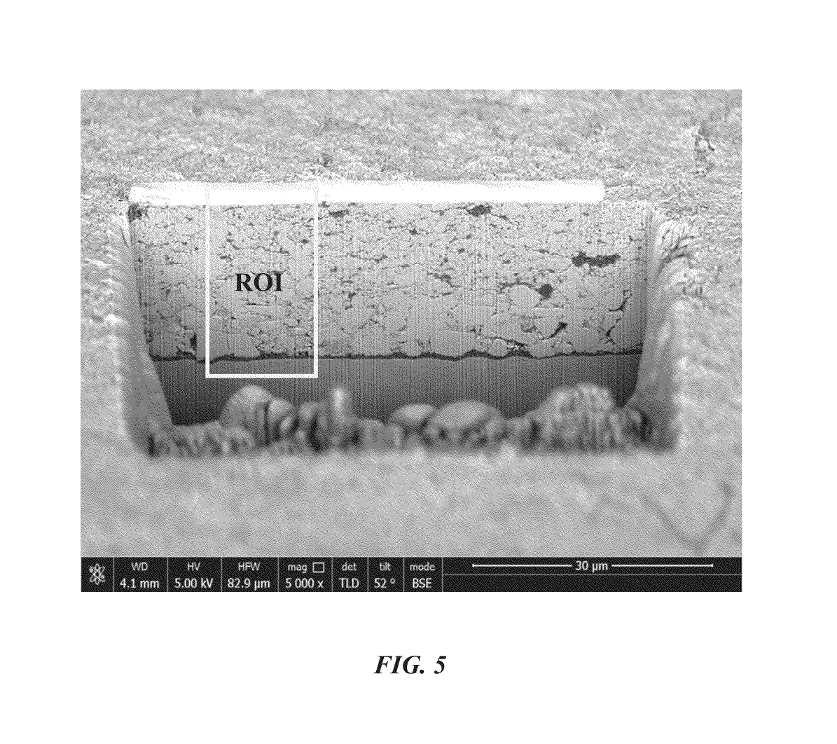

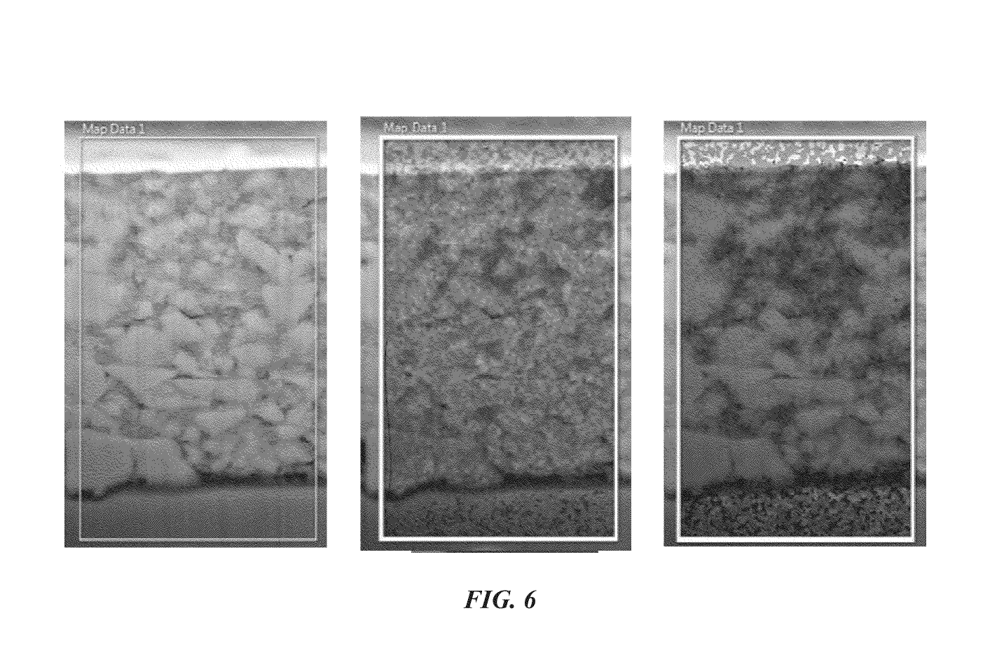

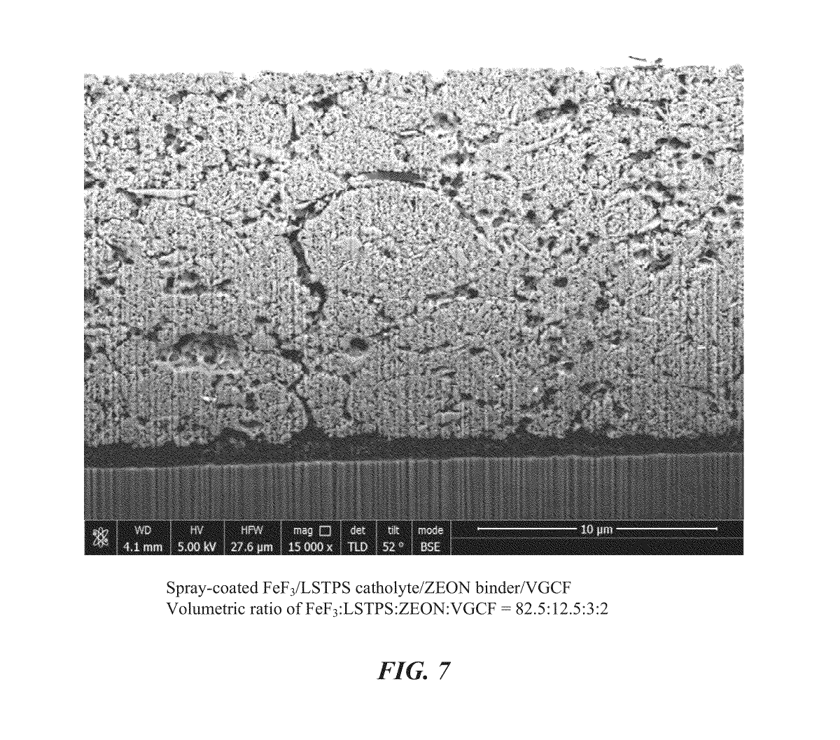

FeF₃ was prepared by Flash Evaporation, the details of which can be found in International Patent Application No. PCT/US2014/041203, filed Jun. 6, 2014, and entitled FLASH EVAPORATION OF SOLID STATE BATTERY COMPONENT, which is incorporated by reference herein in its entirety. The FeF₃ powder was solvent milled until the median particle diameter d₅₀ was reduced to approximately 200-400 nm and then mixed with VGCF carbon and V₂O₅ (MEIC), to form a composite particle in which the weight ratio of MEIC:FeF₃ was about 1:8 to about 1:12. The composite particles were size selected to have a median (d₅₀) diameter of 1-5 μm and then mixed with a binder and LSTPS catholyte in a slurry and cast onto a current-collecting metal. The subsequently dried film was hot-calendered at about 1-1000 pounds per square inch (PSI) and at 30° C. to about 200° C. The resulting film is shown in FIGS. 3-6, in which a low porosity composite was observed. As shown in FIG. 6, the Fe, F, and V are identified by elemental analysis as located within a micron sized nanocomposite particle and the Fe, F, and V are separated from each other, therein, by nanometer dimensions. The LSTPS catholyte, as evidenced by the S and P elemental analysis signals, surrounds the nanocomposite particles but is not contained in the nanocomposite particles.

### Example 4

### Forming a Positive Electrode Film Including Spray-Coated FeF₃

This process deposits an inorganic coating on alcohol-stable FeF₃ cathode particles to improve particle compatibility with other components and stability. The product of this process was formulated into a slurry and deposited as an electrode film as noted in Examples 1-3 depending on whether a nanocomposite film was prepared or a film without a nanocomposite therein.

In this example, FeF₃ was transferred to a media bottle and homogenized in a solvent homogenizer at 10,000 RPM for 10-30 seconds. The solvent was isopropanol. FeF₃ was coated using a spray dryer with flowing Argon while agitating the FeF₃. The inorganic coating spray dried onto the FeF₃ included, in isopropanol, FeF₃, LiNO₃, Al(NO₃)₃.9H₂O, H₃PO₄. The spray coated FeF₃ was placed in an oven to evaporate the water, HNO₃, and isopropanol. The product included FeF₃ coated with a lithium aluminum phosphate characterized by the chemical formula LiAl(PO₄)_{1.33}. In some instances, this chemical formula is represented in a simplified manner as LiAl(PO₄). In this example, the LiAl(PO₄) is a thin coating (i.e., shell) surrounding the FeF₃. This coated FeF₃ was formulated into nanocomposites according to Examples 2 and 3.

### Example 5

### Forming a Positive Electrode Film Including CuF₂:FeF3/V₂O₅ with No Catholyte

This example provides a method of producing a Li-secondary battery positive electrode film comprising composite particles that comprise a V₂O₅ MEIC, a FeF₃ MF, VGCF, and a binder.

A CuF₂-doped FeF₃ powder was prepared by a flash evaporation process, the details of which can be found in International Patent Application No. PCT/US2014/041203, filed Jun. 6, 2014, and entitled FLASH EVAPORATION OF SOLID STATE BATTERY COMPONENT, which is incorporated by reference herein in its entirety. Additional details regarding CuF₂-doped FeF₃ can be found in U.S. Provisional Patent Application No. 62/038,059, filed Aug. 15, 2014, and entitled DOPED CONVERSION MATERIALS FOR SECONDARY BATTERY CATHODES, and in U.S. Provisional Patent Application No. 62/043,353, filed Aug. 28, 2014, and entitled DOPED CONVERSION MATERIALS FOR SECONDARY BATTERY CATHODES, all of which are incorporated by reference herein in their entirety. The FeF₃ in the reactant mixture was not lithiated in this example. However, in some embodiments, when the FeF₃ powder is substochiametric (e.g., if the ratio of F:Fe is less than 3), LiF was added to the reactant mixture in the appropriate amount.

In this Example, reactant CuF₂ powder was ground to a fine particle size in a glove box. FeF₃ and CuF₂ powders were mixed in a glove box at a weight ratio of 95:5 FeF₃:CuF₂. The mixture was homogenized and transferred to a vacuum tight feeder hopper. The hopper was pumped down and installed on a vacuum chamber with an evaporation source. The powder was dispensed into the evaporation chamber and vaporized. The vapor stream coming out of the source nozzle condensed on a water cooled rotating drum, or condensed before making contact with the water cooled drum. The powder that condensed on the drum was removed in situ by a scrapper device and subsequently milled into a fine powder and funneled into a collection hopper. The collection hopper was sealed and later opened in inert environment.

The flash evaporated CuF₂-doped FeF₃ powder had a particle size d₁₀, d₅₀, and d₉₀ of 6, 15, and 40 μm, respectively, as measured by a particle size analyzer. The CuF₂ doping was determined to be approximately 1 atomic % by Inductively Coupled Plasma (ICP) analysis. The reactant mixture included 5% CuF₂ w/w. In the final product, CuF₂ was measured to be about 1 atomic %. The CuF₂-doped FeF₃ powder was then solvent milled until the median particle diameter d₅₀ was reduced to approximately 200-400 nm.

The milled CuF₂-doped FeF₃ powder was combined with V₂O₅ powder with a mass ratio (i.e., weight ratio) of CuF₂-doped FeF₃ to V₂O₅ of 85:15, and the combined powder was then milled to form composite particles having a median diameter d₅₀ of approximately 6 μm. VGCF and a binder were added to the composite mixture, with the mass percent of the composite particles, VGCF, and binder being 93, 4, and 3%, respectively. The particle mixture was hot-calendered at about 1-1000 pounds per square inch (PSI) and at 30° C. to about 200° C.

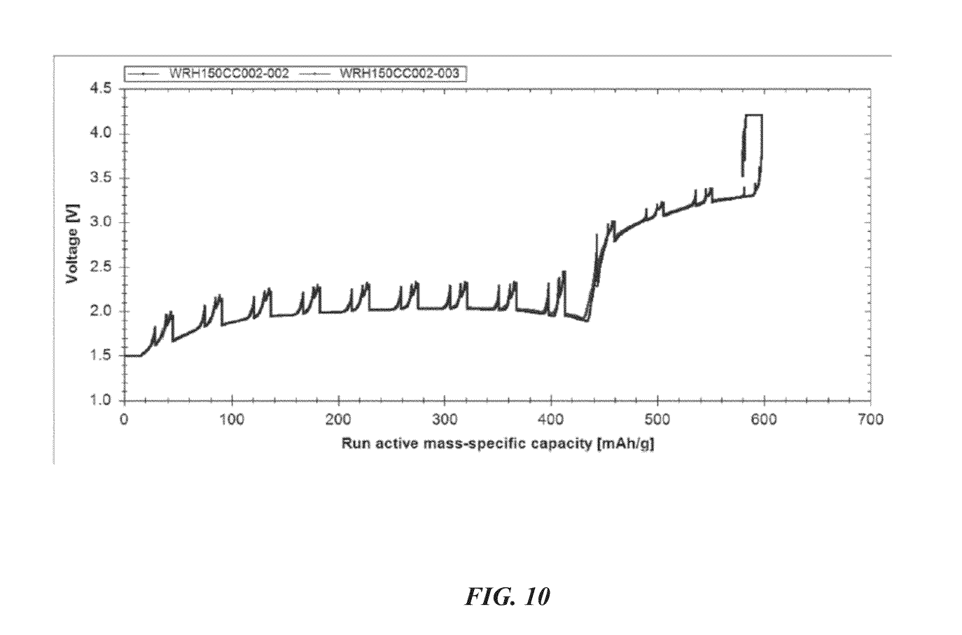

The mass-specific capacity of the sample was tested using three ten-minute charging voltage pulses where the sample was first charged to 4.2 V and then discharged back to 1.5 V. Increasing C-rates were used, with the first, second, and third C-rates being C/100, C/50, and C/33, respectively. Each pulse was followed by a 10 minute rest period. Then, a thirty minute discharge at a C-rate of C/33 was performed and followed by a 15 minute rest period. This process was then repeated, the results of which are shown in FIG. 10.

The measuring device used to produce the measurements shown in FIG. 10 calculates the absolute energy by taking the integral of the voltage times the mass-specific capacity. The specific energy is calculated by dividing the absolute energy by the mass of active material in the electrode, and corresponds to the expected fraction of active material (i.e. as a percentage of the starting materials) multiplied by the actual electrode mass which was weighed before testing. Based on the measured data shown in FIG. 10, the electrode sample surprisingly and unexpected demonstrated a 600 mAh/g specific capacity with a gravimetric energy density of approximately 1360 Wh/kg with a capacity weighted voltage of 2.27 V.

### Example 6

### Forming a Positive Electrode Film Including CuF₂:FeF₃/V₂O₅

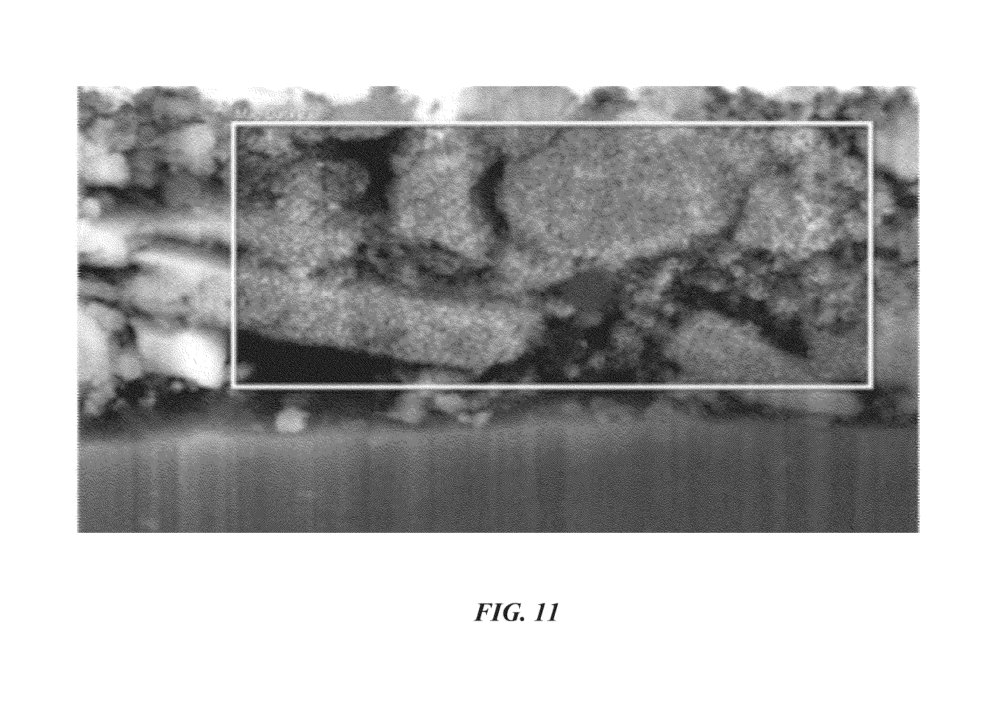

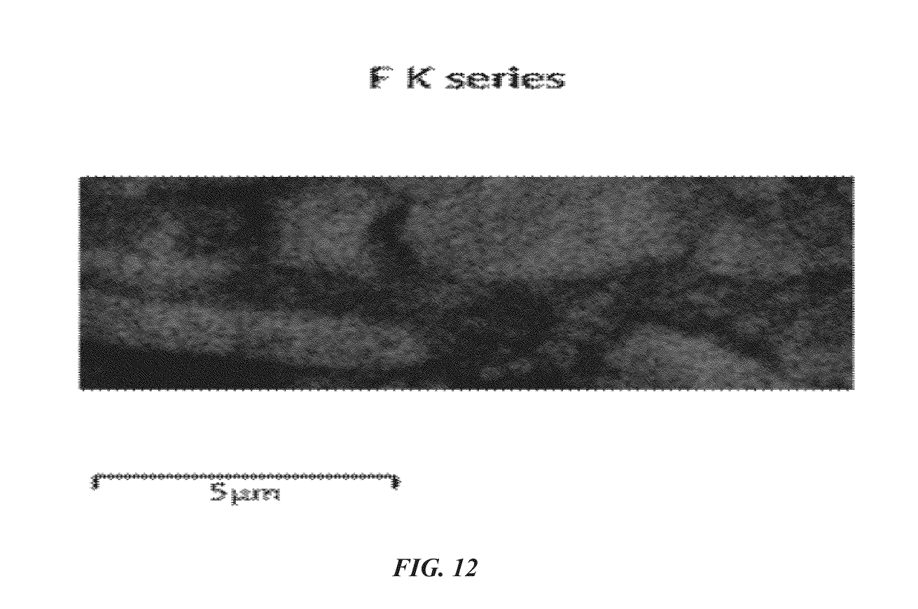

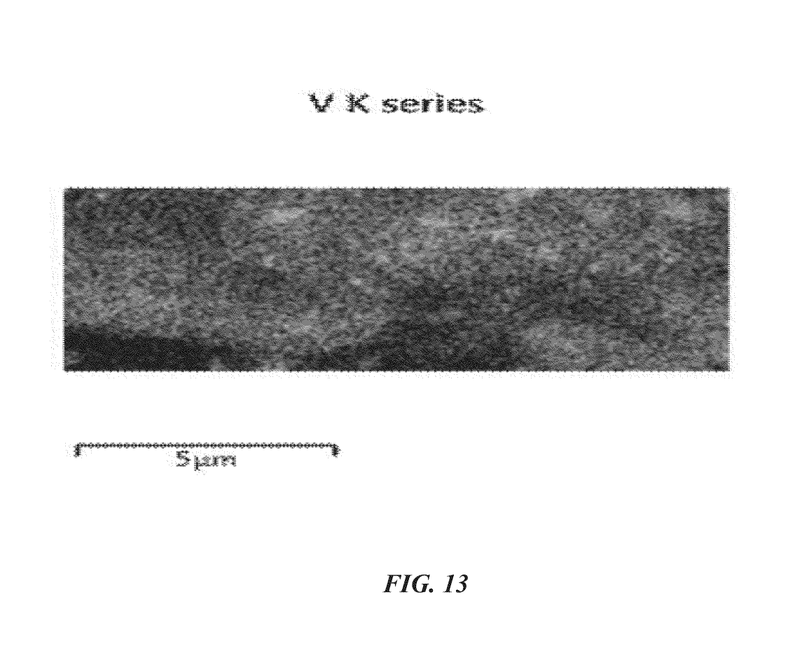

FeF₃ was prepared by flash evaporation according to the methods set forth in Example 5. The reactant input included a weight ratio of 95:5 FeF₃:CuF₂. The FeF₃ was then solvent milled in a Hockmeyer mill (final size: d₅₀=250 nm, d₉₀=395 nm), and then baked at 180° C. under vacuum for three hours to produce a dried powder. V₂O₅ and baked at 200° C. for 3 hours under vacuum to remove surface moisture. The V₂O₅ was then solvent milled in a Hockmeyer mill (final size: d₅₀=184 nm, d₉₀=341 nm), and then baked at 180° C. under vacuum for three hours to produce a dried powder (size not measured). Approximately 3.00 grams of the dried V₂O₅ and 0.53 grams of milled FeF₃ were put in a Spex mill with stainless media for approximately 45 minutes to prepare particles having a d₅₀ of about 10-50 μm range and d₉₀ of about 50-150 μm. Additional solvent milling in a Spex mill jar was performed to prepare particles having a d₅₀ of about 3 to 8.4 um, a d₉₀ of about 8 to 36 um. Multiple batches were prepared according to this procedure and later combined to produce large quantities of materials approximately 15-20 grams in total. The materials produced by this method are shown in FIGS. 11-13. As shown, for example, in FIG. 11 by elemental analysis, the catholyte contacts the outside of the composite particles but is not contained therein. Fe, and F, are observed in the low porosity composite particles. The composite particles have a “marbled steak” appearance in which the MEIC (e.g., VOₓ) is intimately mixed with the conversion chemistry material. The MEIC and FeF₃ are separated by nanometers in a composite particle which is several microns in size.

### Example 7

### Forming a Positive Electrode Film Including CuF₂:FeF₃/MoS₂

FeF₃ was prepared by flash evaporation. The reactant input included a weight ratio of 95:5 FeF₃:CuF₂. The FeF₃ was then solvent milled in a Hockmeyer mill (final size: d₅₀=250 nm, d₉₀=395 nm), and then baked at 180° C. under vacuum for three hours to produce a dried powder. MoS₂ and baked at 200° C. for 3 hours under vacuum to remove surface moisture. The MoS₂ was then solvent milled in a Hockmeyer mill (the d₅₀ was approximately 184 nm, the d₉₀ was approximately 341 nm), and then baked at 180° C. under vacuum for three hours to produce a dried powder (size not measured). Approximately 3.00 grams of the dried MoS₂ and 0.53 grams of milled FeF₃ were put in a Spex mill with stainless media for approximately 45 minutes to prepare particles having a d₅₀ of about 10-50 μm range and d₉₀ of about 50-150 μm.

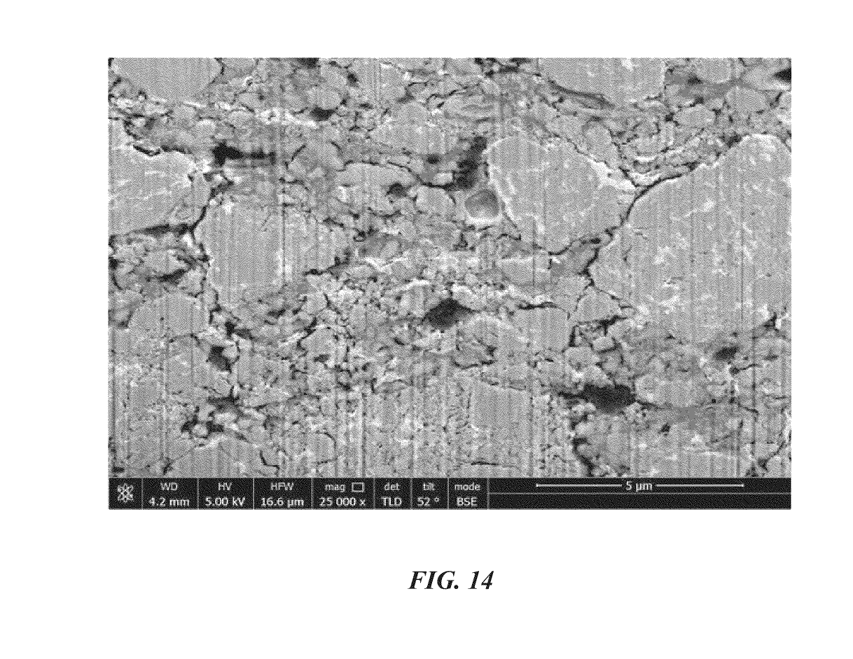

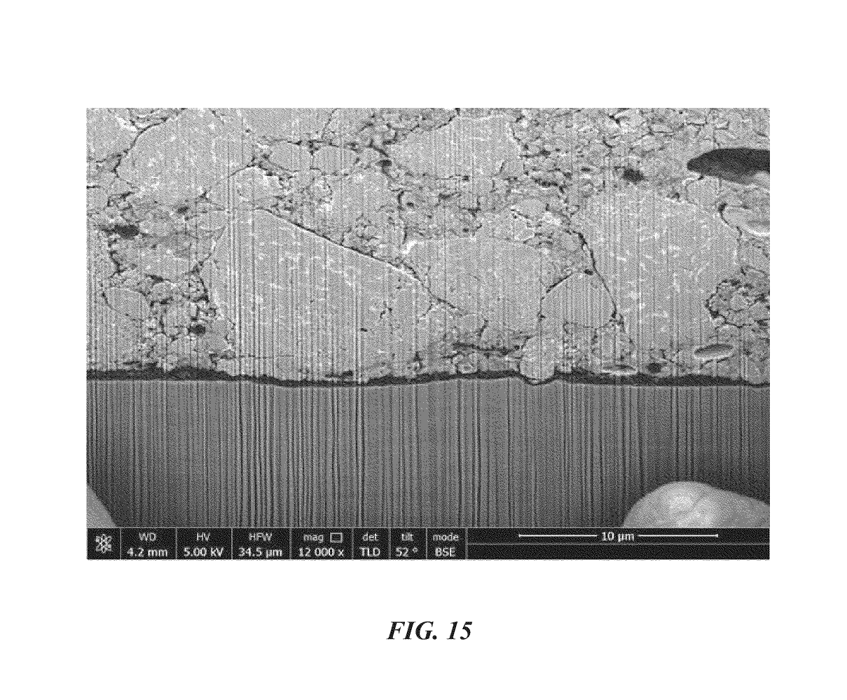

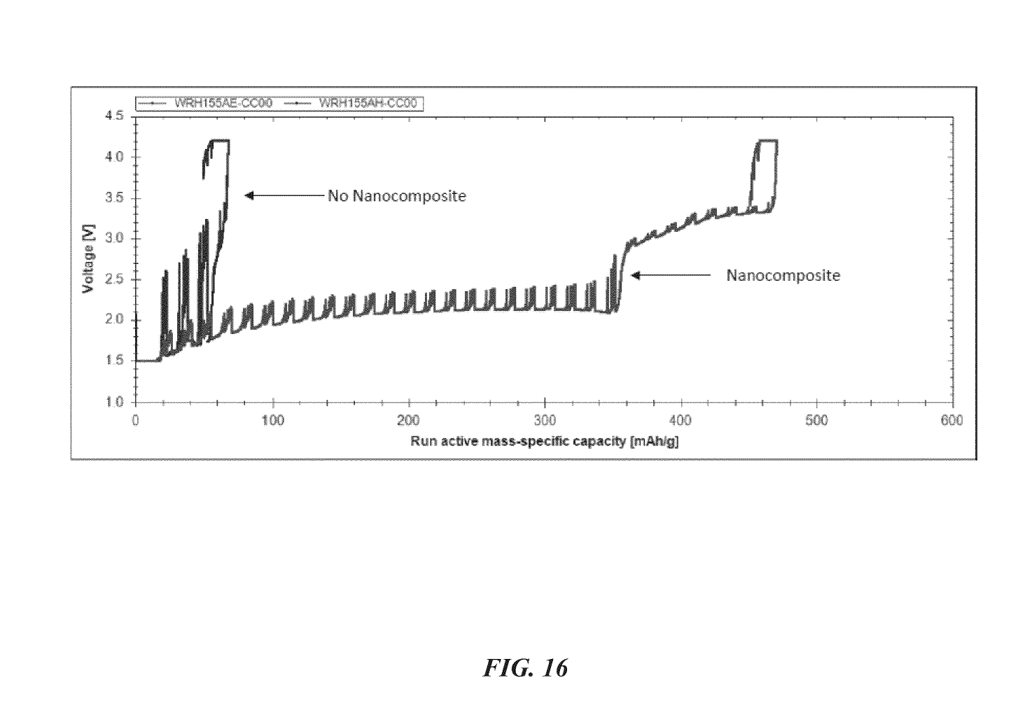

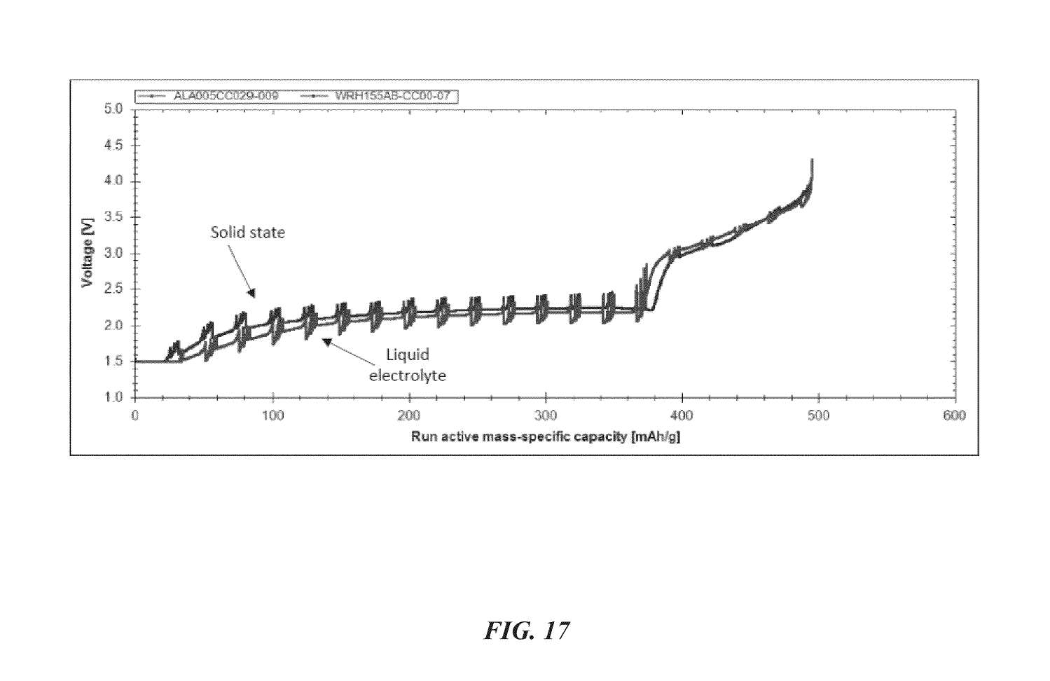

Additional solvent milling in a Spex mill jar was performed to prepare particles having a d₅₀ of about 3 to 8.4 um, a d₉₀ of about 8 to 36 um. Multiple batches were prepared according to this procedure and later combined to produce large quantities of materials approximately 15-20 grams in total. The materials produced by this method are shown in FIGS. 14-15. As shown, for example, in FIG. 14, the MEIC is uniformly mixed with the FeF₃ in the composite particle, and the mixture of the MEIC and the conversion chemistry material in the composite particle had the appearance of marbled steak. The MEIC and FeF₃ are separated by nanometers in a composite particle which is several microns in size. As shown, for example, in FIG. 15, the MEIC and conversion chemistry material are located in micron sized particles but are separated from each other, inside the micron sized particle, by nanometers. In some particles, the MEIC and conversion chemistry material are separated in the micron sized particles by dimensions greater than 100 nm.

### Example 8

### Electrochemical Testing of Nanocomposites

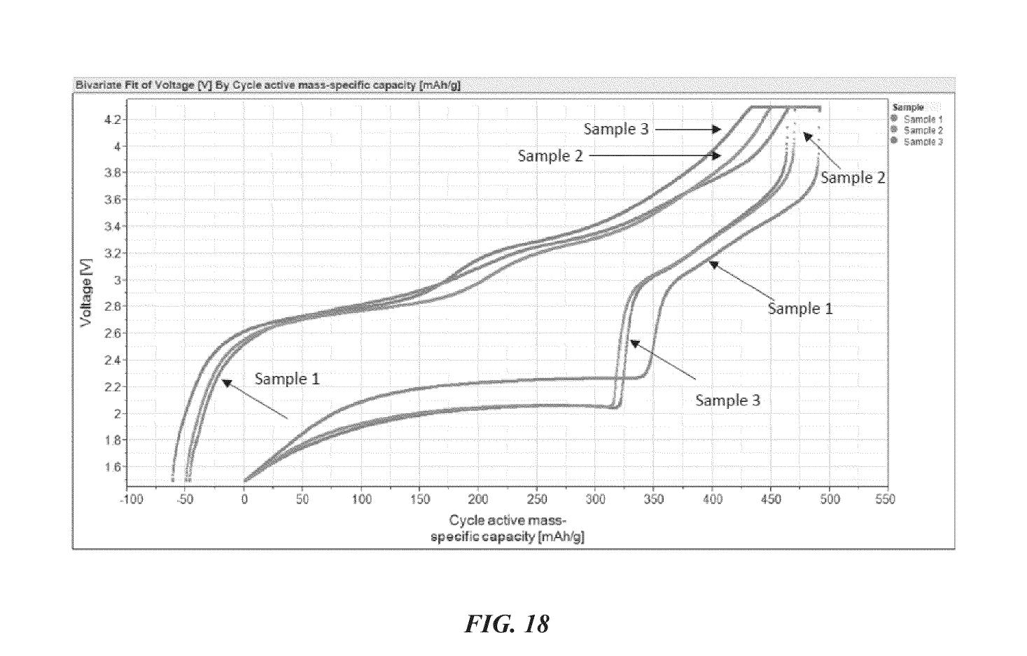

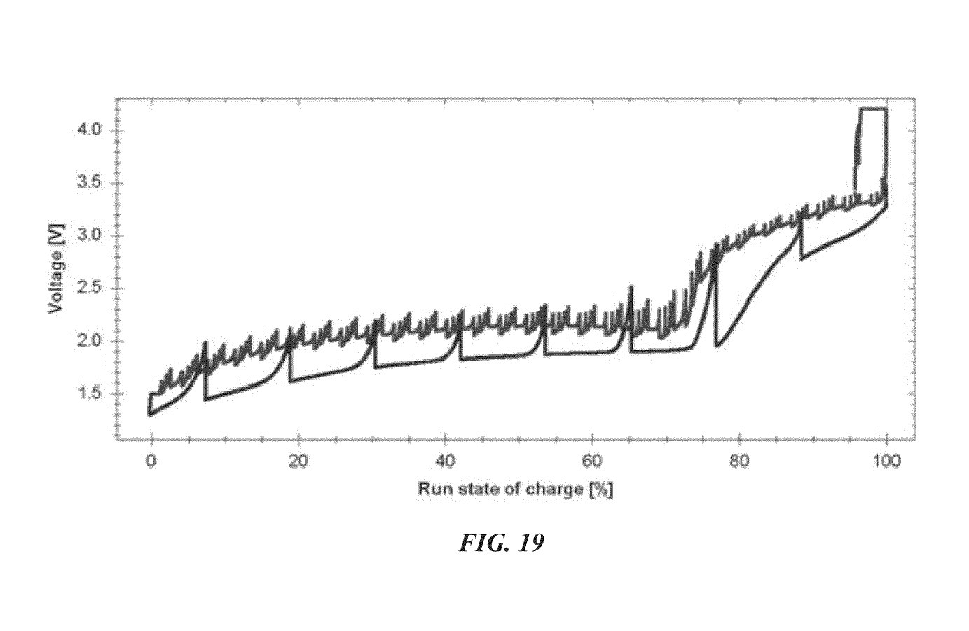

Samples herein were analyzed by an electrical test in an asymmetric three step discharge charge discharge test. The cells were produced in a charged state. The cells were initially discharged and first charged at a C/10 rate. The first discharge was carried out at a C rate of either C/10, C/3 1C, or 3C. An example analysis is shown in FIG. 18, in which the first charge and the first discharge are illustrated. In FIG. 18, sample 1 is flash evaporated Cu-doped FeF₃; sample 2 is flash evaporated FeF₃ without a dopant therein; sample 3 is crystalline FeF₃.

Samples herein were tested using a liquid electrolyte in a coin cell with 1:1 molar ratio of ethylene carbonate (EC): diethylene carbonate (DC) with 1M LiPF₆.

### Example 9

### Forminga Positive Electrode Film Including Annealed Cu-Doped FeF₃/MoO₃ Nanocomposites

This example provides Cu-doped FeF₃ was prepared by Flash Evaporation, as described above, the details of which can be found in International Patent Application No. PCT/US2014/041203, filed Jun. 6, 2014, and entitled FLASH EVAPORATION OF SOLID STATE BATTERY COMPONENT, which is incorporated by reference herein in its entirety. The Cu-doped FeF₃ powder was solvent milled until the median particle diameter d₅₀ was reduced to approximately 200-400 nm and then mixed with VGCF carbon and MoO₃ (MEIC), to form a composite particle in which the weight ratio of MEIC:FeF₃ was about 1:8 to about 1:12.

The composite particles were size selected to have a median (d₅₀) diameter of 1-5 μm. The composites were then annealed by heating them to about 350° C. for about 2-8 hours. The annealing atmosphere in contact with the composites include a controlled mixture of oxygen in the range of 50 ppm Oxygen to 500 ppm Oxygen. Subsequently, after cooling, the composites were then mixed with a binder and LSTPS catholyte in a slurry and cast onto a current-collecting metal. The subsequently dried film was hot-calendered at about 1-1000 pounds per square inch (PSI) and at 30° C. to about 200° C. The resulting film is shown in FIGS. 3-6, in which a low porosity composite was observed. As shown in FIG. 6, the Fe, F, and V are identified by elemental analysis as located within a micron sized nanocomposite particle and the Fe, F, and V are separated from each other, therein, by nanometer dimensions. The LSTPS catholyte, as evidenced by the S and P elemental analysis signals, surrounds the nanocomposite particles but is not contained in the nanocomposite particles.

When test in liquid electrolyte formats, samples herein were tested using a liquid electrolyte in a coin cell with 1:1 molar ratio of ethylene carbonate (EC): diethylene carbonate (DC) with 1M LiPF₆.

### Example 10

### Electrochemical Testing and XRD Analysis of Annealed Nanocomposites

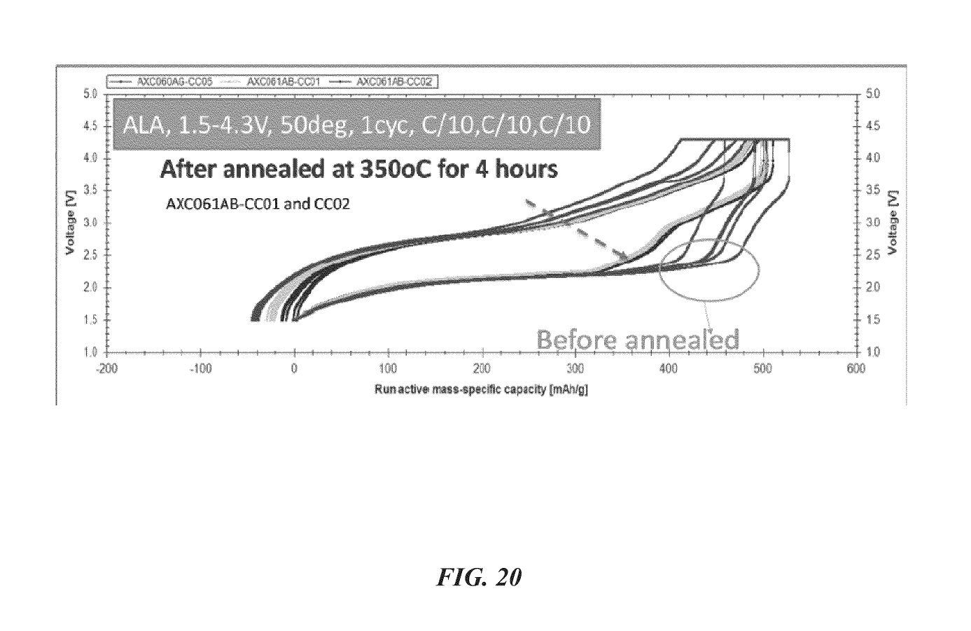

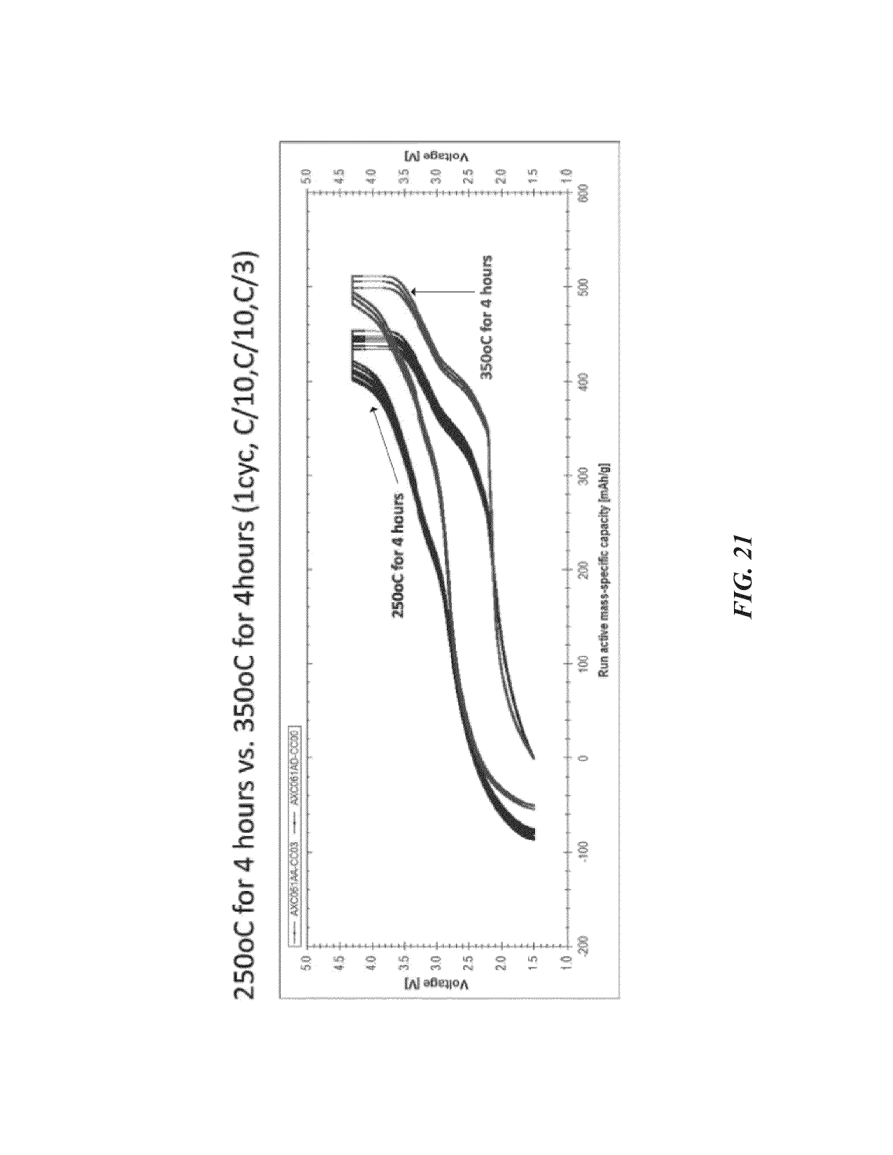

In this example, nanocomposites, annealed and not annealed, were prepared as set forth in Example 9. As shown in FIG. 20, the annealed nanocomposites were observed to have a reduced voltage hysteresis and improved cycleability as compared to nanocomposites which were not annealed. Also, the overpotential on charge is reduced for the annealed nanocomposites as compared to the nanocomposites which were not annealed. In addition, the intercalation plateau is maintained at a higher V, which results in improved power density, for the annealed nanocomposites as compared to the nanocomposites which were not annealed. The annealed nanocomposites were observed to have an increased intercalation capacity and higher weighted discharge voltage. As shown in FIG. 21, those composites that were annealed at 350° C. had improved properties as compared to those composites that were annealed at 250° C. These improved properties included a reduced hysteresis, improved cycleability, and more sustained intercalation plateau. The sample annealed at 350° C. is observed to have a higher conversion capacity than the sample annealed at 250° C. As shown in FIG. 22, the XRD pattern indicates that a crystal structure change occurs when the nanocomposites are annealed as compared to the nanocomposites before they are annealed.

Although the foregoing embodiments have been described in some detail by way of illustration and example for purposes of clarity of understanding, one of skill in the art will appreciate that certain changes and modifications can be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A positive electrode film comprising:
composite particles;
a catholyte; and
a binder;
wherein the composite particles comprise a mixed electronic ionic conductor (MEIC) and a metal fluoride (MF);
wherein the composite particles optionally comprise an electrically conductive additive comprising carbon;
wherein the catholyte and binder contact outer surfaces of the composite particles but are not contained therein; and
wherein the composite particles are characterized by a porosity of less than about 15% v/v.

2. The positive electrode film of claim 1, wherein the composite particles comprise an electrically conductive additive comprising carbon.

3. The positive electrode film of claim 1, wherein the MEIC is selected from the group consisting of carbon (C), MoSₓ wherein 0<x≦3, MoS₂, MoS, LiV₃O₈, LiV₃O₆, MoOF, MoO₃₋ₓ wherein 0≦x≦1, LiₓVO_{y} wherein 0<x<2y and 1≦y≦2.5, V₂O₅, MnₐO_{b} wherein 1≦a≦2 and 1≦b≦7, MnO, Mn₃O₄, Mn₂O₃, MnO₂, LiAlCl₄, LISICON, NASICON, Na₁₊ₓZr₂SiₓP₃₋ₓO₁₂ wherein x in each instance is 0<x<3 and optionally wherein Na, Zr and/or Si is replaced by isovalent elements, NASICON-structured phosphates, Li_{c}Na_{c}V₂(PO₄)₃ wherein c in each instance is independently 0<c<1, Li_{d}Na_{d}MₑM′_{f}(PO₄)₃ wherein d in each instance is independently 0≦d≦2, and 0≦e≦2, 0≦f≦2, and M and M′ are metals selected from the group consisting of V, Nb, Ta, Cr, Fe, Al, Co, Ni, and Cu, Li_{g}MM′(SO₄)₃ where M and M′ are transition metals and g is selected so that a compound is charge neutral, and LiMXO₄ where X is Ge, Si, Sb, As, or P, LiₕNaV₂(PO₄)₃, LiₕNa₂FeV(PO₄)₃, LiₕFeTi(PO₄)₃, and LiₕTiNb(PO₄)₃, and LiₕFeNb(PO₄)₃, wherein 0≦h≦1.

4. The positive electrode film of claim 1, wherein the MEIC or carbon are coated on the MF.

5. The positive electrode film of claim 1, wherein the MEIC and the MF are nanodimensioned.

6-10. (canceled)

11. The positive electrode film of claim 1, wherein the MF is selected from the group consisting of LiF, Li_{z}FeF₃, Li_{z}CuF₂, Li_{z}NiF₂, Li_{z}NiF_{2.5}, Li_{z}NiF₃, Li_{z}CoF₂, Li_{z}CoF₃, Li_{z}MnF₂, and Li_{z}MnF₃, wherein 0≦z≦3.

12. The positive electrode film of claim 1, wherein the MF is Li_{d}MF_{g}, wherein d and g are, independently in each instance, selected from within a range of 0 to 3, and wherein M is a metal selected from Fe, Cu, Ni, Co, Mn, alloys thereof, or combinations thereof.

13-14. (canceled)

15. The positive electrode film of claim 1, wherein the MF is doped with a dopant selected from the group consisting of oxygen, carbon, a metal selected from the group consisting of Li, Mg, Al, Si, Ca, Ti, V, Cr, Mn, Mo, Fe, Co, Ni, Cu, Zn, Y, Zr, Nb, Ba, and Hf, a metal oxide of said metal, a cation of said metal, a metal fluoride of said metal, and combinations thereof.

16. The positive electrode film of claim 15, wherein the dopant is selected from the group consisting of Li₂O, Cu, CuF₂, MoO₂, MoO₃, NiF₂, ZrF₄, CaF₂, and AlF₃.

17-18. (canceled)

19. The positive electrode film of claim 1, wherein the catholyte is selected from the group consisting of LSS, LTS, LXTS, LXPS, LXPSO, and Li-stuffed garnet, where X is Si, Ge, Sn, As, Al, or combinations thereof.

20. The positive electrode film of claim 1, wherein the catholyte is LXPS and is substantially free of oxygen, where X is Si, Ge, Sn, Al, or combinations thereof.

21. The positive electrode film of claim 1, wherein the catholyte is LXPS and has an oxygen content between about 0 and 10 atomic %, where X is Si, Ge, Sn, As, Al, or combinations thereof.

22-38. (canceled)

39. The positive electrode film of claim 1, wherein a weight ratio of the MEIC to the MF in the composite particles is between about 8:92 to 17:83 w/w.

40-95. (canceled)

96. A Li-secondary battery positive electrode film comprising:
composite particles;
a catholyte; and
a binder;
wherein the composite particles comprise a mixed electronic ionic conductor (MEIC) and a conversion chemistry material;
wherein the composite particles optionally comprise an electrically conductive additive comprising carbon;
wherein the catholyte and binder contact outer surfaces of the composite particles but are not contained therein; and
wherein the composite particles are characterized by a porosity of less than about 15% v/v at 25° C.

97-160. (canceled)

161. A method for forming a positive electrode film, the method comprising:
preparing a composite comprising:
a mixed electronic ionic conductor (MEIC) comprising a member selected from the group consisting of metal oxides, metal sulfides, metal halides, metal oxyhalides, and combinations thereof;
a nanodimensioned metal fluoride (MF);
optionally a binder; and
optionally an electrically conductive additive comprising carbon;
milling the composite to form a milled composite having a characteristic dimension of about 300 nm to 100 μm;
heating the milled composite to a temperature of about 150° C. to 600° C. for about 2 to 10 hours to form an annealed composite;
optionally cooling the annealed composite to room temperature;
preparing a slurry by mixing the annealed composite with a catholyte and optionally a binder;
casting the slurry as the positive electrode film;
heating the positive electrode film to a temperature of about 80° C. to 400° C.; and
applying a pressure to the positive electrode film.

162-165. (canceled)

166. The method of claim 161, wherein preparing the composite comprises individually milling the MEIC, the MF, optional binder, and optional electrically conductive additive prior to combining the MEIC, the MF, optional binder, and optional electrically conductive additive.

167-169. (canceled)

170. The method of claim 161, wherein milling the composite comprises wet milling the MEIC, the MF, optional binder, and optional electrically conductive additive in a solvent selected from the group consisting of methanol, ethanol, isopropanol, butanol, pentanol, hexanol, toluene, toluene:ethanol, acetone, N-methyl-2-pyrrolidone (NMP), diacetone alcohol, ethyl acetate, hexane, nonane, dodecane, and combinations thereof.

171-173. (canceled)

174. The method of claim 161, wherein the milled composite is heated to a temperature selected from the group consisting of about 300° C., 325° C., 350° C., 375° C., 400° C., 425° C., 450° C., 475° C., and 500° C.

175-188. (canceled)

189. The method of claim 161, further comprising coating the milled composite prior to heating the milled composite.

190. The method of claim 161, further comprising coating the annealed composite prior to preparing the slurry.

191-267. (canceled)
